(19) United States
(12) Patent Application Publication
(10) Pub. No.: US 2010/0017223 A1
(43) Pub. Date: Jan. 21, 2010

(54) Electronic donor medical records management system

(76) Inventors: Amy Johnson, Centennial, CO (US); Mike Hooks, Centennial, CO (US); Mathew Shuster, Englewood, CO (US)

Correspondence Address: HOLLAND & HART, LLP, P.O BOX 8749, DENVER, CO, 80201, US

(21) Appl. No.: 12/380,966

(22) Filed: Mar. 3, 2009

Related U.S. Application Data
(60) Provisional application No. 61/033,311, filed on Mar. 3, 2008.

(51) Int. Cl. G06Q 50/00; G06F 3/01

(52) U.S. Cl. 705/2; 715/760

(57) ABSTRACT

There are disclosed an electronic donor medical records management system and a method of managing electronic donor medical records in a system. In an embodiment, the system includes a recovery agency site having a first electronic chart component configured to allow a recovery agency to add online donor charts directly to the system; and a medical records site having a second electronic chart component configured to allow processing of the online donor charts. In one embodiment, the method includes navigating a browser to a recovery agency site related to a donor; selecting an add donor link; selecting a prefix to identify a recovery agency; entering a recovery agency donor number; selecting necessary documents to be uploaded and associated with a donor chart; clicking a checkbox for review; and clicking a save donor button. Other embodiments are also disclosed.

### REFERENCE TO PENDING PRIOR PATENT APPLICATION

This application claims the benefit under 35 U.S.C. 119 (e) of U.S. Provisional Patent Application No. 61/033,311, filed Mar. 3, 2008 by Amy Johnson, et al. for “ELECTRONIC DONOR MEDICAL RECORDS MANAGEMENT SYSTEM,” which patent application is hereby incorporated herein by reference.

### BACKGROUND

Generally, medical records for donors of tissue are in paper form or otherwise linked to the tissue provided to a processing facility by an organ procurement organization. This requirement is necessary for determining if the tissue meets standards for use by the processing facility and, ultimately, for use as an allograph transplant.

Prior art processes are generally time consuming and labor intensive operations. Other computer based tracking software systems do not provide the level of information necessary in a user-friendly format. Accordingly, a new type of donor tissue medical records system is desirable.

### SUMMARY OF THE INVENTION

In an embodiment, there is provided an electronic donor medical records management system, comprising a recovery agency site having a first electronic chart component configured to allow a recovery agency to add online donor charts directly to the system; and a medical records site having a second electronic chart component configured to allow processing of the online donor charts.

In another embodiment, there is provided a method of managing electronic donor medical records in a system, the method comprising navigating a browser to a recovery agency site related to a donor; selecting an add donor link so as to be directed to an add donor page; selecting a prefix to identify a particular recovery agency; entering a recovery agency donor number to identify a donor; selecting necessary documents to be uploaded and associated with a donor chart being added to the system; clicking a checkbox for review when the donor chart is complete and a medical director of the recovery agency has signed off on the donor chart; and clicking a save donor button so as to store the donor chart.

Other embodiments are also disclosed.

### BRIEF DESCRIPTION OF THE DRAWINGS

Illustrative embodiments of the invention are illustrated in the drawings, in which:

FIGS. 1-98 illustrate various exemplary screen displays of the electronic donor medical record management system.

FIG. 99 illustrates a flow chart of a traditional medical records workflow.

FIG. 100 illustrates a flow chart of a joint restoration workflow.

FIG. 101 illustrates a flow chart of a skin exceptional release workflow.

### DETAILED DESCRIPTION

Definitions

OPO—Organ Procurement Organization; also known as a Recovery Agency

SharePoint—Microsoft web-based portal product that the Donor Medical Records Management System is built on

Syntergy—Module for SharePoint that maintains an audit trail of all document events such as add, update, or delete

Aquaforest—Product that allows users to view, add, and modify annotations on a TIFF document, such as sticky notes or free text

TIFF—File format used for storing scanned paper documents

Web Part—Custom plug-in module for SharePoint, used to add additional functionality to the SharePoint product

Site—An encapsulated area in SharePoint for collaborating and storing documents and lists

Site Template—A set of files defining what a site looks like when it is created

IIS—Internet Information Services; Microsoft web server product

Active Directory—Microsoft directory server for maintaining users, passwords, and group membership

JR—An acronym for Joint Restoration which refers to donor tissue that is suggested to be of pristine quality intended for graft processing and/or transplantation

Form—A file that is electronically created and populated with donor medical information; all data is editable and easily extracted electronically

Document—A file that is scanned and uploaded into the system; documents represent “pictures” of medical records data so information cannot be extracted electronically from scanned documents

Signature Meaning—An available choice a user has to attest to when they sign a form

InfoPath—Microsoft Office product for creating and filling out electronic forms

Report—Human-readable representation of the state of a data set, such as donor charts

The Donor Medical Records Management System consists of two main components as follows.

Recovery Agency Sites

The electronic chart component utilized by the Recovery Agencies allows Recovery Agencies to add donor charts directly to the system. Once the donor chart has been added to the system, Medical Records Site Personnel (which are generally referred to herein as AlloSource personnel) my access it to process each donor chart through to completion. The Recovery Agencies also have the ability to add and replace documents not available when the donor chart was originally added to the system.

Medical Records Site

The electronic chart component utilized by Medical Records (or AlloSource) personnel allow the processing of these online donor charts. The Medical Records personnel (e.g., Allosource) access the donor charts that were added by the Recovery Agencies, review the information, update related forms, attach additional documentation and perform online signatures/approvals.

All authorized users are able to view the donor charts pertinent to their area at any stage in the process. There are system defined statuses tagged to each donor chart as it moves through the process that will provide a quick overview of where that chart stands. If more information is required, there are several ways to drill down on the system data for further details.

The benefits of an automated process ensure a more streamlined and error-free approach. Documentation is stored electronically and tied to a specific donor chart for easy access and retrieval. The capability for remote chart approval by the Allosource Medical Director results in a quicker turnaround in processing the donor charts through the various stages to completion. The system has built-in audit trails, document versioning, document history, and electronic signatures, which all ensure FDA compliance.

Users generally include two distinct sets of users. The users working at a Medical Records (e.g., Allosource) location are logged into the Allosource network directly. The second set of users access the medical records software remotely, for example, via a Cisco Systems Virtual Private Network “tunnel”. The VPN provides a secure mechanism for gaining access to the Allosource network and handling the donor charts.

Medical Directors and other remote users must gain access to the Allosource network via the provided VPN to work with the donor medical records system. The change password feature described below does not need the VPN to be active as it may simply accessed via an internet web page.

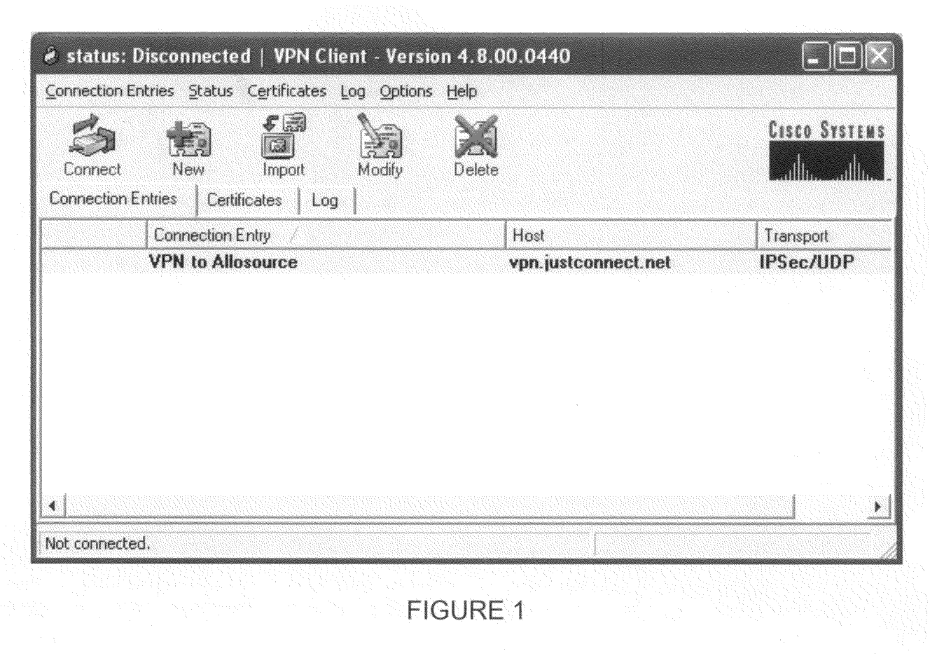

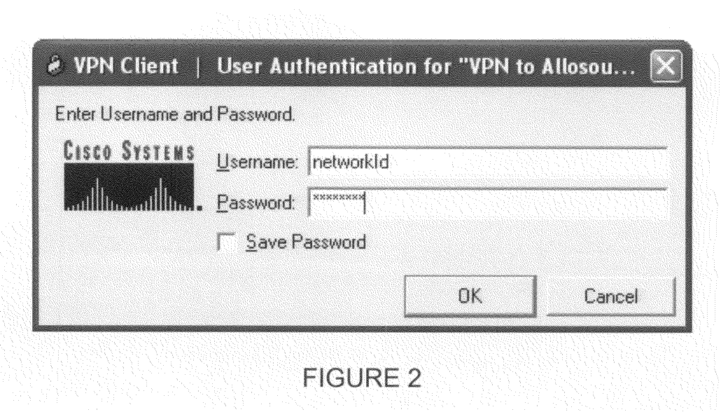

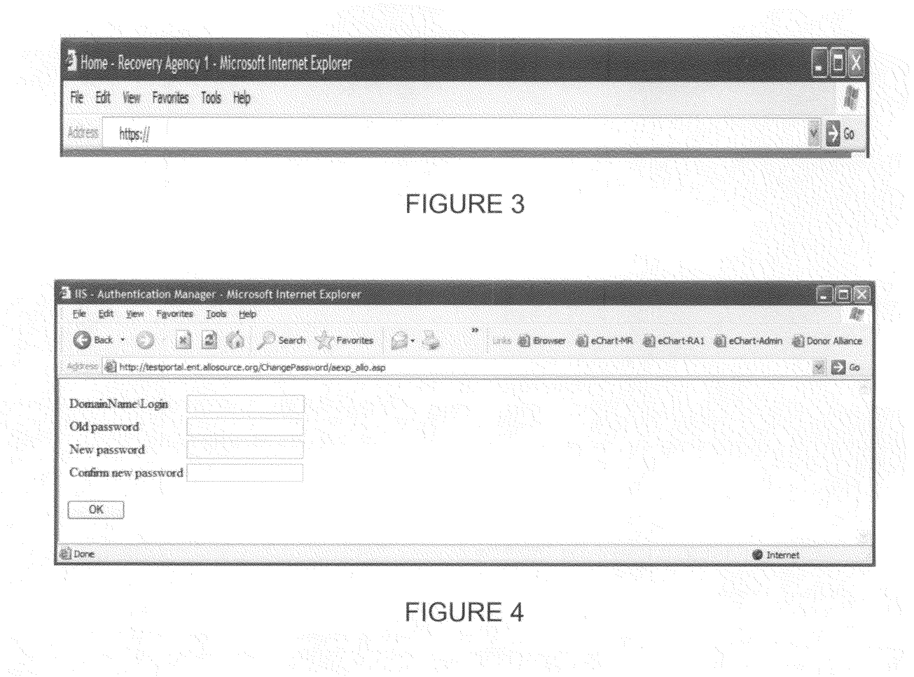

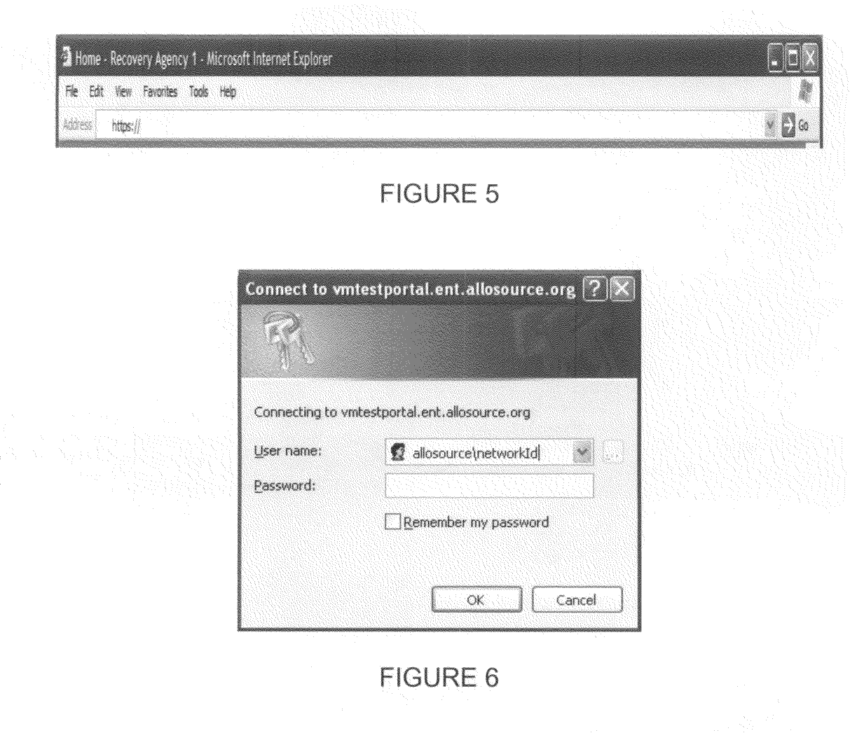

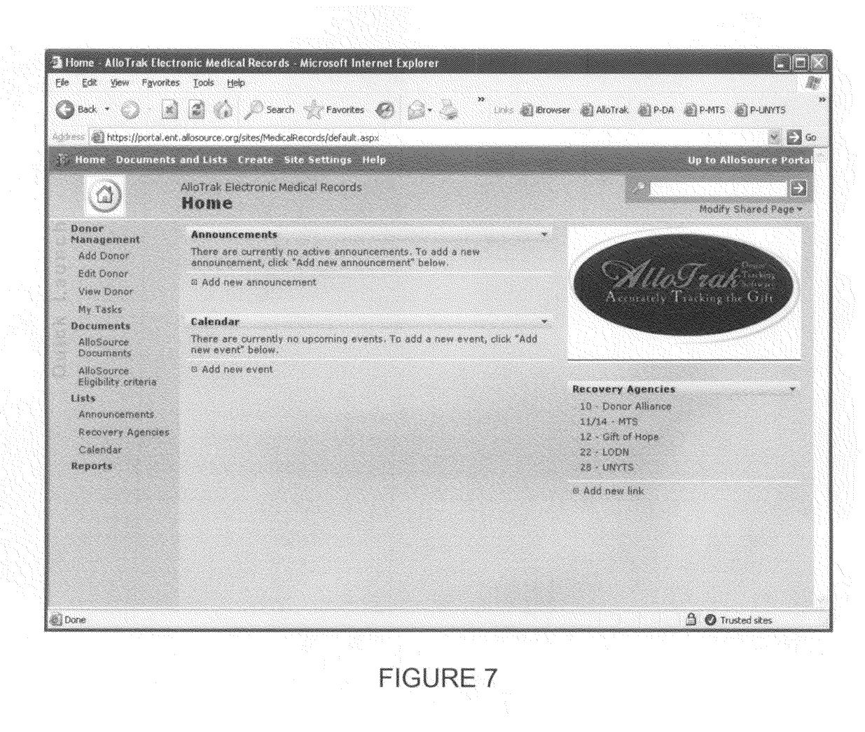

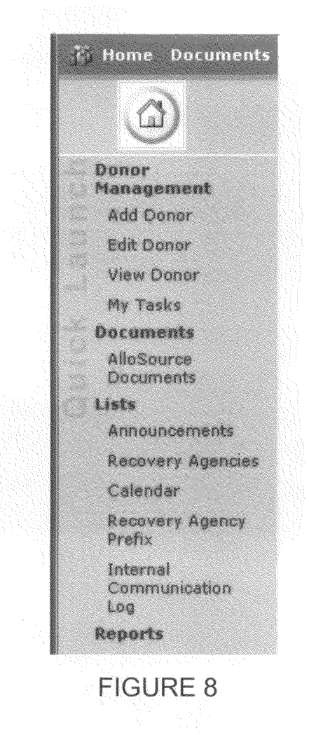

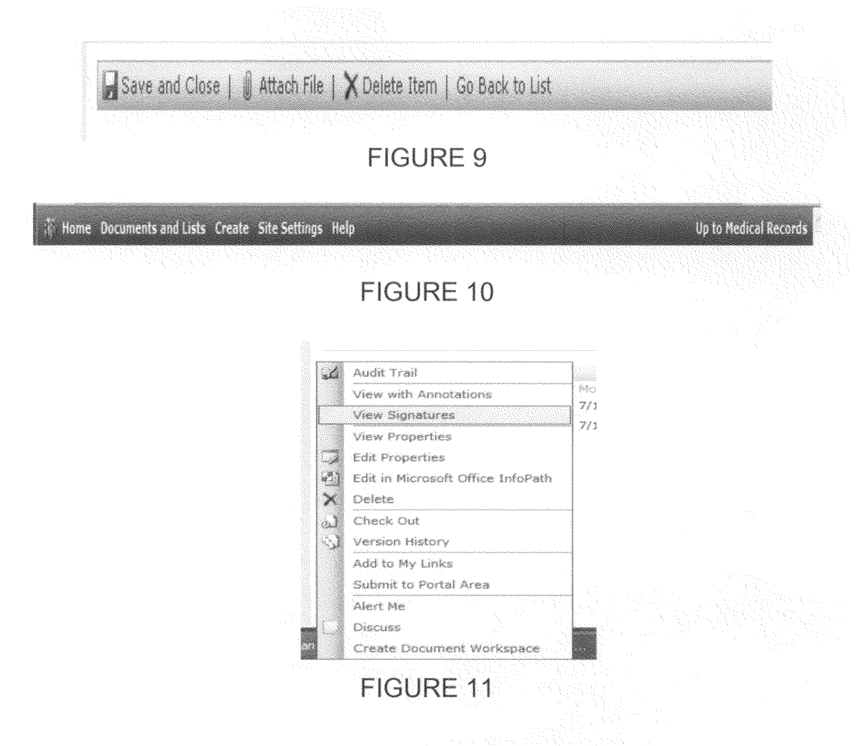

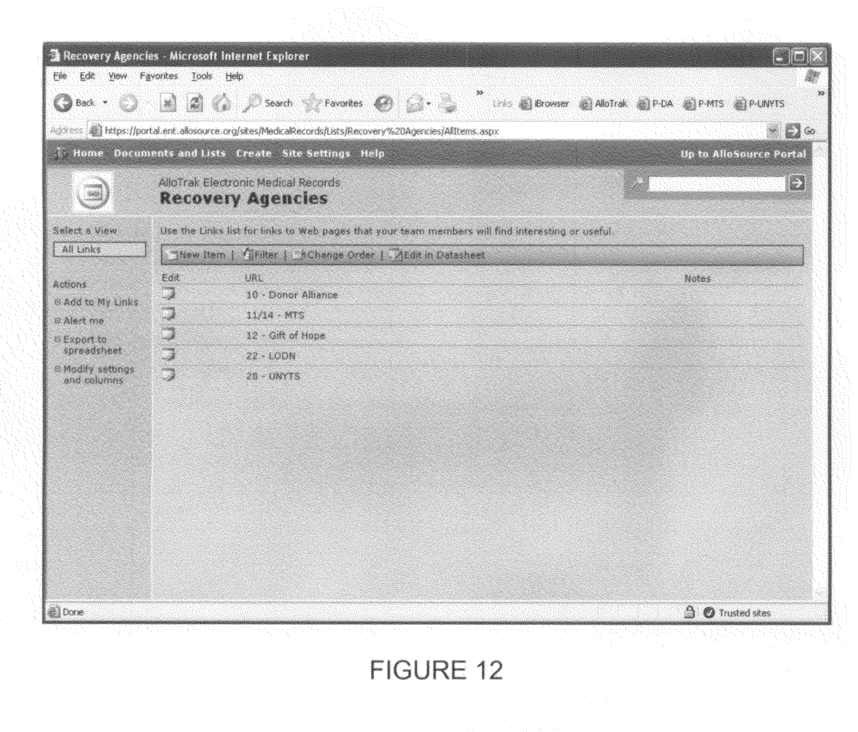

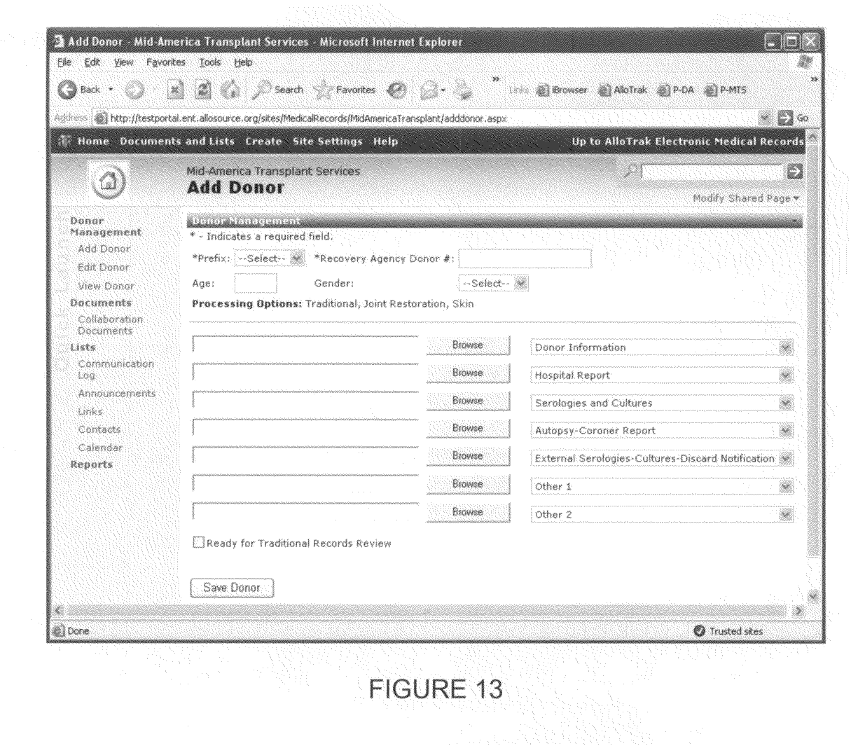

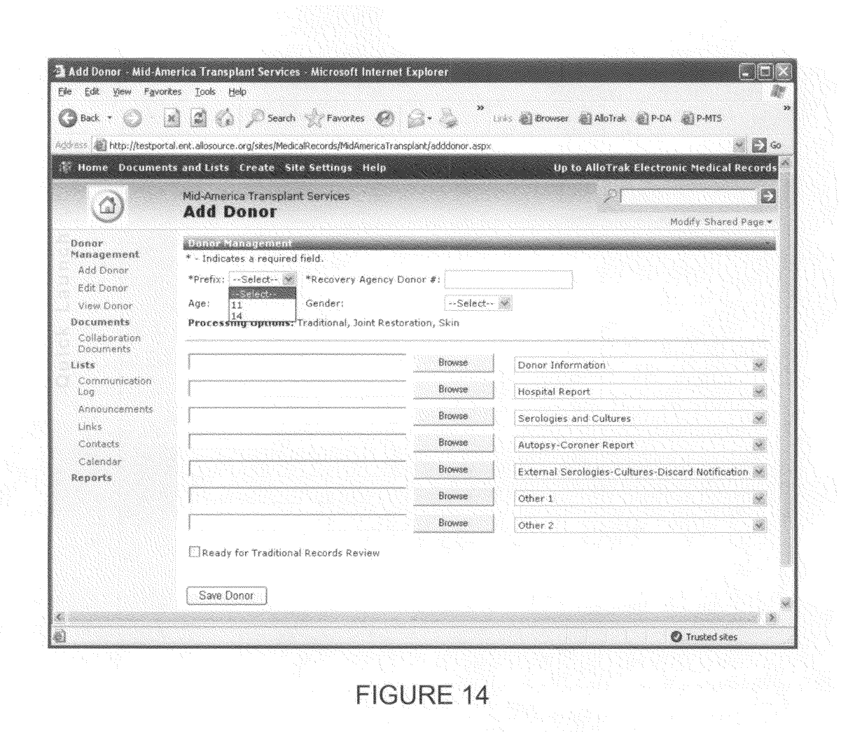

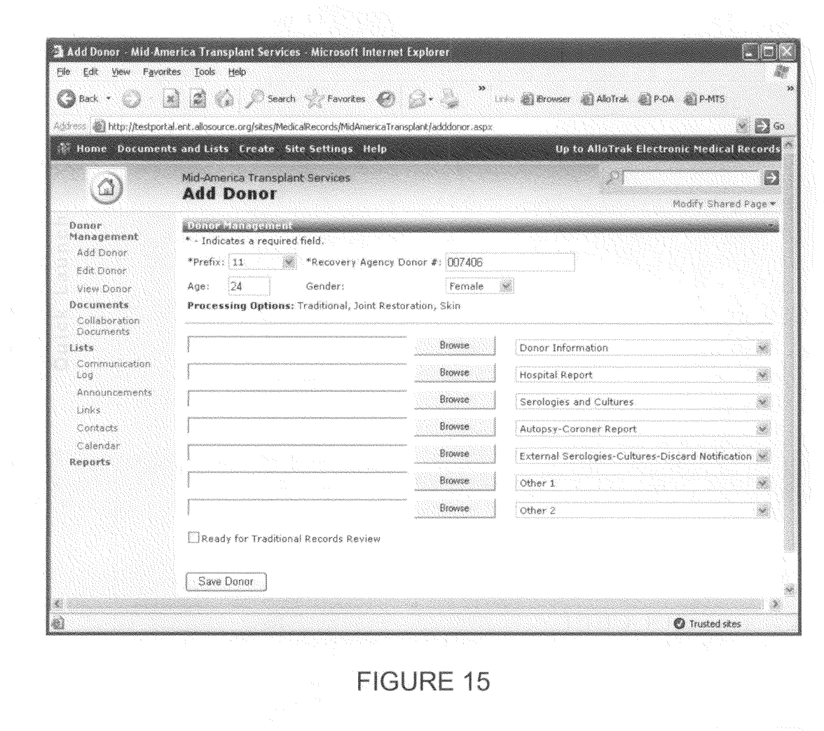

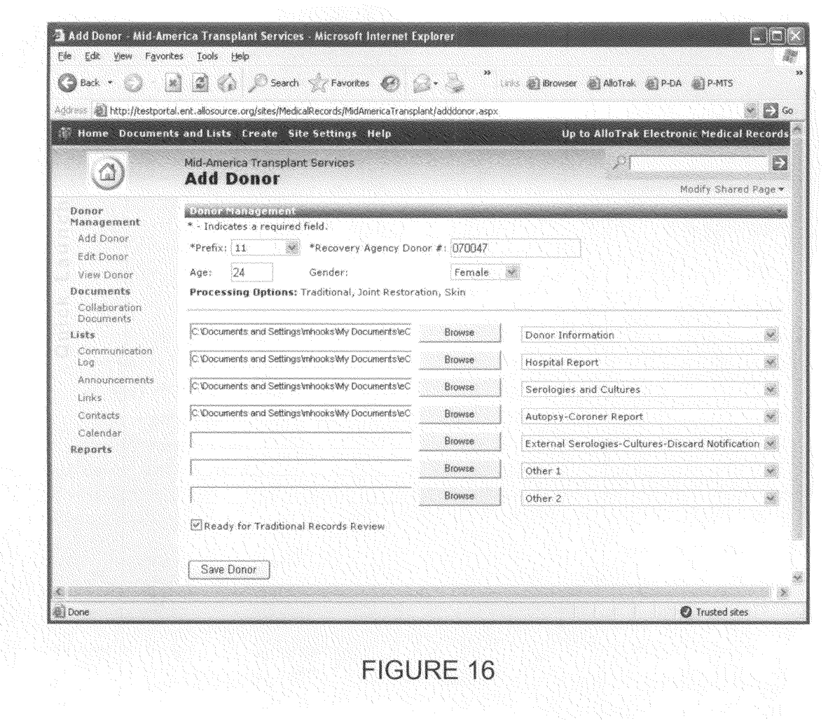

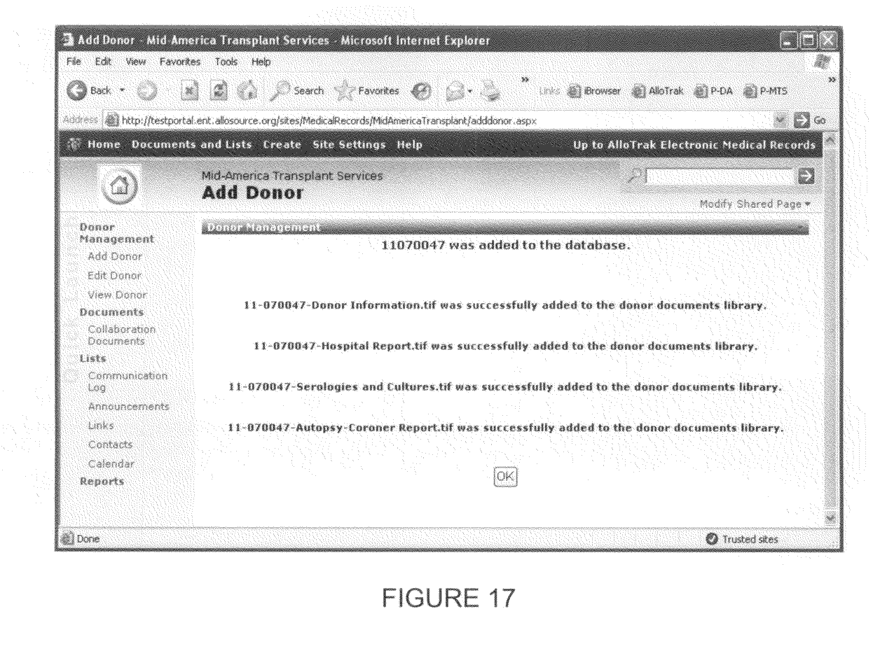

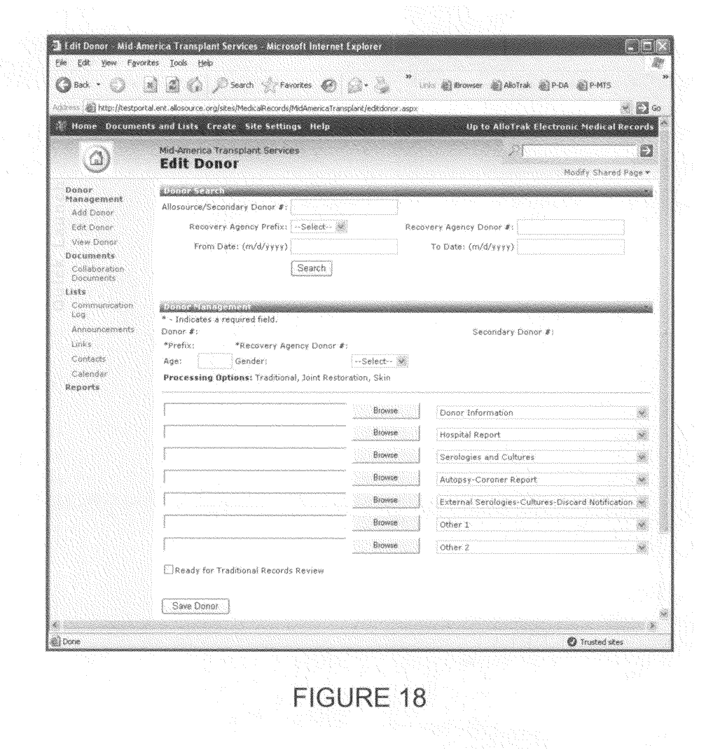

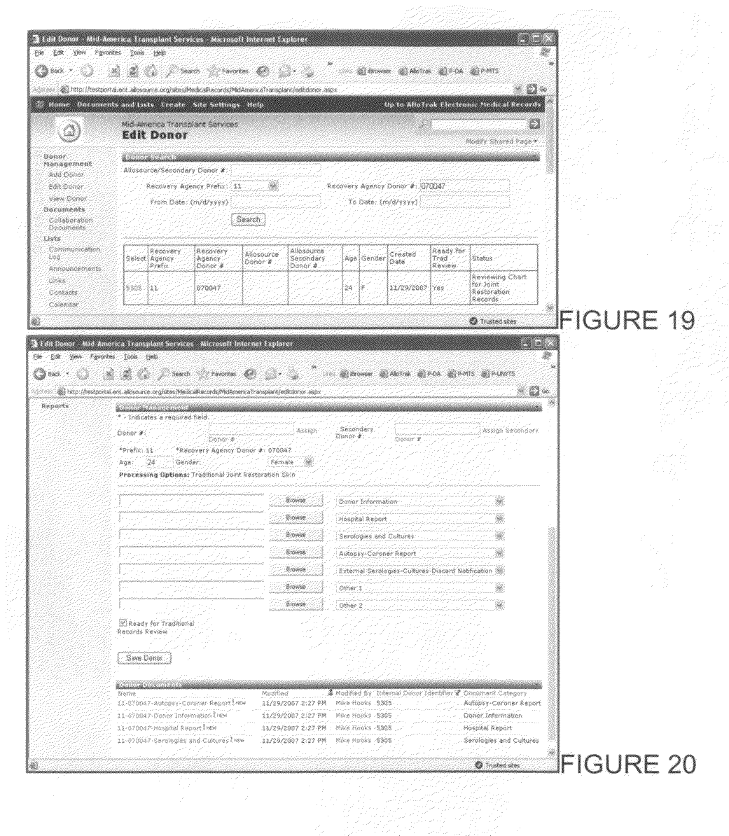

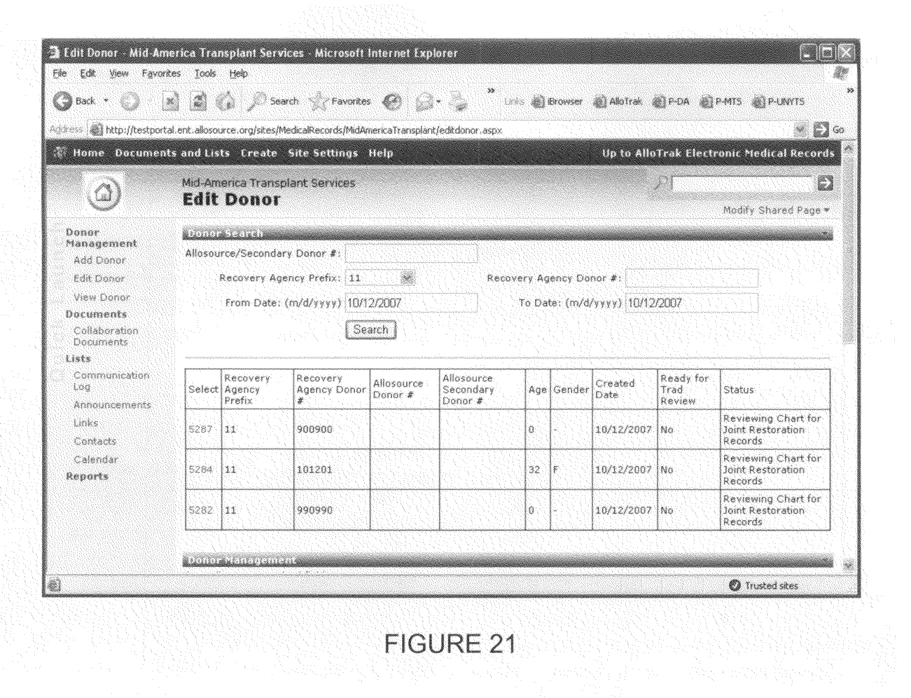

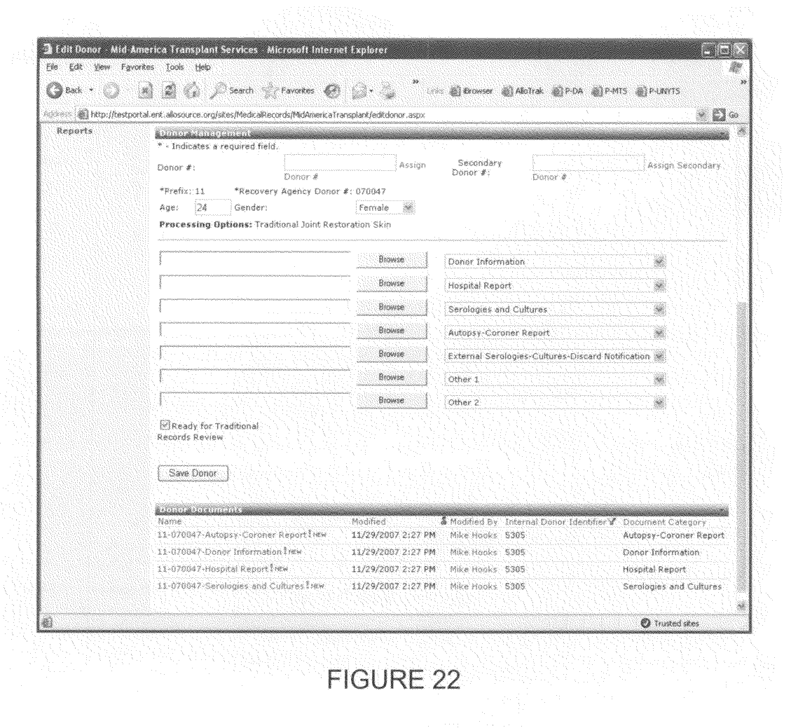

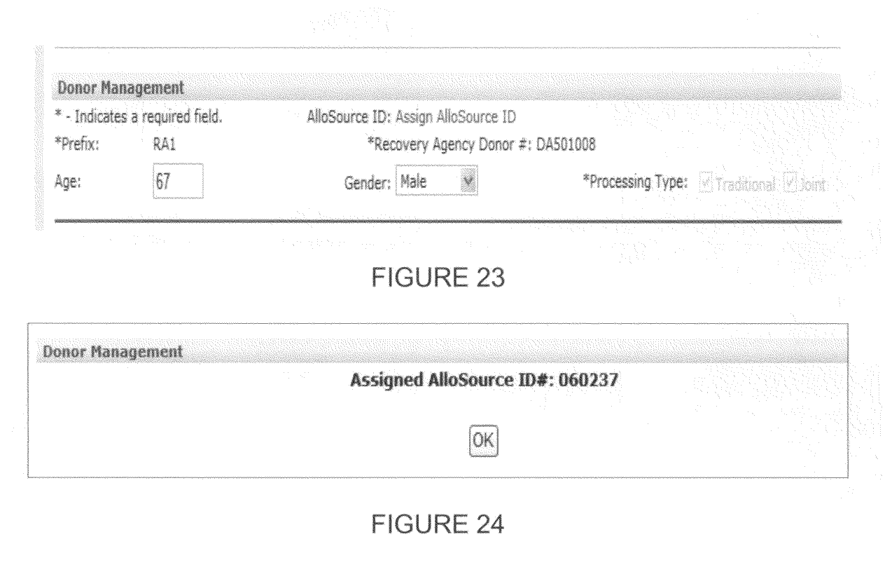

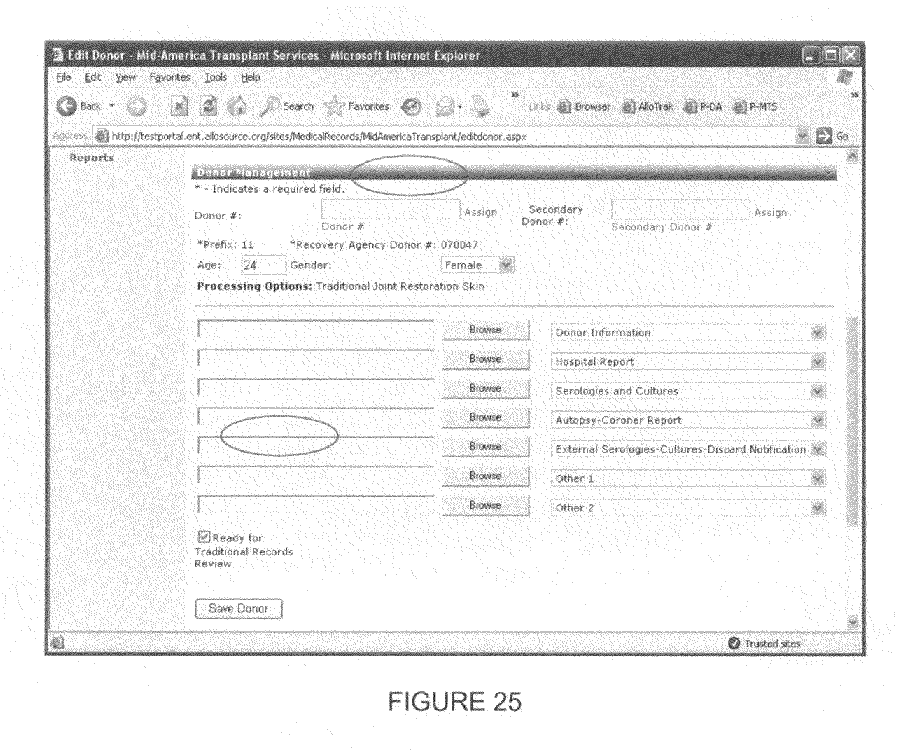

While activating the VPN tunnel, the remote users will see two popup dialogue boxes (see FIG. 1 and FIG. 2.) The first dialogue box (FIG. 1) requires the user to select VPN to AlloSource and click on the Connect icon. The second popup dialogue box (FIG. 2) is the User Authentication. A valid user id and password may be entered here.

Medical Directors and Recovery Agency users are able to change their password via a secured website when needed. The VPN tunnel does have to be active for this functionality.

Open an Internet Browser, and key the designated URL (https://portal.ent.allosource.org/ChangePassword) in the address field of the browser. Note that the URL is preceded with https:// (“https” indicates a secured connection). (See, for example, FIG. 3.) Click on the arrow to the left of the address field on the browser's toolbar to access the website.

Referring to FIG. 4, enter the fields as follows:

DomainName\Login

Domain Name=AlloSource

Login=this is your AlloSource network userid, which will normally be the first name initial followed by the full last name. For an example, this would be entered as:

AlloSource\pjohnson.

Old Password—Enter old password

New Password—Enter new password

Confirm new password—Re-key password again

Passwords need to be at least 7 characters. Spaces are not allowed. One Numeric, special character or uppercase is required for security. An example would be “password” or even better, “Pa$$worD”. After entering the required information, click OK. You can now access the AlloTrak System using your new password.

The Medical Records Site may be accessed by all applicable AlloSource users and Medical Directors via a URL (Uniform Resource Locator), commonly called a web address. This URL will be secured for access by only those users who are authorized to access the system. If your internet options are set to automatically logon to the eChart site you will NOT see the logon prompts. If your internet options are set to prompt for logon then users will be prompted to sign in to the system. Users will utilize their AlloSource network ID to be authenticated as an authorized user in order to gain access into the system.

Referring to FIG. 5, open an Internet Browser, and key your designated URL in the address field of the browser. https://portal.ent.allosource.org/sites/MedicalRecords/default.aspx. Note that the URL is preceded with https:// (“https” indicates a secured connection). Click the arrow to the right of the address field on the browser's toolbar to access the site. If you have automatic logon enabled then you will not see the popup shown in FIG. 6. Otherwise you will be prompted first with a dialogue box asking that you sign in with your domain\userid and password. Enter the required information, and click OK. Once access to the system has been made, users will be directed to the Home page in the Medical Records Site.

Once the authorized user accesses the Medical Records Site, the Medical Records Home page shown in FIG. 7 will be displayed.

In an embodiment, a SharePoint Site has been created for the Medical Records functionality, which will be separate from the Recovery Agency Sites. The Medical Records Site via the Home page may be the entry point into the system for these applicable users and will give them an easy way to navigate and access the various components required to perform their jobs. Internal forms and documents, procedures, along with internal communication such as a department calendar and announcements will also be maintained in this site. The Donor Medical Records Management System provides separate sites for each Recovery Agency so that donor documents are physically stored separately. Internal Medical Records (e.g., AlloSource) documents and forms will be stored in the Medical Records Site rather than with the Recovery Agency documents. Recovery Agencies only have access to their sites whereas Medical Records users will be able to access each Recovery Agency site. Links may be provided from the Medical Records Site's Home page to each of the Recovery Agency Sites so that electronic donor charts, the associated documentation, and communication log entries can be accessed and retrieved easily.

Referring to FIG. 8, there is provided a navigation bar. Navigation is simply the means to move from one page or section to another. There are points that need to be highlighted when navigating through the various pages (i.e., screens).

Generally, it is not recommended to use the back or forward arrows (on the web browser toolbar), unless there is no other means to return back or advance forward to a page or section in your application. Although it may not occur in all cases, using the web browser features instead of the ones built within the application could result in unpredictable system behavior. The main toolbar in the application (found on the upper portion of every page) may include a Home link. Selecting this link will return the user back to the Home page if no other navigation has been provided. Also, it is important not to close the web browser to end a transaction. For instance, in some processes you must save first before exiting or submit the transaction to the database for it to be finalized. Closing the web browser before performing a save, submit or other designated application requirement will result in loss of the data just entered or processed.

The Left-Hand Navigation Bar (FIG. 8) is the area on the Home page and any subsequent page accessed in the system and helps direct the user to the correct place to perform a task or activity. Each item listed on the Left-Hand Navigation Bar is a hyperlink that when click on will direct you elsewhere. The items listed in the Left-Hand Navigation Bar may vary by the page you are on, and by a user's security access.

Referring to FIG. 9, there is shown an example of a tool bar. A toolbar is a row, column or block of onscreen buttons or icons, that when clicked, activate certain functions of the program. The toolbar and the buttons displayed on the toolbar can also vary by page. Some toolbars will only be displayed on certain pages or when a specific function or task has been selected.

FIG. 10 illustrates a toolbar that may be provided at the top of every main page in the application. If you are in a Recovery Agency site and want to return back to the Medical Records site, select the “Up to Medical Records” link from the upper right section of the toolbar.

An example of a drop-down box is illustrated in FIG. 13. Some of the data fields displayed on a page might contain a drop-down box. When the down arrow is clicked, a drop-down list of valid options will be displayed. Some of these options are selected to populate the field with data, and some are selected to direct you to another place in the application where a function can be performed.

In addition to the previously mentioned navigation methods, many system processes will direct you back to the page from where you started the process, after a “Save Donor” button has been activated.

The following are terms may be referenced in relation to the Donor Medical Records Management System.

Annotations

In an embodiment, Aquaforest software allows users to view, add and modify annotations on a TIFF (scanned) document, such as sticky notes or free text. These annotations can be viewed by all users who have access to the specified document.

Document

In terms of how it is defined in the Donor Medical Records Management System, a document refers to any identifiable portion of the Donor Chart or Memorandum, etc. that is added to the donor chart. For example, Donor Information, Serology-Microbiology Report, Hospital Report, etc. This is the information that is scanned by the Recovery Agencies when adding donor charts to the system.

Form

In terms of how it is defined in the Donor Medical Records Management System, a form is any piece of paper that requires it to be filled out. In an automated system, these will be electronic forms that will require user input. For example, Donor Chart Medical Review Form, Tissue Disposition Review Form, and the Graft and Culture Summary Form. Forms will be a responsibility of Medical Records personnel (e.g., AlloSource personnel), and will be stored electronically in the Medical Records Site.

HTTPS URL (Uniform Resource Locator)

An HTTPS URL, commonly called a web address, is usually shown in the address bar of a web browser. This will be the secured address that you use to access the Donor Medical Records Management System.

Image Viewer

An image viewer or image browser is a computer program that displays a stored graphical image. This is the tool that will be used to view scanned documents. There are various types of viewers available and what type is utilized may vary by location/computer.

K2 Workflow

This is a workflow automation tool that is being utilized by AlloSource to help manage data, tasks and auditing.

Metadata

This is data that describes other data, by acting as a reference or index. It can be used to improve searching for other resources.

Microsoft Office InfoPath

This is an application that was used to develop the internal Medical Records forms. In addition to creating electronic forms, InfoPath provides the means of filling out the forms electronically.

Microsoft SharePoint Portal Server

SharePoint is a web-based portal product on which the Donor Medical Records Management System is built. It is the basic graphical user interface (GUI) in the browser, standardized layout and navigation, hierarchical site structure, and search engine. It provides “Document Libraries” to handle features such as versioning, upload and viewing, and “Lists” for maintaining contacts, links, and issues. It ensures authentication and authorization for users to only access the content to which they have permissions.

Microsoft SharePoint Site

A SharePoint Site will be created for Medical Records (e.g., AlloSource) users and Medical Directors, which will be their entry point into the system. Multiple SharePoint sub-sites will be created; one for each Recovery Agency. Consider these sub-sites as a shared workspace with AlloSource. All scanned documents that are uploaded to the system will reside on the site that corresponds to the appropriate user group. A Recovery Agency will be able to view their donor charts, but not those of another Recovery Agency or the information that resides on the main Medical Records Site. Authorized AlloSource users will have the means to access each Recovery Agency site for the purposes of accessing, processing and finalizing the donor charts, hence the concept of a shared workspace.

Microsoft SQL Server

This is the storage medium for SharePoint, Aquaforest, and Syntergy. All documents, document annotations, audit trails, and configuration data is stored here. SQL Server also provides a place to put custom databases that may be used for reporting or data integration with Recovery Agencies.

Synteray

This is a module for SharePoint that is being used to maintain a time-stamped audit trail of all document tasks being performed in the system. This will provide the compliance required by the FDA.

TIFF

This is a file format used for storing scanned paper documents in the system. Click on a TIFF file to open and display in whatever Image Viewer/Browser you have set up on your computer. All TIFF files will be stored electronically on the Recovery Agency site to which it belongs or on the Medical Records Site if they relate to internal AlloSource documents.

Donor Chart Management

The Donor Medical Records Management System has been designed to allow authorized users to add new donor charts to the system, and edit or view existing donor charts that already reside in the system. The following pages will take you through the steps for each Donor Management task found in the Medical Records Site.

Donor Charts are separated by function rather than combined into one large file.

Recovery Agencies or Medical Records (e.g., AlloSource) users will be required to upload documents into one of the following categories (if applicable) when adding a donor chart in the system: Consent-Med Soc, Procurement Records, Cultures-Serology, Medical Record, Autopsy-Coroner Report, Traditional Tissue Medical Director Release, Joint Restoration Tissue Medical Director Release, or Other Information.

AlloSource users will upload internal documents into categories established for their purposes.

The “Add Donor” and “Edit Donor” options within the Donor Medical Records Management System require the user to choose the category of document they are uploading by using a pre-defined drop-down list.

The file names of the documents to be attached to a donor chart in the Donor Medical Records Management System must be unique within the Donor Chart. Duplicate filenames attached to the Donor chart in the “Add Donor” process will cause the file upload process to fail with the following error message “There has been an error uploading the documents, please verify that the document library name has been set in the webpart properties. Error: Object reference not set to an instance of an object.”

Add Donor

For the most part, Recovery Agencies will be adding donor charts to the system for the Traditional processing types, but for the other scenarios (i.e., Skin and Joint Restoration processing types) Medical Records staff will need to add the donor charts. Whoever adds the donor chart, note that it will always be entered via the Recovery Agency site to which it applies. This means that for Medical Records (i.e., AlloSource) users, the user needs to navigate first to the appropriate Recovery Agency Site.

If a user selects the “Add Donor” link from the Home page of the Medical Records Site, an additional page will be displayed reminding the user that a donor chart can only be added through a Recovery Agency Site. From a list of valid Recovery Agencies listed on this page, the user can simply select the appropriate Recovery Agency from the list. (See, for example, FIG. 12.)

Reference is made to the following steps when adding a new donor chart to the system. From the Home page, navigate to the Recovery Agency Site to which the donor applies. Once you have accessed the Home page for the appropriate Recovery Agency Site, refer to the Donor Management section in the left-hand navigation bar. Select the “Add Donor” link. The user is now directed to the “Add Donor” page as shown in FIG. 13. The appropriate prefix for the Recovery Agency is defaulted if there is only one prefix for the Recovery Agency. Depending on the Recovery Agency, there may only be one prefix and, for some Recovery Agencies, there might be more. As illustrated in FIG. 14. the drop-down displays the valid option(s) for the Recovery Agency site that has been accessed. Refering to the “Prefix” field, the drop-down arrow is clicked to select the appropriate prefix.

Next, and referring to FIG. 15, the “Recovery Agency Donor #” is keyed in the designated field. In an exemplary embodiment, the value must be numeric and 6 digits long. The Medical Records facility (i.e., AlloSource) will key the number the Recovery Agency has assigned to the donor. Along with the donor number, specify the Age and Gender in the designated fields for the donor being added. Specifying the Age and Gender of the donor is optional. The system will automatically allocate the appropriate processing types based on the Recovery Agency contracts.

A donor chart can generally consist of Consent-Med Soc, Procurement Records, Cultures-Serology, Medical Record, Autopsy-Coroner Report, Traditional Tissue Medical Director Release, Joint Restoration Tissue Medical Director Release, and Other Information. This varies by Recovery Agency and the add donor screen will be different based on the agreed upon document categories. See, for example, FIG. 15. These categories will aid in the proper segregation of the donor chart documents when they are uploaded to the system. Ensure documents are uploaded with the appropriate document category. Once the donor chart has been submitted and uploaded to the system, the document category cannot be changed once saved. This requires that the document be uploaded again with the correct document category if necessary.

The appropriate documents are selected that need to be uploaded and associated with the donor chart being added. The appropriate “Browse” button may be clicked twice to perform a search for the required document on your local computer/network. Once the document is found, it may be highlighted and the “Open” button is clicked so the path (i.e., location) is displayed in the designated field on the “Add Donor” page. The next time a “Browse” button is clicked twice the proposed search path is the last path where a document was selected. The system will “remember the path” to the document location. The user should ensure each document being attached is associated with the proper document category.

In one embodiment, file names do not matter when uploading the documents. The system takes the name of the document as it resides on the hard drive or location from which it was scanned. The same file cannot be uploaded to two different document categories in the same upload or an error will be generated. If needed, repeat the above process as many times as required to attach the required supporting documentation for the donor chart being added. The “Add Donor” page supports the agreed upon document categories for the Recovery Agency.

Referring to FIG. 16, click the “Ready for Traditional Records Review” checkbox if the Donor Chart is complete and the Recovery Agency Medical Director has signed off on the chart. This tells the Medical Records (AlloSource) Traditional Medical Records Specialists that the chart is ready for Medical Records (AlloSource) review. The checkbox should remain unchecked until both of these conditions are true. After attaching the required documentation on the “Add Donor” page, click the “Save Donor” button. The browser should not be closed at this time as the activity might not complete successfully. Wait for a “success” message and click on the OK button. This will finalize the transaction for adding and uploading that donor chart (and supporting documentation) to the system.

If the donor chart is uploaded successfully, a message will be provided and may similar to the example illustrated in FIG. 17. Click the “OK” button to confirm the message. The system will direct the user back to where another donor chart can be added. Once all scanned documents are uploaded for a specified donor chart, they are stored on the Recovery Agency Site on the Medical Records (e.g., AlloSource) server.

Edit Donor

The Edit Donor option allows the user to access a donor chart that already exists in the system. This may be required to update certain editable properties about the donor, add additional supporting donor documentation, add internal AlloSource documentation, or replace new versions of existing documents for a specified donor.

Depending on the type of editing that needs to be performed, the “Edit Donor” option will proceed to one of the following sites.

Recovery Agency Site

As in the Add Donor option, users navigates to the appropriate Recovery Agency Site to edit donor properties, add additional donor documentation or replace existing donor documentation. Remember, all donor documentation resides on the Recovery Agency Site to which it applies; therefore, that Recovery Agency Site must be accessed in order to access those documents. Donor documents that reside on the Recovery Agency Sites include the agreed upon documents pertinent to a Recovery Agency.

Medical Records Site—To edit donor properties, add internal Medical Records (e.g., AlloSource) documentation or assign the internal donor number (AlloSource ID) to an existing donor chart, the Edit Donor option is selected from the Medical Records Site as all internal Medical Records (i.e., AlloSource) documents are stored there. Documents that reside on the Medical Records Site are still being finalized.

Editing donor properties can be handled from the Recovery Agency Site (to which it applies) or the Medical Records Site; it is just the supporting documentation for that chart that is site specific.

Referring to FIG. 18, from the Home page, refer to the Donor Management section in the left-hand navigation bar. Select the “Edit Donor” link. The user is directed to the “Edit Donor” page as shown in FIG. 18. The Edit Donor page in the Medical Records Site contains 3 sections, which include Donor Search, Donor Management and Donor Documents. Once a donor chart is selected to edit, these sections are populated with the specific data, if applicable.

There are several ways to search for a donor chart that already resides in the system. The system was designed to allow users to find donor documents by AlloSource ID, Recovery Agency ID, or Donor Chart Creation Date. Refer to the “Donor Search” section of the page to perform a search. To search based on AlloSource ID, refer to the “AlloSource Donor #” field. Enter the applicable AlloSource donor number. To search based on Recovery Agency ID, refer to the Recovery Agency fields. Click on the drop-down arrow on the first field to select the appropriate Recovery Agency. Click on the drop-down arrow for the second field to select the Recovery Agency prefix. If there is only one prefix for the Recovery Agency, it will be defaulted automatically. In these cases, a user only needs to enter the donor number. In the field to the right of the prefix, key the Recovery Agency donor number. To search based on the Donor Chart Creation Date, a user may not know the exact creation date, which is why a date range search has been provided. Enter a start date in the “From Date” field and an end date in the “To Date” field. The date format is m/d/yyyy. After specifying your chosen search criteria, click search.

In one scenario, referring to FIGS. 19 and 20, if the system finds the donor specified in the search, it will display the details in the middle of the page, populate the “Donor Management” section with information applicable to that donor, and display any documents that have already been uploaded or system generated forms under the “Donor Documents” section. In another scenario, referring to FIG. 21, if based on the search criteria, the system finds a range of donors, these donors will all be displayed in a grid as shown. In this scenario, simply click the number that corresponds to the donor chart to edit. The Donor Management and Donor Documents sections are populated accordingly.

FIG. 22 displays the information that exists in the system for the specified donor chart. There are several reasons a user might need to edit an existing donor chart. One reason is to change or add properties for a donor. There are only two fields that can be updated in the system for an existing donor currently. These fields are reflected under the “Donor Management” section. These include change (or add) for the Age and Gender, if needed. To upload new documentation or replace existing documentation for a donor chart, file names do not matter when uploading the documents. The system will take the name of the document as it resides on the hard drive or on the location in which it was scanned. Similar to when the supporting documentation was first added for the donor chart, a user needs to click “Browse” to find the document on your local computer/network, highlight and click “Open” to update the designated field with the document path (location). The user must specify a document category by clicking on the drop-down arrow and selecting the appropriate description for the document being added. This upload process may be repeated as many times as needed. As indicated above, the document category cannot be changed for a previously uploaded document. It is possible to upload the document again, this time selecting the correct categorization.

To assign an internal donor number (AlloSource ID) to an existing donor chart, there are two links to assign the number. Referring to FIGS. 23-25, either link can be used once which will sequentially assign the next donor id number. Joint Restoration or Medical Records click on the appropriate link depending on the circumstances. If the donor is a JR and a Skin donor, both of the links will be used and Traditional Medical Records will share the JR donor number. If the donor is a Jr/Trad donor or is a Skin/Trad donor then only one “AlloSource Donor” id is required. The open boxes next to each donor id assignment link is available for a situation where the donor medical records management system was unavailable for a period of time and AlloSource Donor Ids were assigned using a manual log book. The donor id from the manual log book must be entered using these open boxes when the donor medical records management system is available again. Looking at FIG. 23, under the “Document Management” section of the page, refer to the “AlloSource ID” field. Select the “Assign AlloSource ID” link. The system will automatically assign the next sequential number, and display it on the page as shown in FIG. 24. Next, the “OK” button is clicked to accept this assignment. When the donor chart is re-accessed, the “Edit Donor” page will now display the assigned donor id as shown in FIG. 25.

The “Ready for Traditional Records Review” checkbox is clicked if the Donor Chart is complete and the Recovery Agency Medical Director has signed off on the chart. This tells the AlloSource Traditional Medical Records Specialists that the chart is ready for AlloSource review. The checkbox should remain unchecked until both of these conditions are true. After making any changes on the “Edit Donor” page, the “Save Donor” button must be clicked to finalize the transaction and allow the system to perform the necessary updates. It is recommended to not close out the browser before clicking the Submit button as the changes just made may be lost.

Referring to FIG. 26, the “View Donor” option is used to query information on existing donor charts without the need to edit information or add any additional documentation. This option may be used to view donor charts and the supporting documentation, print donor chart information, view annotations, etc. Depending on what needs to be viewed will dictate the site from which the “View Donor” option will need to be taken.

Recovery Agency Site

As in the Add Donor and Edit Donor options, users need to navigate to the appropriate Recovery Agency Site to view donor chart information that resides on the Recovery Agency Sites (all the Recovery Agency scanned documents), as well as add document annotations. Donor documents that reside on the Recovery Agency Sites may include, for example, Consent-Med Soc, Procurement Records, Cultures-Serology, Medical Record, Autopsy-Coroner Report, Traditional Tissue Medical Director Release, Joint Restoration Tissue Medical Director Release, or Other Information.

Medical Records Site

When viewing donor chart information that resides on the Medical Records Site (internal AlloSource documents and forms), the View Donor option can be selected from the Home page. Another task that is handled via the “View Donor” option is accessing system-generated forms for input. This includes “Documents” that reside on the Medical Records Site are currently being defined. This also includes “Forms” that reside on the Medical Records Site and may include, for example, Donor Chart Medical Review Form, Tissue Disposition Review Form, and Graft and Culture Summary Form.

FIGS. 26-30 illustrate viewing an existing donor chart. From the Home page, refer to the “Donor Management” section in the left-hand navigation bar. The “View Donor” link is selected. The user is directed to the “View Donor” page as shown in FIG. 26. The View Donor page in the Medical Records Site contains 2 sections, including Donor Search and Donor Documents. Once a donor has been selected to view, these sections are populated with the specific data, if applicable.

There are several ways to search for a donor chart that already resides in the system. The system allows users to find donor documents by AlloSource ID, Recovery Agency ID, or Donor Chart Creation Date. Referring to FIG. 27, a user may access the Donor Search section of the page to perform a search. To search based on AlloSource ID, at the AlloSource Donor # field the applicable AlloSource donor number is entered. To search based on Recovery Agency ID, at the Recovery Agency fields, the drop-down arrow on the first field is clicked to select the appropriate Recovery Agency. The drop-down arrow for the second field is clicked to select the Recovery Agency prefix. If there is only one prefix for the Recovery Agency, it will be defaulted automatically. In these cases, the user will only need to enter the donor number. In the free-format field to the right of the prefix, key the Recovery Agency donor number. If a user does not know the exact creation date, which is why a date range search has been provided. To search based on the Donor Chart Creation Date,_enter a start date in the From Date field and an end date in the To Date field. The date format is m/d/yyyy. After specifying the your chosen search criteria, click search.

If the system finds the donor specified in the search, it will display the details in the middle of the page, and display any internal AlloSource documents that have already been uploaded or system generated forms under the Donor Documents section. See, for example, FIG. 28. If based on the search criteria, the system finds a range of donors; they will all be displayed in a grid as shown in FIG. 29. In this scenario, the user simply selects the number that corresponds to the donor chart desired to view, and the Donor Documents section will be populated accordingly.

The grid will not disappear after making your selection, so if there were many results returned in the search, scroll down the page until you see the results displayed for the selected donor chart. At this point, the user is able to view the information that exists in the system for the specified donor chart as shown in FIG. 30. If a user needs to view the donor chart information in further detail, the forms and documents may be accessed as listed under the Donor Documents section.

Communication Log Tasks

Medical Records staff is required to keep a log of all communications with a Recovery Agency regarding any discrepancies found on donor charts. The Communication Log functionality allows for the recording and tracking of all discrepancies or issues that the Medical Records staff has identified with donor charts being processed in the system. The Communication Log will act as a custom issues list so that user comments are stored and a history retained of the actions that were taken to resolve the problems. Resolution of these issues must be handled before AlloSource can accept the donor.

There are “statuses” that are key to all the issues listed in the Communication Log and should be understood.

Active

This is the original status for an issue. It signifies that AlloSource Medical Records has created an communication log entry in an active state and needs to be addressed.

Resolved

This status is selected by the Recovery Agency when they have satisfactorily resolved the original communication log entry.

Closed

This status is assigned by AlloSource Medical Records when the log entry has been satisfactorily resolved. Although this status “closes” out the entry, it merely indicates that resolution to the issue has been met. The entry will remain on the communication log for future viewing, if needed.

To view or add communication log entries, Medical Records personnel must access the appropriate Recovery Agency Site. From there the user can view the communication log entries for a specific donor chart (via the View Donor option) or for a consolidated view of all communication log entries for the Recovery Agency (via the Home page, select the Communication Log link).

Users must use the SharePoint alert functionality to be notified automatically of new or updated Communication Log entries.

Users view existing communication log entries for a specified donor, as well as access the entries to make changes, when needed. Since the communication log is a communication between the Medical Records Site (e.g., AlloSource) and each Recovery Agency, AlloSource Medical Records will need to access the specific Recovery Agency Site to see or update the communication log entries associated with the donor chart. From the Home page, a user navigates to the appropriate Recovery Agency Site. Once the user has accessed the Home page for the Recovery Agency, the “View Donor” link is selected in the Donor Management section in the left-hand navigation bar. The user is directed to the “View Donor” page as shown in FIG. 31.

As discussed herein, there are several ways to search for a donor chart that already exists in the system. After the system has found and displayed the donor chart specified in the search, a user is able to see if there are any associated issues that have been added in the system (for example, in the Communication Log.) Looking at FIG. 32, and if there are issues listed, the mouse may be positioned over the title of the entry to display a drop-down box. The down arrow may be clicked to open a task list as shown in FIG. 32.

If a user wants to just view the issue, select “View Item”. The system will open that specific entry in another window for the user to view. The user will be able to see the action(s) taken for that specific issue as referenced in the “Issue History” section at the bottom of the page. The user can click on each specific entry listed to open the record and find additional details.

If the user wants to edit the issue, “Edit Item” is selected. The system will open that entry into an editable format for the user to change or update as needed as illustrated in FIG. 34. Here, the desired fields may be edited. After making any changes, “Save and Close” may be clicked on the toolbar. The system will save the changes made, and return back to the “View Donor” page. The “Go Back to List” button on the tool bar will return the user to the “View Donor” page without performing a save. This option is used when simply viewing an issue. Once the user returns to the “View Donor” page, a search may be conducted for the donor chart to verify the communication log entry reflects the changes just made.

A communication log entry can be added to the system for a specified donor chart if any issues are found. The communication log acts as an issues list and provides the ability to notify a person or persons responsible for resolving the issue. The Medical Records Site (e.g., AlloSource) needs to access the specific Recovery Agency Site to add a communication log entry associated with that Site and donor chart.

From the Home page, a user navigates to the appropriate Recovery Agency Site. Once the user has accessed the Recovery Agency's Home page, the “View Donor” link is slected in the left-hand navigation bar. The user is directed to the “View Donor” page as shown in FIG. 35. As discussed herein, there are several ways to search for a donor chart that already exists in the system. After the system has found and displayed the donor chart specified in the search, the user may add a new issue. The user refers to the Communication Log section as shown in FIG. 36. Next, the user selects the “Add new item” link. The “Communication Log: New Item” page will be displayed to allow you to add a new entry as shown in FIG. 37. A user may fill in all the information required to clearly communicate the issue and action that needs to be taken for the specified donor chart. The fields include:

Title

Enter a brief explanation for the issue being added. The title will be shown on subsequent pages so ensure that it is descriptive, yet concise.

Assigned To

Click on the drop-down list and select the person that will need to take action for this issue.

Status

Click on the drop-down list and select the appropriate status. “Active” is the original status. “Resolved” is selected by the Recovery Agency when they have satisfied the original communication log entry. “Closed” is assigned by AlloSource when they have confirmed the log entry issue has been resolved.

Priority

Click on the drop-down list and select the appropriate priority.

Comment

Enter additional information to further clarify the issue, if needed.

Due Date

Select the date and time for when this issue or action needs to be resolved. This field will be utilized by Medical Records—Joint Restoration.

Donor Id

Enter the Recovery Agency Donor identifier (which is Recovery Agency prefix followed by Donor Number). This information is critical for the system to associate this communication log entry with the specified donor and Recovery Agency. Omitting this information, or keying it incorrectly, will result in the entry not being visible to the correct Recovery Agency and thus the assigned user.

Referring to FIG. 38, click the “Save and Close” button on the toolbar after entering the required information. The system will add the issue to the Communication Log and an email alert will be sent to the user who was assigned to resolve the issue. The “View Donor” page is now displayed.

Once the user is returned back to the “View Donor” page, the donor may be searched for again to verify that this entry is now displayed under the Communication Log section. As illustrated in FIG. 39, this information will now be available to all users who are authorized to access the donor chart. Once an issue's status has been set to “Closed,” it will remain in the Communication Log for the applicable donor chart so a history of events can be retained and viewed.

To access all the issues assigned to a Recovery Agency (not just the ones associated with a specific donor chart), from the Recovery Agency Site, refer to the “Lists” section in the left-hand navigation bar (FIG. 40) and select the “Communication Log” link. The system will direct the user to a consolidated list of communication log entries associated to any donor chart applicable to that Recovery Agency.

Internal Communication Log

Referring to FIG. 41, the Medical Records Home page includes an Internal Communication Log. Issues that need to be tracked internal to the Medical Records site (e.g., AlloSource) should be entered and managed here. This is for the issues that Recovery Agencies are not responsible for resolving. The JR or Medical Records Specialist will create entries in this log as desired and will close issues as they are resolved. The information in this log is under control of the JR and Medical Records Specialists. The Internal Donor Chart Status uses this log to determine the appropriate status to display on the task list.

Document Annotations

Medical Records staff must have the ability to communicate with the Medical Director using notes/comments attached to documents in a donor chart to help aid the Medical Director in a chart review. The Medical Records site (e.g., AlloSource) is utilizing Aquaforest within the system to allow authorized users to add/modify or view annotations, better known as “sticky notes,” on a TIFF (i.e., scanned document) file.

Comments will be viewed as sticky notes on the documents themselves. These annotations can be viewed by any user in the system that has rights to view the document. All scanned documents stored in the system can be downloaded or viewed in the TIFF Viewer page. When documents are downloaded, the original file is shown without any annotations. When documents are viewed in the TIFF Viewer page, annotations are shown.

Annotations only apply to documents, not forms. The Medical Records site (e.g., AlloSource) will be applying annotations to the Recovery Agency donor documents (not their own internal documents). Therefore, annotations must be added and viewed on the Recovery Agency Site to which the document applies.

To view annotations on existing donor documents, a user must first access the specific Recovery Agency Site to which the donor chart applies. From the Home page, the user navigates to the appropriate Recovery Agency Site. Once the user has accessed the Recovery Agency's Home page, the “View Donor” link is selected in the left-hand navigation bar. The user is directed to the “View Donor” page as shown in FIG. 42. As discussed herein, there are several ways to search for a donor chart that already exists in the system. After the system has found and displayed the donor chart specified in your search, the user may view the associated information that exists in the system. In FIG. 43, attention is drawn to the “Donor Documents” section. Now looking at FIG. 44, the mouse is positioned over the name of the document desired to be accessed. This displays a drop-down arrow. Clicking on the down arrow opens a task list as shown FIG. 44. From this list, a selection of “View with Annotations” may be made. If the user clicks on a document to open it versus selecting the View with Annotations option, the document will be downloaded to the user's computer and opened with whatever application the computer has registered for TIFF (scanned) files. Annotations will generally not be shown in the downloaded file using this procedure. However, the system browser places the associated document in the Aquaforest Image Viewer so the user can see any sticky notes that have been added as illustrated in FIG. 45. It may take a few seconds for the document to be opened depending on the size of the file.

To add a new sticky note or modify an existing sticky note, follow the steps noted above to get to the point of having accessed and opened the document in an Image Viewer. To add an annotation, position the mouse over to the (outermost) right-hand, vertical scroll bar on the Image Viewer and click on the down arrow as shown in FIG. 46. The viewer may be scrolled downwards until the bottom toolbar is shown. The user may go to the page in the document where a sticky note is wanted using the display and arrows shown in FIG. 47. A user can determine if the document contains more than one page by looking at this toolbar (FIG. 47) in the viewer for the page number display. The system allows the user to click the next/previous arrows to access the correct page in the document.

The “add annotation” button may be invoked from the lower toolbar on the Image Viewer. This will activate the page in “add annotation” mode and allow for a sticky note to be added to the document. The mouse may be positioned to the area on the page where the note should be added with a click of the left mouse button. Two things will happen, (1) a yellow sticky note will be added on the page where specified for placement and (2) a Sticky Note text box will appear for addition of the required text or comment associated to the note. (See, for example, FIG. 48.) Referring now to FIG. 49, the text to be associated with the sticky note may now be typed in the Sticky Note text box. The “Apply” button may be clicked when the user is finished adding the text. The save button my be clicked on the lower toolbar on the Image Viewer. The system will display a message box indicating it has saved the sticky note to the system's database. The user may click the “OK” button in response. If the user does not save before exiting, the system will discard the sticky note.

To add another sticky note, select the back link that is located above the upper toolbar on the Image Viewer. This will return you back to the “View Donor” page. The donor chart may be searched and accessed for the applicable donor document to verify the annotation has been added as illustrated in FIG. 50. The left-hand navigation bar on the Image Viewer contains contain the note(s) recently added, along with any other notes that may have been added previously. The View with Annotations feature is useful when a document contains multiple pages. Instead of having to view all the pages in a document to see if a note has been added, a user can quickly see from the list how many notes are associated with the document. Simply click on each text link for the system to go directly to the page and corresponding note for review.

To access and open an existing sticky note, click on the text hyperlink associated with any of the sticky notes displayed in the list to be directed to the exact page and place in the document where the note had been added. Double-click the left mouse button to open the note and read its full content. Once the user is finished viewing the comment, the Sticky Note text box may be closed by clicking the “x”. To modify an existing sticky note, text may be added or changed once the sticky note is opened. After making any modifications, the “Apply” button is clicked to close the Sticky Note text box. Next, the disc or save icon may be clicked to ensure the system saves the modifications and adds them to the database. Once the save is complete, the user can position the mouse on the sticky note and double-click the left mouse button to see the modification just made.

When a new version of the document is added to the system (i.e., uploaded), the annotations will stay with the same page number as on the previous version of the document. If the previous version of the document was 6 pages long with a sticky note on the 6^{th} page and the new version of the document is 5 pages long the sticky note from the 6^{th} page is discarded. A review of all sticky notes is required if the document is versioned.

Workflow

A Workflow is a technology that is utilized to automate certain business processes to trigger events, which in turn will add task items to the work queues of pre-defined user groups. Task items will alert members of the user group that an action needs to be performed such as Complete the Donor Medical Chart Review Form. As the User completes the action the User will use the Task to “sign” completion and status of the activity.

There are two main workflows, which are “Joint Restoration” and “Traditional”. Based on these workflows, task items will also be generated at subsequent stages in the electronic donor chart process for the user groups of Quality Assurance Lab and Medical Directors.

A new workflow instance starts when a donor chart is added in the system. The workflow is created for the specific user group based on the Processing Type that was assigned as the donor chart was added. This will vary based on the Recovery Agency.

A donor chart is added to the system with the Processing Type being Joint Restoration. The donor chart status is set to “Reviewing Chart for Joint Restoration Records.”

The Joint Restoration Workflow adds the task item, Complete Donor Chart Medical Review Form, to the My Tasks page for everyone in the Joint Restoration Active Directory group. This task will instruct the users that this form must be completed.

After completing the form as necessary (via the “Edit Donor” page), the user will go back to the “My Tasks” page and select the task item link to access the “Apply Signature” page, and apply an electronic signature.

On an electronic signature page, and in an embodiment, the signatures screen must display an icon representative of the signature option as well as a short description for easier option identification. In addition, the system allows signature options to be turned on or off at anytime without republishing the workflows giving flexibility to remove options after deployment.

The task will be removed from the “My Tasks” page since it has now been completed.

The Joint Restoration Workflow adds the item, Review Donor Chart Medical Review Form, to the tasks list (My Tasks) of Traditional Medical Records users after an electronic signature is added specifying the Donor Chart Medical Review Form has been completed. Traditional Medical Records serves as the Quality check for Joint Restoration Donor Charts. After reviewing the Donor Chart, Traditional Medical Records will go to the “My Tasks” page and select the task item link to access the “Apply Signature” page, an apply an electronic signature. The task will be removed from the “My Tasks” page since it has now been completed. The Joint Restoration Workflow will add the item, Complete Graft and Culture Summary Form, to the tasks list (My Tasks) of Joint Restoration users after an electronic signature is added specifying the Donor Chart Medical Review Form has been reviewed and approved by Traditional Medical Records. After completing the form in (via the “Edit/View Donor” page), the user will go back to the My Tasks page and select the task item link to access the “Apply Signature” page, an apply an electronic signature. The task will be removed from the “My Tasks” page since it has now been completed. The Joint Restoration Workflow will add the task item, Review Graft and Culture Summary Form, to the “My Tasks” page for Traditional Medical Records users after an electronic signature is added specifying the Graft and Culture Summary Form has been reviewed. The user will go to the “My Tasks” page and select the item link to access the “Apply Signature” page, review the form, and apply an electronic signature. The task will be removed from the “My Tasks” page since it has now been reviewed. The donor chart status will be set to “Waiting for Medical Director Joint Restoration Records Review.”

The Joint Restoration Workflow adds the task item, Review Graft and Culture Summary Form, to the “My Tasks” page for Medical Director users after an electronic signature is added specifying the Graft and Culture Summary Form has been reviewed by QAL. The user goes to the “My Tasks” page and select the item link to access the “Apply Signature” page, review the form, and apply an electronic signature. The task will be removed from the “My Tasks” page since it has now been reviewed. The Joint Restoration Workflow adds the task item, Review Donor Chart Medical Review Form, to the “My Tasks” page for Medical Director users after an electronic signature is added specifying Graft and Culture Summary Form has been reviewed by the Medical Director. The user goes to the “My Tasks” page and selects the item link to access the “Apply Signature” page, review the form, and apply an electronic signature. The task will be removed from the “My Tasks” page since it has now been reviewed.

At this point the donor chart status is changed the donor chart status to “Joint Restoration Records Review Accepted the Donor” or “Joint Restoration Records Review Deferred the Donor”, depending on the final approval. If the donor is accepted then a Task to Complete the Lot Characteristics Form is inserted in the Joint Restoration Workflow. The Joint Restoration Specialist prepares the form and prepares iRen with a PO and GRN for the donor and signs the Task. The information in the form is passed to iRen. The workflow for this donor chart will transition to the Traditional workflow after executing this last step.

If a discrepancy is noted in a Donor Chart Medical Review Form signature (based on the signature option selected), then the process will loop back and re-add a “Complete Donor Chart Medical Review Form” task to the tasks list of Joint Restoration users.

If a discrepancy is noted in a Graft and Culture Summary Form signature (based on the signature option selected) by either Traditional Medical Records users or Medical Directors, then the process will loop back and re-add a “Complete Graft and Culture Summary Form” task to the tasks list of Joint Restoration users.

Traditional Workflow

The following is a high-level overview of the workflow and the sequential order of events for a single donor chart being processed in the system. A donor chart is added to the system with a Processing Type being Traditional. The donor chart status is set to “Reviewing Chart for Traditional Records.”

The Traditional Workflow will add the task item, Complete Donor Chart Medical Review Form, to the “My Tasks” page for all users in the Traditional security group. This task will instruct the users that this form must be completed.

After completing the form (via the “Edit/View Donor” page), the user will go back to the “My Tasks” page and select the task item link to access the “Apply Signature” page, an apply an electronic signature. The task will be removed from the “My Tasks” page since it has now been completed.

The Traditional Workflow will add the task item, Review Donor Chart Medical Review Form, to the “My Tasks” page for Traditional Medical Records users after an electronic signature is added specifying the Donor Chart Medical Review Form has been completed. This step is the Manager of Traditional Medical Records performing a Quality review of the Donor Chart and Medical Review Form. The user goes to the “My Tasks” page and selects the item link to access the “Apply Signature” page, and apply an electronic signature. The task will be removed from the “My Tasks” page since it has now been reviewed.

For a Quality Assurance Lab, the Traditional Workflow will add the task item, Complete Donor Tissue Disposition Review Form, to the “My Tasks” page for Quality Assurance users after an electronic signature is added specifying the Donor Chart Medical Review Form has been reviewed. After completing the form (via the “Edit/View Donor” page), the user will go back to the “My Tasks” page and select the task item link to access the “Apply Signature” page, and apply an electronic signature. The task will be removed from the “My Tasks” page since it has now been completed. The donor chart status will be set to “Waiting for Medical Director Traditional Records Review.”

For medical director review, the Traditional Workflow will add the task item, Review Donor Tissue Disposition Review Form, to the “My Tasks” page for Medical Director users after an electronic signature is added specifying the Donor Tissue Disposition Review Form has been completed by QAL. The Medical Director goes to the “My Tasks” page and select the item link to access the “Apply Signature” page, review the form, and apply an electronic signature. The task will be removed from the “My Tasks” page since it has now been reviewed. The Traditional Workflow will add the task item, Review Donor Chart Medical Review Form, to the “My Tasks” page for Medical Director users after an electronic signature is added specifying the Donor Tissue Disposition Review Form has been reviewed by the Medical Director. The user will go to the “My Tasks” page and select the item link to access the “Apply Signature” page, review the form, and apply an electronic signature. The task will be removed from the “My Tasks” page since it has now been reviewed. The donor chart will be locked from editing by Recovery Agency users.

At this point the donor chart status is changed to “Traditional Records Review Accepted the Donor” or “Traditional Records Review Deferred the Donor”, depending on the final approval. If the donor is accepted then a Task to Complete the Lot Characteristics Form is inserted in the Medical Records Workflow. The Medical Records Specialist prepares the form and prepares iRen with a PO and GRN for the donor and signs the Task. The information in the form is passed to iRen. The workflow for this donor chart will end after executing this last step.

If a discrepancy is noted in a Donor Chart Medical Review Form signature (based on the signature option selected), then the process will loop back and re-add a “Complete Donor Chart Medical Review Form” task to the tasks list of Traditional users.

If a discrepancy is noted in a Donor Tissue Disposition Review Form signature (based on the signature option selected), then the process will loop back and re-add a “Complete Donor Tissue Disposition Review Form” task to the tasks list of Quality Assurance users.

Fresh Skin Workflow

A donor chart is added to the system with a Processing Type being “Skin.” The donor chart status is set to “Reviewing Chart for Joint Restoration.” The Joint Restoration and Fresh Skin processing will occur in the same time period so the donor chart status might reflect the last action of either workflow depending on the exact sequence of activities.

For Medical Records being Traditional, the Skin Workflow will add the task item, Skin—Complete Donor Chart Medical Review Form, to the “My Tasks” page for all users in the Traditional security group. This task will instruct the users that this form must be completed. After completing the form (via the “Edit/View Donor” page), the user will go back to the “My Tasks” page and select the task item link to access the “Apply Signature” page, and apply an electronic signature. The task will be removed from the “My Tasks” page since it has now been completed.

The Traditional Workflow will add the task item, Skin—Review Donor Chart Medical Review Form, to the “My Tasks” page for Traditional Medical Records users after an electronic signature is added specifying the Donor Chart Medical Review Form has been completed. This step is another member of Traditional Medical Records performing a Quality review of the Donor Chart and Medical Review Form.

The user will go to the “My Tasks” page and select the item link to access the “Apply Signature” page, and apply an electronic signature. The task will be removed from the “My Tasks” page since it has now been reviewed.

For Medical Records as Traditional, the Skin Workflow will add the task item, Complete Skin Exceptional Release Form, to the “My Tasks” page for Traditional Medical Records users after an electronic signature is added specifying the Donor Chart Medical Review Form has been reviewed. After completing the form (via the “Edit/View Donor” page), the user will go back to the “My Tasks” page and select the task item link to access the “Apply Signature” page, and apply an electronic signature. The task will be removed from the “My Tasks” page since it has now been completed. The donor chart status will be set to “Waiting for Medical Director Traditional Records Review.” The Skin Workflow will add the task item, Review Skin Exceptional Release Form, to the “My Tasks” page for Traditional Medical Records users after an electronic signature is added specifying the Donor Chart Medical Review Form has been reviewed. This step is another member of Traditional Medical Records performing a Quality review of the Donor Chart and Fresh Skin Release Form. The user goes to the “My Tasks” page and select the item link to access the “Apply Signature” page, and apply an electronic signature. The task will be removed from the “My Tasks” page since it has now been reviewed.

For the Skin Medical Director, the Skin Workflow adds the task item, Review Donor Chart Medical Review Form, to the “My Tasks” page for Medical Director users after an electronic signature is added specifying the Skin Exceptional Release Form has been reviewed by Medical Records. The Medical Director will go to the “My Tasks” page and select the item link to access the “Apply Signature” page, review the form, and apply an electronic signature. The task will be removed from the “My Tasks” page since it has now been reviewed.

The Skin Workflow will add the task item, Review Skin Exceptional Release Form, to the “My Tasks” page for Medical Director users after an electronic signature is added specifying the Donor Chart Medical Review Form has been reviewed by the Medical Director. The user will go to the “My Tasks” page and select the item link to access the “Apply Signature” page, review the form, and apply an electronic signature. The task will be removed from the “My Tasks” page since it has now been reviewed. The donor chart will be locked from editing by Recovery Agency users.

At this point the donor chart status is changed to “Skin Records Review Accepted the Donor” or “Skin Records Review Deferred the Donor”, depending on the final approval. If the donor is accepted then a Task to Complete the Lot Characteristics Form is inserted in the Medical Records Workflow. The Medical Records Specialist prepares the form and prepares iRen with a PO and GRN for the donor and signs the Task. The information in the form is passed to iRen. The workflow for this donor chart will end after executing this last step.

If a discrepancy is noted in a Donor Chart Medical Review Form signature (based on the signature option selected), then the process will loop back and re-add a “Skin—Complete Donor Chart Medical Review Form” task to the tasks list of Traditional Medical Records. If a discrepancy is noted in a Skin Exceptional Release Form signature (based on the signature option selected), then the process will loop back and re-add a “Complete Skin Exceptional Release Form” task to the tasks list of Traditional Medical Records.

My Tasks

As the previous section explained, when a donor chart is added to the system, the workflow automation tool automatically generates task items and place these items in the work queues of the user groups responsible for completing the electronic chart. The system knows which group to assign the task to based on the Processing Type that was assigned on the “Add Donor” page. This work queue (or tasks list) is referred to as “My Tasks”.

There is a link in the Medical Records Site to a “My Tasks” page that will display collective task items for specified groups of users. All the system users who fall under a defined group will have access to the tasks that are generated to that group. There will be designated groups for Medical Records: Traditional, Joint Restoration, Medical Directors and Quality Assurance Lab. When system users are initially set up with system access, they will be assigned to one of these pre-defined groups.

The task items found on the “My Tasks” page will instruct users that certain actions need to be taken in regards to the electronic donor charts. For example, when a form has been created and is ready to be completed a corresponding task item will be updated and displayed on the “My Tasks” page. Likewise, once a form has been completed in the system, another item may appear in the tasks list for another user group indicating that the form needs to be reviewed.

Generally, it is important to realize that these tasks are driven by the Workflow, indicate an action that needs to be performed, and are “completed” once an electronic signature has been applied.

Accessing My Tasks

The “My Tasks” page can be accessed and viewed anytime to see what actions need to be taken. From the Home page, selection of the “My Tasks” link is made from the Donor Management section in the left-hand navigation bar. The user is directed to the “My Tasks” page as shown in FIG. 51. All the task items are shown that have been updated to this queue based on the automated workflow, and for which the associated user group will need to perform some action. The tasks are filtered based on user preferences then oldest to newest within each grouping. Once a task has been “completed” (as indicated by an electronic signature), it will be removed automatically from the queue.

Setting the User Customizable Task List Criteria

The task list display enables each user to define the task presentation for the tasks that are assigned to them. Each user, with the Set Preferences feature, may customize the display based on their needs. First, select the “My Tasks” link from the left menu. Second, click the “Show Red External Status” checkbox at the top of the task list to include tasks with a Red External status. Uncheck this box to exclude the tasks that have an Red External Status. This checkbox may be toggled at any time. Third, click on the “Use Preferences? Yes No” radio button to toggle between the default preferences setting (show all tasks with all groupings) and your customized settings. Fourth, click on the “Set Preferences” button at the top of the task list. The two screenshots of FIGS. 52 and 53 depict the default settings the first time you navigate to this screen. Fifth, group by Recovery Agency Checkbox is left checked if tasks should be organized by Recovery Agency. The box t should be unchecked if this grouping is not wanted. Sixth, group by Activity should be left checked if tasks should be organized by Activity (i.e. Complete Donor Chart Medical Review Form, Review Donor Chart Medical Review Form, etc.). The box should be unchecked if this grouping is not wanted. Seventh, for the Order Boxes a number (1 is first, 2 is second and so on) is entered for the order of display of the groupings or for changing the Order Box to blank (spaces) if activities that belong under this grouping should not be shown. Eighth, for the Expand check boxes these should be unchecked with a number in the corresponding Order Box will display the grouping “rolled up”. If desired, the grouping in the task list may be selectively expanded as a user is working with the task list. Checking the Expand box will individually list all tasks that are assigned to you for the corresponding grouping. Ninth, the Save Button is clicked to save preferences. In addition, click the “Reset to Default” button to set all of the preferences back to the original default state. Also, click on the “Cancel” button to discard changes made to the preferences since the last Save button click.

Donor Chart Statuses on the Task List Display

The task list has two new columns representing an External donor chart status and an Internal donor chart status. External chart status is focused on the donor chart as it relates to the responsible Recovery Agency. The Internal chart status is focused on issues that are internal to the Medical Record site (e.g., AlloSource) or unrelated to a Recovery Agency. “External Task Status” is the first column in the task list. It has a column header labeled “Ext”. This column has the following status meanings:

0/Green=The donor chart is ready for review or is being reviewed.

R/FS/Trad—No Communication Log entries or only ‘Closed’ log entries exist for the current Recovery Agency Donor Id.

Trad Only—Above AND—The “Ready for Traditional Records Review” checkbox is checked for the Donor Chart.

1/Yellow=The Recovery Agency has provided the missing/incomplete information.

JR/FS/Trad—One or more Communication Log entries exist for this Recovery Agency Donor Id with a status of ‘Resolved’.

Trad Only—Above AND—The “Ready for Traditional Records Review” checkbox is checked for the Donor Chart.

2/Red=The donor chart is waiting for information from the Recovery Agency.

JR/FS/Trad—One or more Communication Log entries exist for this Recovery Agency Donor Id in the ‘Active’ status.

Trad only—Above OR—The “Ready for Traditional Records Review” checkbox is NOT checked for the Donor Chart.

“Internal Task Status” is the second column in the task list. It has a column header labeled “Int”. This column has the following status meanings:

0/Green=The donor chart is ready for review or is being reviewed.

JR/FS/Trad—No Internal Communication Log entries or only ‘Closed’ log entries exist for the current Recovery Agency Donor Id.

2/Red=The donor chart review is on hold for some reason.

JR/FS/Trad—One or more Internal Communication Log entries exist for this Recovery Agency Donor Id in the ‘Active’ status.

1/Yellow=The missing/incomplete information has been obtained but not closed yet.

JR/FS/Trad—One or more Internal Communication Log entries exist for this Recovery Agency Donor Id with a status of ‘Resolved’.

Forms Management

Medical Records site staff (e.g., AlloSource staff) are responsible for the forms associated with the electronic donor charts. Forms include, but are not limited to, Donor Chart Medical Review Form, Tissue Disposition Review Form, Graft and Culture Summary Form, and Skin Exceptional Release Form.

These forms are automated in the donor medical records management system and can be accessed in an online format. Certain fields on the forms will be pre-populated based on data that is gathered and extracted from the donor charts when added to the system. Once the forms are accessed, the forms can be filled out electronically and saved like any other document. Since these forms are online, the forms can be accessed and viewed by all users who are authorized to do so. Comments can also be added to these forms to communicate between work groups such as Medical Records and Medical Director.

Forms (and internal AlloSource documents) will only be resident in the Medical Records Site therefore this will be the only place where they can be accessed. Recovery Agencies will not have the rights to access or view AlloSource forms.

Forms are created and added automatically to the Medical Records Site by the Workflow when a donor chart is added to the system. The Processing Type that is assigned on the “Add Donor” page will dictate which forms are to be created and to which user group the forms should be assigned.

Electronic donor charts for Traditional Medical Records will be associated with the Donor Chart Medical Review Form and Tissue Disposition Review Form.

Electronic donor charts associated with Joint Restoration Donors will be associated with the JR Donor Chart Medical Review Form and the Graft and Culture Summary Form. As the Donor is converted to a Traditional Donor the Traditional forms are included.

The Workflow obtains a copy of the form template from the most recent version of the form. The new form may be saved in the Donor Documents library on the Medical Records Site.

Users will know when a form has been created and is ready to be completed or reviewed based on a task item being added to their work queue (My Tasks).

Accessing a Form

Since the responsibility for completing the requisite forms fall under personnel in Medical Records and Quality Assurance Lab, they will need to sign on to the Medical Records Site in order to access a form. From the Home page, select the “View Donor” link from the “Donor Management” section in the left-hand navigation bar. The user is directed to the “View Donor” page as shown in FIG. 54. As discussed herein, there are several ways to search for a donor chart that already exists in the system. After the system has displayed the donor chart specified in a search, the user is able to view the associated information that exists in the system. Referring to the Donor Documents section of FIG. 55, this is where the system-generated forms are displayed for the specified donor chart. The mouse may be positioned over the name of the form to access, and the left mouse button clicked to open the form. In an embodiment, the form will be opened in Microsoft Office InfoPath, which enables users to view (and edit) forms.

Form Input & Update

Forms are created and added automatically to the Medical Records Site by the Workflow whenever a donor chart is added to the system. The workflow will also add a task item to the work queue of the applicable user group. When a user associated to that user group accesses the “My Task” page, the user is shown a task item indicating a need to complete a form. The user may access the form via the Edit/View Donor option to complete the form. Fields bordered in red indicate a “Required” field for input. The workflow will still proceed through the system regardless of the “Required” field contents. There are no system time constraints in completing a form. Users can gather the information required to complete a form as it becomes available to them and thus access/update the form as many times as needed until it is fully completed. Save the form after making any changes and before exiting the form.

Joint Restoration

This user group is responsible for completing the Donor Chart Medical Review Form (JR) and Graft and Culture Summary Form.

Traditional

This user group is responsible for completing the Donor Chart Medical Review Form (Traditional) and the Fresh Skin Release Form.

Quality Assurance Lab

This user group is responsible for completing the Serology and Microbiology sections on the Donor Tissue Disposition Review Form.

Medical Director

Responsible for filling out the Medical Director section of the Donor Skin/Tissue Disposition Review Form.

To update a form, the steps noted in “Accessing a Form” are followed to get to the point of having accessed and opened the form in InfoPath. Subsequently, the steps for Form Input & Update may be utilized. FIGS. 56-61 contain exemplary versions of these forms.

Joint Restoration Graft and Culture Summary Form

This form (see FIG. 56) is completed by Joint Restoration personnel. The Joint Restoration Workflow obtains a copy of the template file from the most recent version of the Joint Restoration Graft and Culture Release Form. It will also pre-populate the Recovery Agency Donor Id.

Donor Chart Medical Review Form

The Traditional Workflow will get a copy of the template file from the most recent version of the Donor Chart Medical Review Form. It will also pre-populate the Recovery Agency Donor ID, the Gender (if available) and the Age (if available) from the information entered on the Add Donor page. FIGS. 57-59 are screenshots that make up this form.

Tissue Disposition Review Form

The Workflow will get a copy of the template file from the most recent version of the Donor Tissue Disposition Review Form (see FIG. 60). It will also pre-populate the Recovery Agency Donor ID from the information entered on the Add Donor page. The Quality Assurance Labs personnel complete the Serology and Microbiology sections of the form. The Medical Director completes the last section of the form.

Fresh Skin Review Form

The Workflow will get a copy of the template file from the most recent version of the Fresh Skin Review Form (see FIG. 61). It will also pre-populate the Recovery Agency Donor ID from the information entered on the Add Donor page. The Medical Records personnel fills in the AlloSource Donor Id. The Medical Director completes the last section of the form.

Donor Lot Characteristics Form

The Workflow will get a copy of the template file from the most recent version of the Donor Lot Characteristics Form (see FIG. 62). It will also pre-populate the Recovery Agency Donor ID from the information entered on the Donor Chart Medical Review Form. The Medical Records personnel enters the key data (Warehouse, Part_Code and AlloSource Donor Id). The information flows to iRen Lot Characteristics when the task is signed.

When the user clicks the “Save” menu option or disk icon on any of the forms, a new version will be saved to the Donor Documents library, preserving the old version in version history.

All forms can be printed if needed. Once they have been accessed via the “View Donor” or “Edit Donor” option and opened in InfoPath, the form can be printed by clicking the “Print” button.

Donor Chart Approval

One important aspect of the Donor Medical Records Management System is the automation of the donor chart approval process. The improvements listed below will provide a more streamlined and expedited process. Task lists have been provided to guide users on what work needs to be done Electronic forms have been created to replace paper ones. Electronic signature functionality has been added.

Up to this point in the process, the following tasks will have generally occurred for a donor chart being processed in the system (and are topics that have all been covered previous to this one): A donor chart was added to the system. The Workflow was triggered to create the associated forms and assign the appropriate task items to the correct user groups. Users edited and viewed the donor chart, as needed. Users added communication log entries for any issues/discrepancies found on the donor chart that required resolution. Users added annotations to the scanned documents associated with the donor chart to aid the Medical Director in their review process. Users accessed and completed the forms they were responsible for filling out.

The final stage in the electronic donor chart process is Donor Chart Approval, which in general terms will include the following. Forms have been completed by Medical Records site (e.g., AlloSource) users and an initial review has been made as to whether the corresponding donor is acceptable/unacceptable for further review and processing. Completed forms are reviewed by additional Medical Records site (e.g., AlloSource) users for a second set of eyes to ensure the corresponding donor is acceptable for further review. The forms/donor information is also evaluated to see if they contain discrepancies that need to be clarified before continuing further in the process. Medical Directors perform a final review of the donor charts. They may still find discrepancies at this point that need to be clarified before continuing further but if no discrepancies are found they will determine whether a donor is accepted or deferred.

Indicating whether a form is complete, a donor is acceptable/unacceptable, discrepancies exist or the final acceptance/deferral of a donor is all specified on the “Apply Signature” page when an electronic signature is applied to finalize that step in the approval process.

Electronically Signing a Donor Chart

Each user group responsible for completing or reviewing a form needs access to the “My Tasks” page to link to the appropriate signature page to apply an electronic signature and approval meaning for their assigned task. This will close out the task item on the “My Tasks” page. More importantly, this electronic signature will signal to the Workflow that a task has been completed and allow it to generate and assign the next round of tasks. The electronic signature is what allows the system to proceed to the next step in the donor chart process. From the Home page, select the “My Tasks” link from the Donor Management section in the left-hand navigation bar. The user is directed to the “My Tasks” page as shown in FIG. 63. Next, the user's mouse is positioned over a task item and clicked with the left mouse button. The system directs the user to the appropriate “Apply Signature” page, as shown in FIG. 64.

An applicable approval response is selected as noted by the options displayed on FIG. 64. The user's password is entered in the Password field. The username/password entered for the signature must match that of the uers logged into the system, i.e. a user cannot sign for someone else. To finalize the approval, the Sign Current Document button is clicked.

The system authenticates the user before recording the signature. If authentication fails, an event will be written to an Event log where monitoring software can pick it up and alert the System Administrator. The signature will not be recorded, and the user will see an error message explaining that their signature was not accepted.

At the top of the page the Recovery Agency Donor Number is displayed along with a hyperlink to the associated form that has been completed or is being reviewed (depending on the task). This link is clicked to open and view the form, if needed. There is also a version number that is displayed to identify the version of the document being electronically signed.

The Task List is refreshed and displayed with the confirmation message shown at the top of the task list. The User can select the next task to process as illustrated in FIG. 65.

Locking Donor Charts

A donor chart is locked from Recovery Agency users once the Medical Director has electronically signed both the Donor Chart Medical Review and Donor Tissue Disposition forms. “Locked” means that no new documents or new versions of documents can be uploaded, and the donor chart cannot be edited.

The donor database will have a field that defines the state of a donor, which includes in process, accepted, or deferred. The “Edit Donor” page will allow donor charts to be modified if the chart is “in process”, but will prohibit donor charts from being modified if the chart's status is “Donor Accepted” or “Donor Deferred.”

Internal Medical Record site (e.g., AlloSource) users will still be able to upload documents because the “Edit Donor” page only applies the lock functionality to Recovery Agency users.

View Signatures

One business requirement is that a user must be able to view all signatures that have been applied to a form. A “View Signatures” page provides a link to print the applicable signatures. From the Home page, the “View Donor” link is selected from the “Donor Management” section in the left-hand navigation bar. The user is directed to the “View Donor” page as shown in FIG. 66. As discussed herein, there are several ways to search for a donor chart that already exists in the system. After the system has found and displayed the donor chart specified in the search, the user may view the associated information that exists in the system. Referring to the Donor Documents section of FIG. 67, position the mouse over the name of the desired form or document to access. This displays a drop-down arrow as shown in FIG. 67.

Referring to FIG. 68, click on the menu option to select the “View Signature” link. The “View Signatures” page is displayed for the specified form as illustrated in FIG. 69. Note the Print link in the upper right portion of the page. Clicking on this link presents the page in a format suitable for printing and your standard Print dialogue box will open allowing printing of the signature summary.

### Other Menu Features

The menu items from Documents to Reports are standard features of SharePoint. These menu items will be displayed on the various pages within the application in the left-hand navigation bar.

Documents

Documentation can be stored in a system library and displayed under this section for users to access when needed. The Medical Records Site has an AlloSource Documents folder containing the User Manual and the Donor Eligibility Criteria table. The documents applicable to these folders can be uploaded where the documents can be accessed and referenced by all authorized users.

Lists

This section will consolidate and display all the standard and custom SharePoint lists that are determined necessary.

Communication Log

A Communication Log feature (see FIG. 70) acts as a custom issues list. Users' comments are stored in a history trail along with the issue. Users can use the alert functionality of SharePoint to be notified of new and updated issues regarding a donor chart in process. Selecting the Communication Log link will direct the user to the Communication Log. Reflected are all communication entries that have been made in the system for all donor charts per the specific Recovery Agency Site. It is not based on a specific donor charts as found when accessing the Communication Log via the View Donor option.

Announcements

A feature of SharePoint is the ability to add announcements that will be displayed on the Home page of the Medical Records Site and seen by users once they have signed on to the application. The Announcements Link is selected to open the Announcements page illustrated in FIG. 71. The New Item button is selected to add a new message as shown in FIG. 72. This is where a message or announcement can be added. After entering a Title (which is a required field) and any associated text in the Body, click the “Save and Close” button on the upper toolbar. Once the user has returned back to the Home page, the announcement will be displayed under the Announcements section, as shown in FIG. 73.

Recovery Agencies

This list will allow Medical Records users a facilitated means to access any of the Recovery Agency Sites. Selecting the “Recovery Agencies” link off of the left-hand navigation bar on the Medical Records Site opens another window that displays a list of all the Recovery Agencies, as shown in FIG. 74. Select the Recovery Agency needed to access and the user is directed to the Home page for that specific Recovery Agency Site. The user may also select the appropriate Recovery Agency Site from the Home page, which is located under the “Recover Agencies” section (under the logo).

Calendar

A standard SharePoint calendar stores events and meetings between the Medical Records site (i.e., AlloSource) and the Recovery Agencies. It is not a personal calendar by user, but a shared calendar amongst all users of the system.

Links

A standard SharePoint links list manages useful web links pertaining to a Recovery Agency. The Home page may be personalized by adding important links or links to websites that a Recovery Agency may frequent in order to perform their job.

Contacts

A standard SharePoint contacts list maintains phone numbers, email addresses, etc., for key contacts at the Recovery Agency, AlloSource and other companies. This contacts list is shared by all users of the system, regardless of location/site.

Reports

Users may access the links under the Reports menu to request and view reports online. A screen is displayed that allows the entry of selection criteria after the report is selected. The desired criteria is entered and report button is clicked to display results. FIG. 75A illustrates an example of “Reports” for a Medical Records site and FIG. 75B illustrates an example of “Reports” for a recovery agency.

Chart Information Report—All Charts

The Chart Information link may be invoked to view a listing of all donor charts and/or input further selection criteria to select the desired donor charts. If a user enters selection criteria, then click on the “view report” button to view the results.

Recently Submitted Charts

The Recently Submitted Chart link may be invoked to view Donor Charts using a structured date interval. First, click on the Recently Submitted Chart link, and then select the desired timeframe from the # of Days to Display pull-down menu, then on the “View Report” button as illustrated in FIG. 76.

Additional Report Features

To export the display results to Excel, the desired format is selected from the Select a Format pull-down list and the export link is invoked next to the pull-down box as illustrated in FIG. 77. The results are made available in the format selected. In this case, the Excel formatted listing is shown in FIG. 78.

Important System Features

The following system features are important to the Donor Medical Records Management System in ensuring FDA compliance is met as well as providing efficiency for users as they process electronic donor charts.

Audit Trail

The Audit Trail feature records every addition and update/change made in the system along with a date and time stamp, the event type, and the user making the change. This provides an audit trail for each transaction occurring in the system, which is an important FDA requirement. This audit tracking occurs transparent to the user. The delete function is granted to any users in the system since documents must remain available throughout their retention period.

Viewing the Audit Trail of a Specified Document/Form

The Donor Documents section on the “View Donor” page (in the Medical Records Site) reflects the internal documents that have been uploaded and the system generated forms for a specified donor chart. Any single document or form can be viewed to see the corresponding Audit Trail.

From the Home page, select the “View Donor” link from the Donor Management section in the left-hand navigation bar. The user is directed to the “View Donor” page as shown in FIG. 79. As discussed herein, there are several ways to search for a donor chart that already exists in the system. After the system has found and displayed the donor chart specified in the user's search, the associated information that exists in the system may be viewed as shown in the the Donor Documents section of FIG. 80. The user may position a mouse over the name of the desired form or document. This will display a drop-down arrow as shown in the FIG. 80.

Referring now to FIG. 81, the user may click on the menu option to select the “Audit Trail” link. FIG. 82 illustrates the Donor Documents page displayed for the specified document. Each Audit Trail entry will include the user who initiated the event, the event type, and a date/time stamp. There will always be two event types listed per document, which include the actual document and the corresponding metadata.

Version History

All documents are versioned to meet FDA regulations and to track changes in the system. Whenever a document is updated, the old version must be saved in the system and remain accessible for viewing. All documents in the system are stored in SharePoint document libraries with a versioning feature turned on. Therefore, SharePoint will transparently maintain old versions when new versions of documents are uploaded.

Viewing the Version History of a Specified Document/Form

Users may access older versions of documents and forms that reside in the system when needed. From the Home page, select the “View Donor” link from the Donor Management section in the left-hand navigation bar. The user is directed to the “View Donor” page as shown in FIG. 83. As discussed herein, there are several ways to search for a donor chart that already exists in the system. After the system has found and displayed the donor chart specified in the search, the associated information that exists in the system may be viewed such as shown in the Donor Documents section of FIG. 84. For example, position the mouse over the name of the form or document desired to access. This will display a drop-down arrow as shown in FIG. 84. Simply click on the down arrow to open a task list as shown in FIG. 85. A selection of the “Version History” link may be made in order to cause the display of the window shown in FIG. 86, which relates to version history for a form. Two entries are shown for every form listed in Version History, which include the the stored form and the updated list (metadata).

Referring to FIG. 87, either entry may be accessed by positioning the mouse over the date/time (which is a hyperlink) until the drop-down box appears. Click on the down arrow to display a list of options, as shown in FIG. 87. Select “View” from the drop down menu and the form or metadata will be opened for view.

FIG. 88 illustrates a version history for a document. All documents are stored in a Document Library. Two entries are shown for every document listed in Version History, which include the stored document and the updated list (metadata). As illustrated in FIG. 89, either entry may be accessed by positioning the mouse over the date/time (which is a hyperlink) until you see the drop-down box appear. Referring to FIG. 90, a user may click on the down arrow to display a list of options. Select “View” and the document or metadata will be opened for a user to view as shown in FIG. 91.

Alert Me

SharePoint has a feature that allows users to specify whether they want to be alerted to certain changes that occur in the system. Users are alerted in the form of an email.

For the Donor Medical Records Management System, it is required that each user sets themselves up with this feature so they are alerted to communication log issues that are assigned to them for resolution. The user can specify frequency of alerts. Generally, it is recommended to set them up to appear immediately.

Setting Up the Alert Me Feature

Each system user needs to set up this Alert Me feature to ensure they are notified when new communication log issues are assigned to them. From the Home page, select the “Site Settings” link from the main toolbar at the top of the page as illustrated in FIG. 92. The user is directed to the “Site Settings” page as shown in FIG. 93. Referring to the Manage My Information section, a user may select the “My alerts on this site” link to be directed to the page shown on FIG. 94. The user may click the “Add Alert” button to open the New Alert page as illustrated in FIG. 95. The user may next select the communications log and after the selection has been made, the “Next” button at the bottom of page will be activated. Clicking on the “Next” button to continue, the user will be provided with questions on a page shown as FIG. 96. The user enters the requested information you in each section on this page. This may included the user's email address, specified the types of communication log changes to be alerted about, specified frequency for receiving this alert. The user may click the “OK” button when finished. The system displays a page (FIG. 97) that lists the alert just added for the user. Any previous alerts that were added will also be reflected in this list.

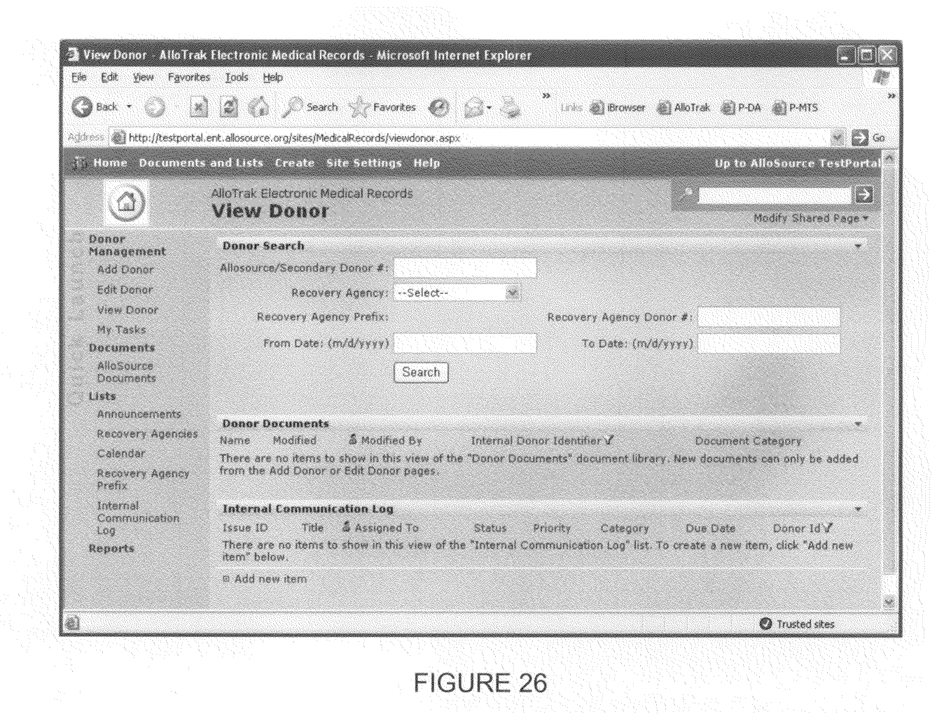

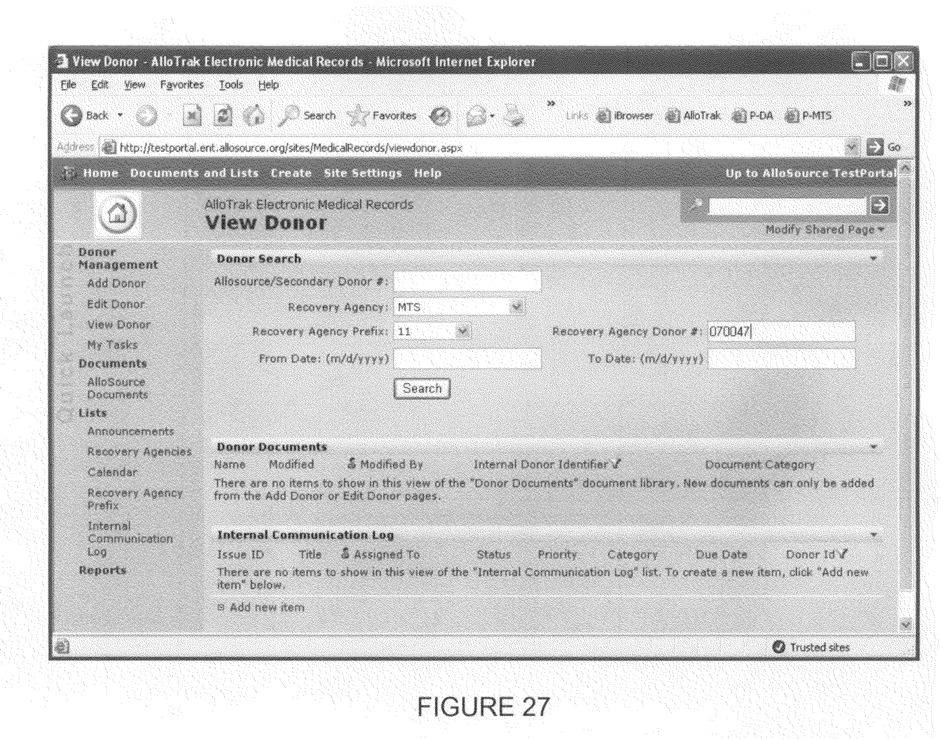

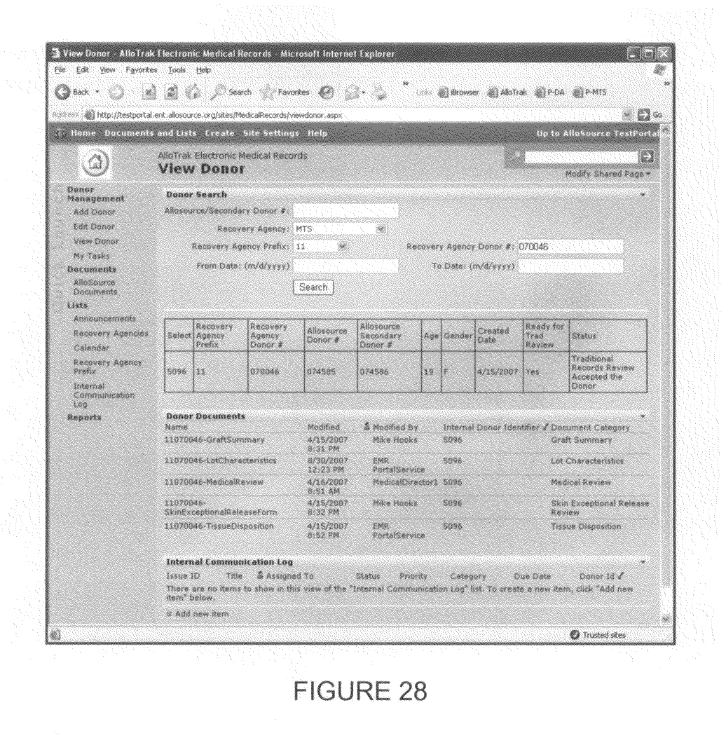

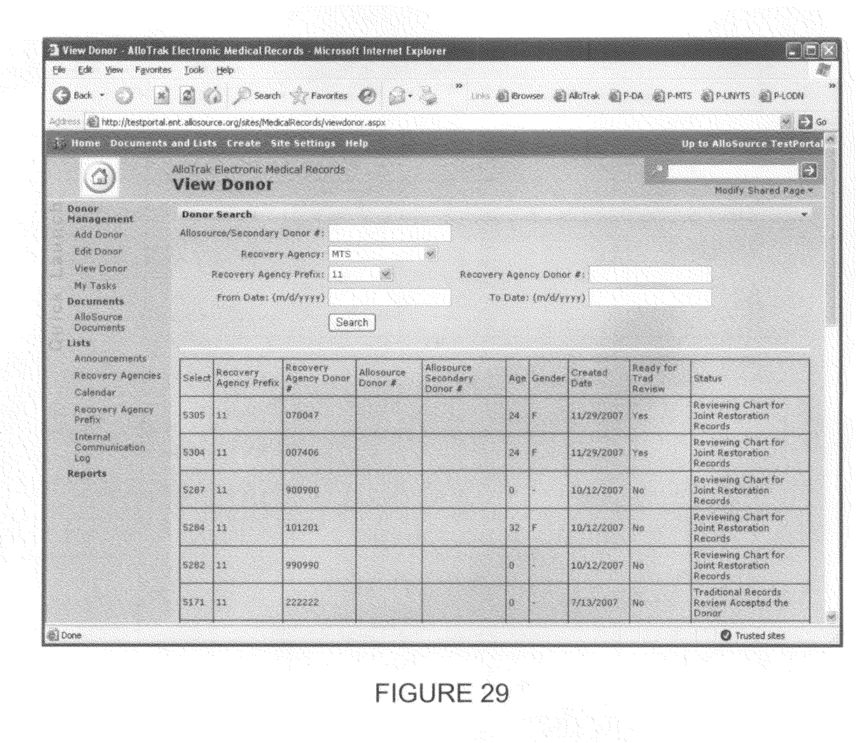

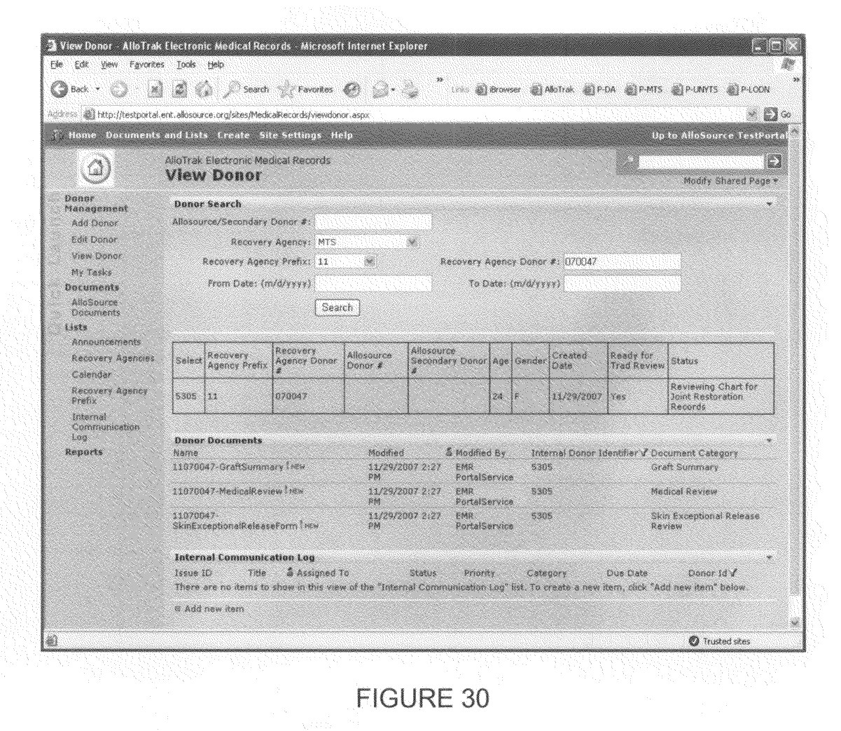

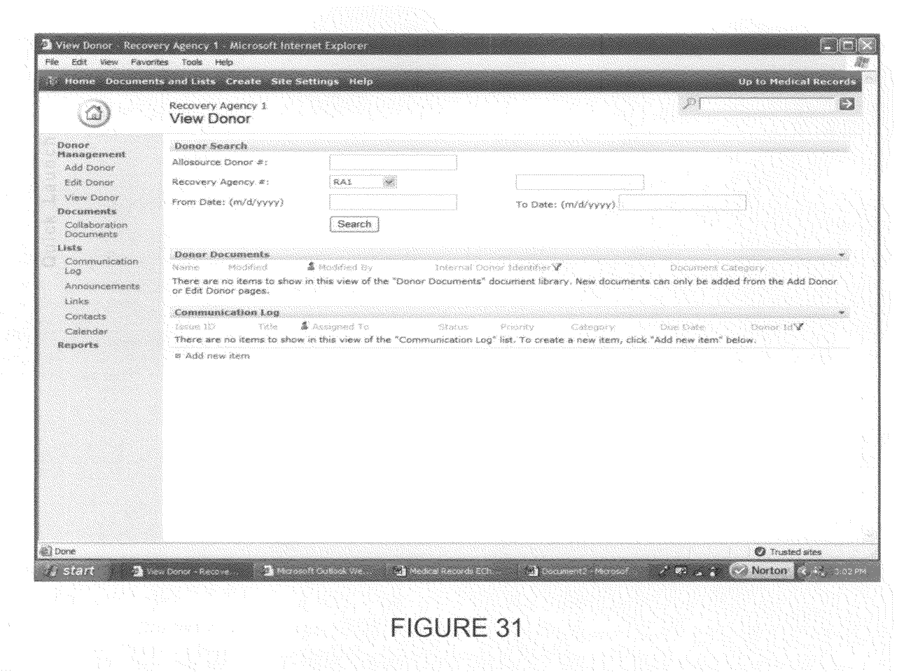

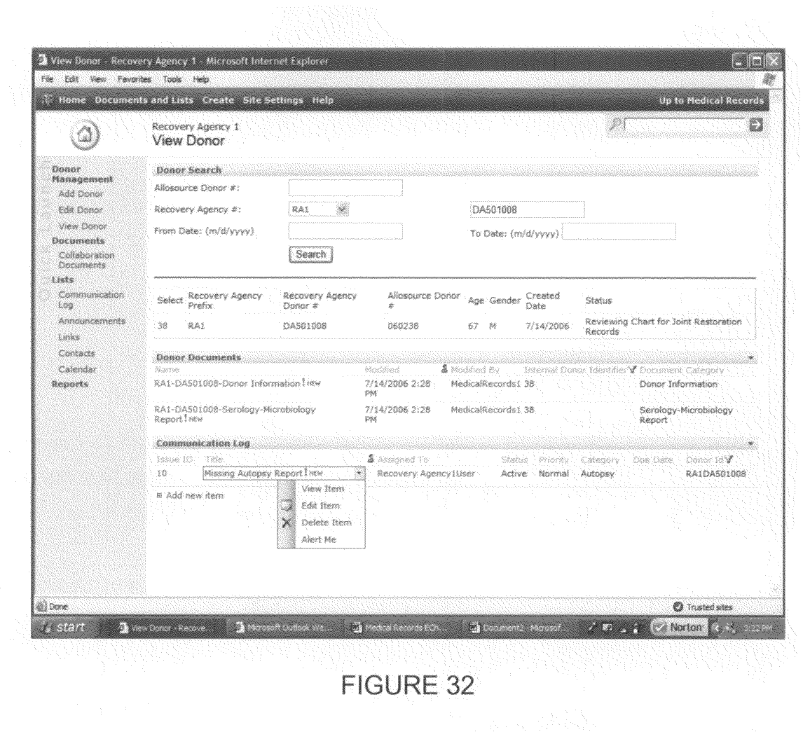

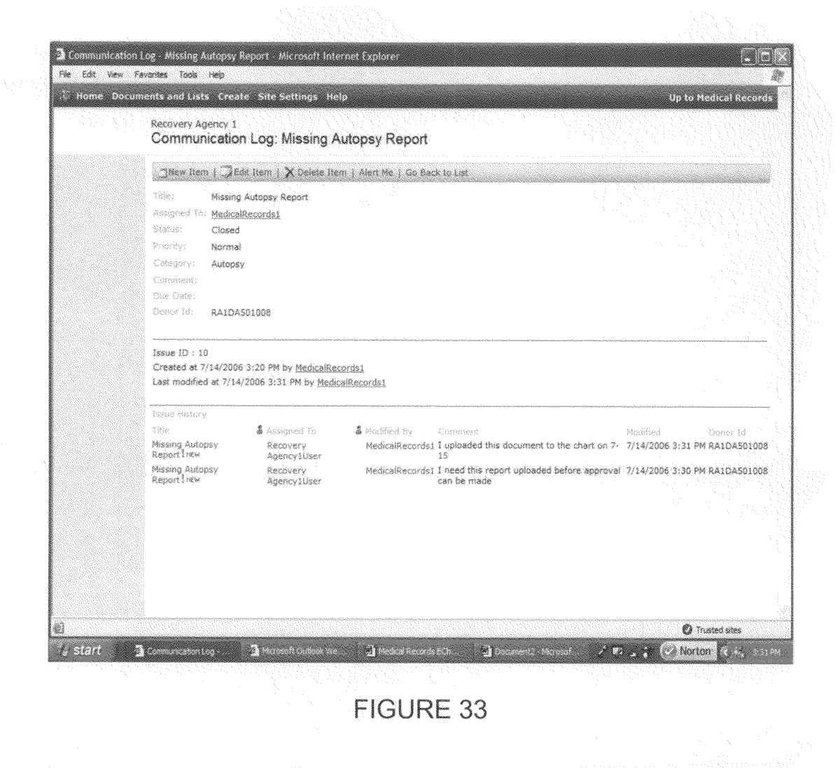

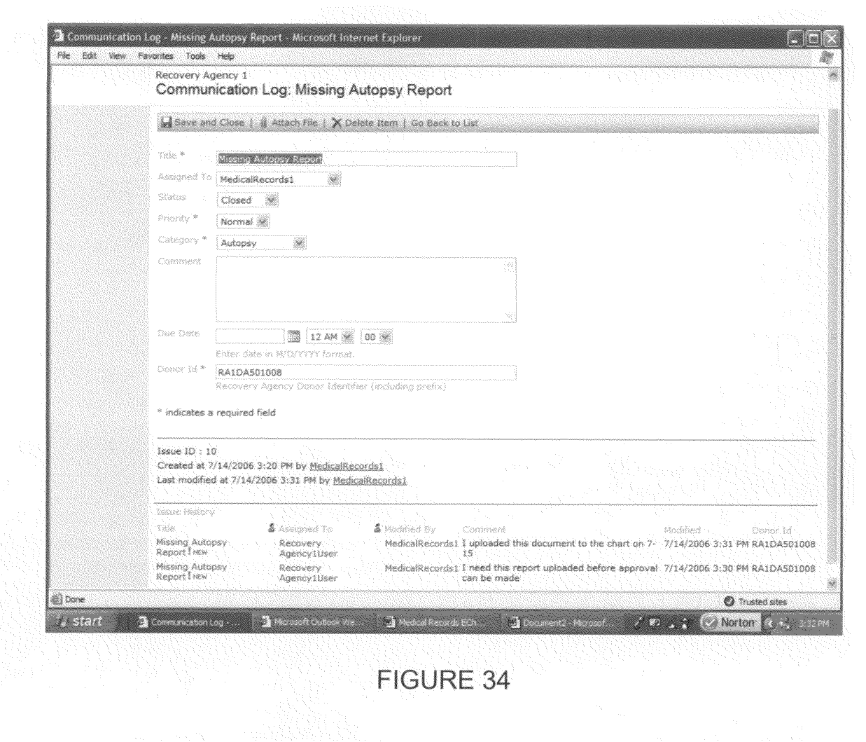

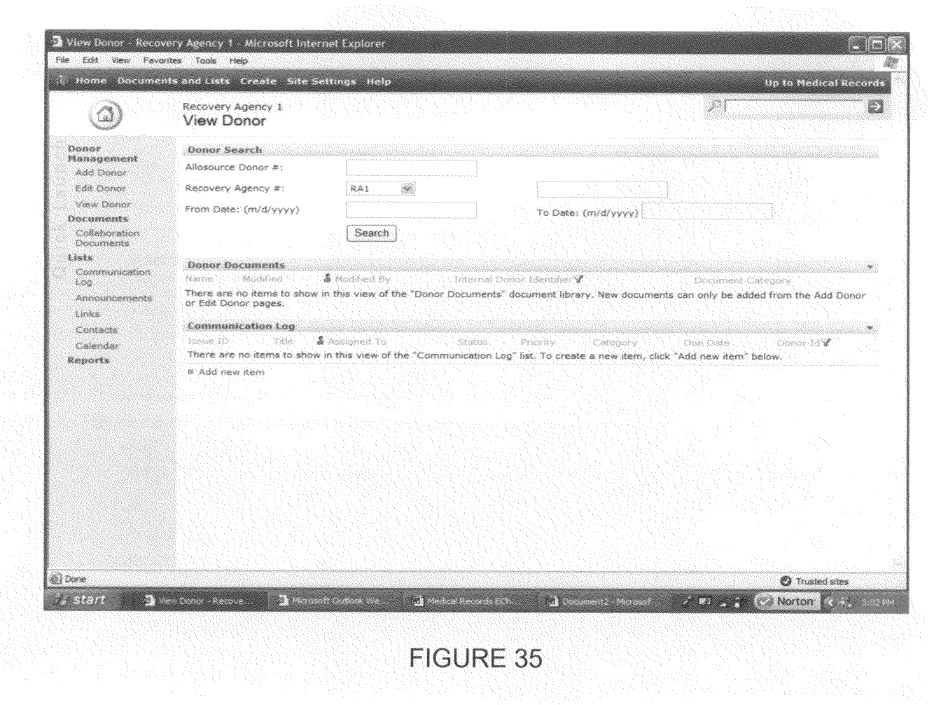

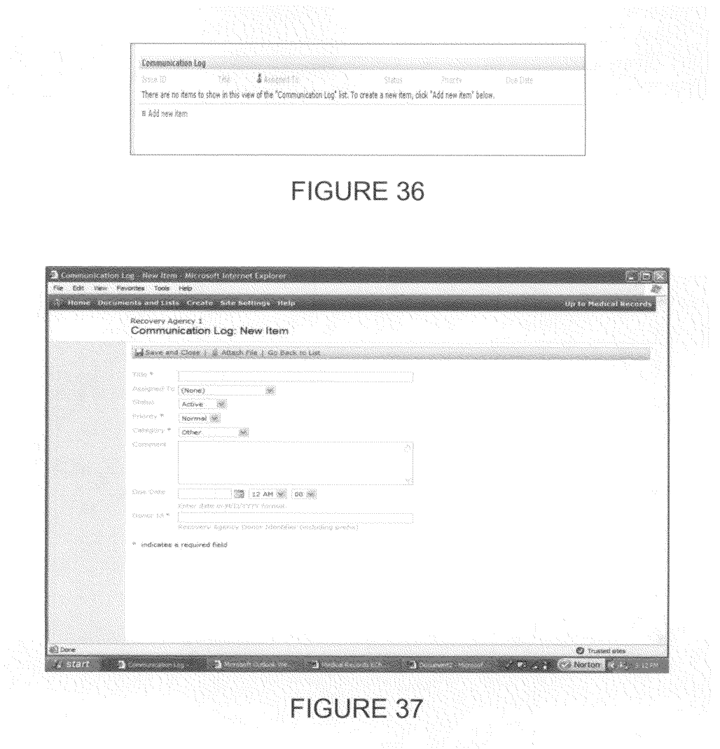

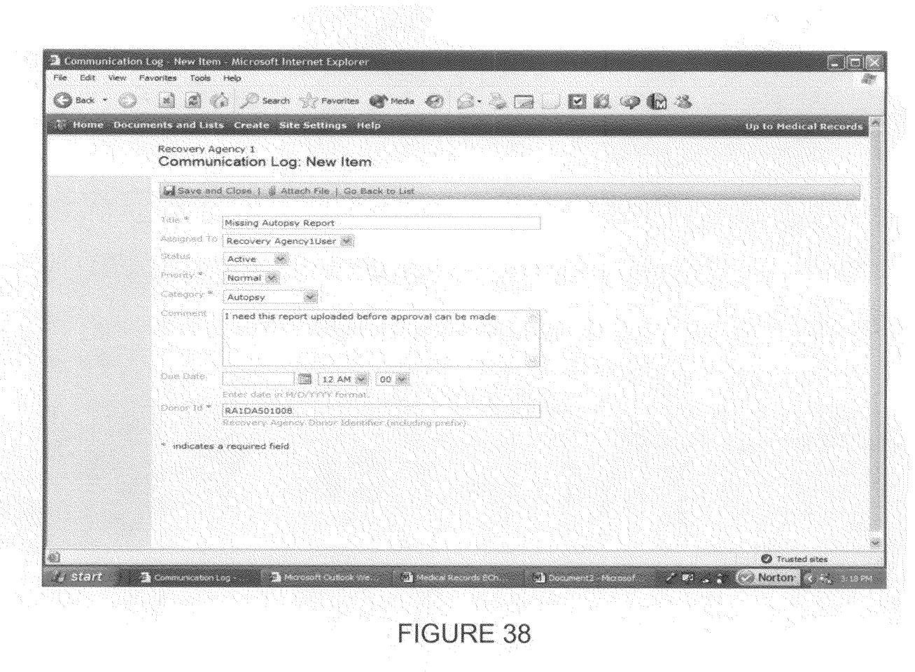

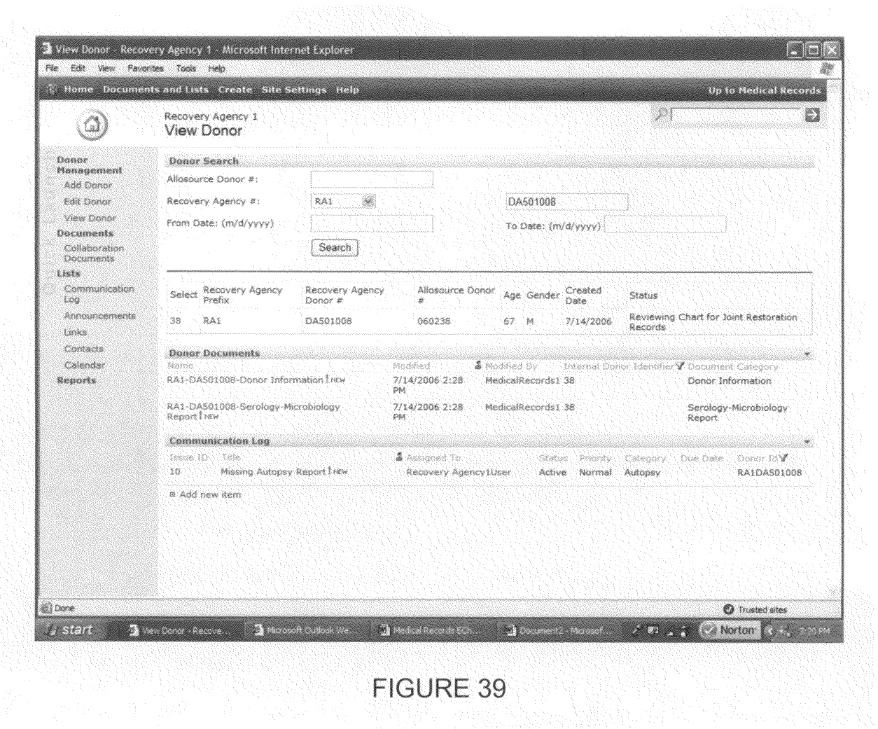

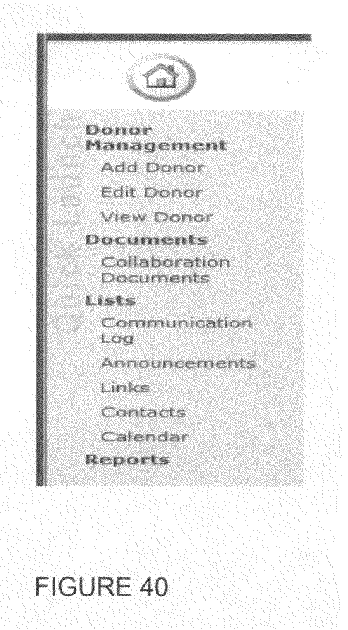

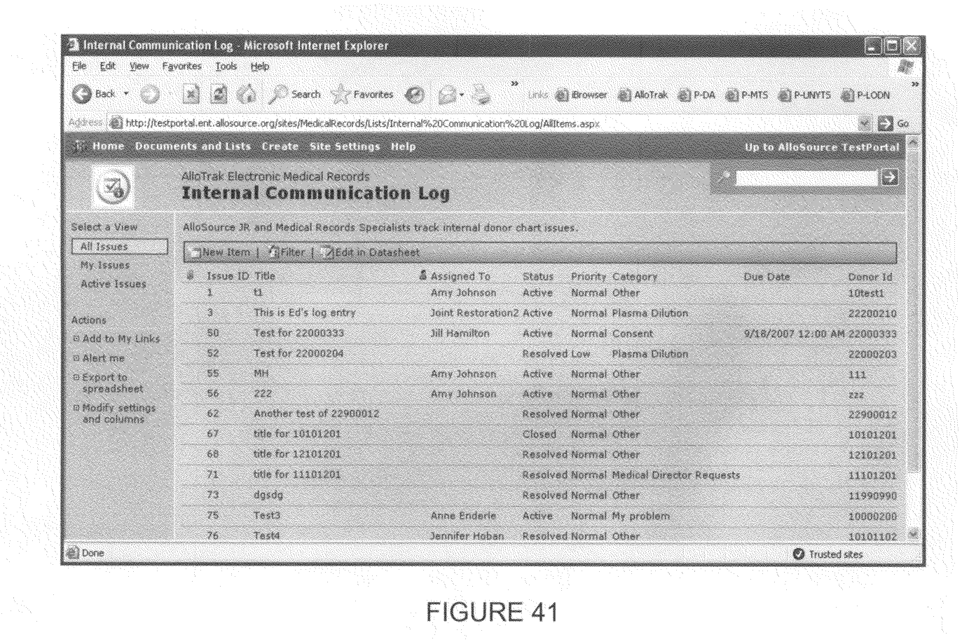

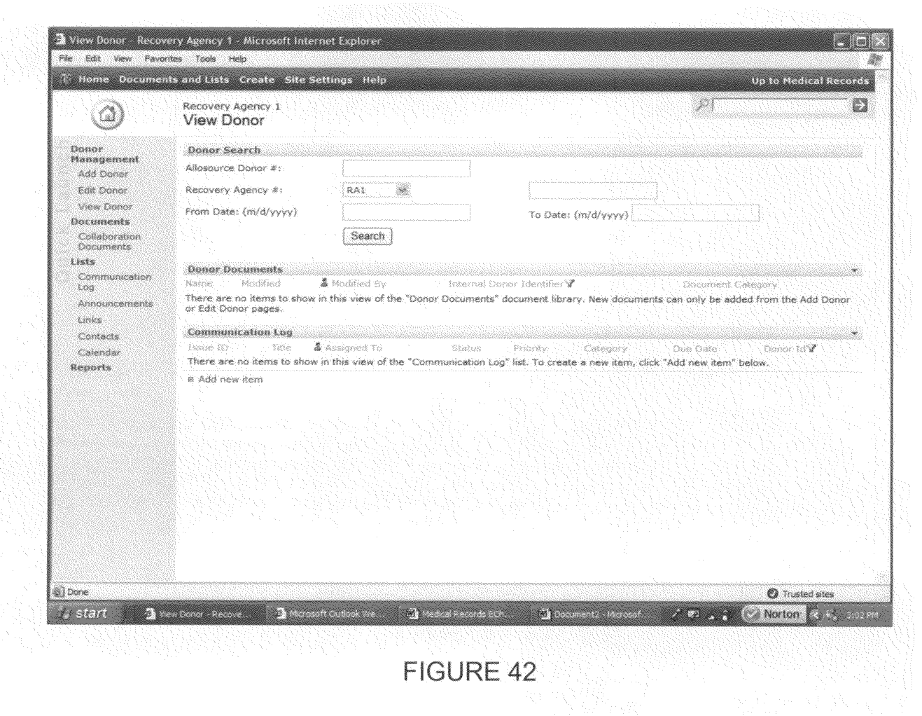

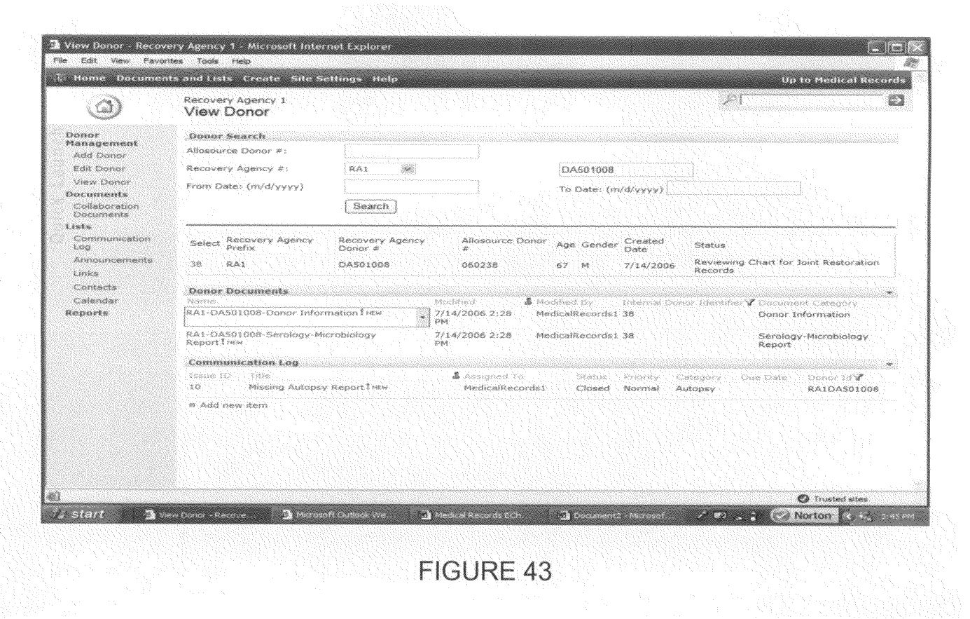

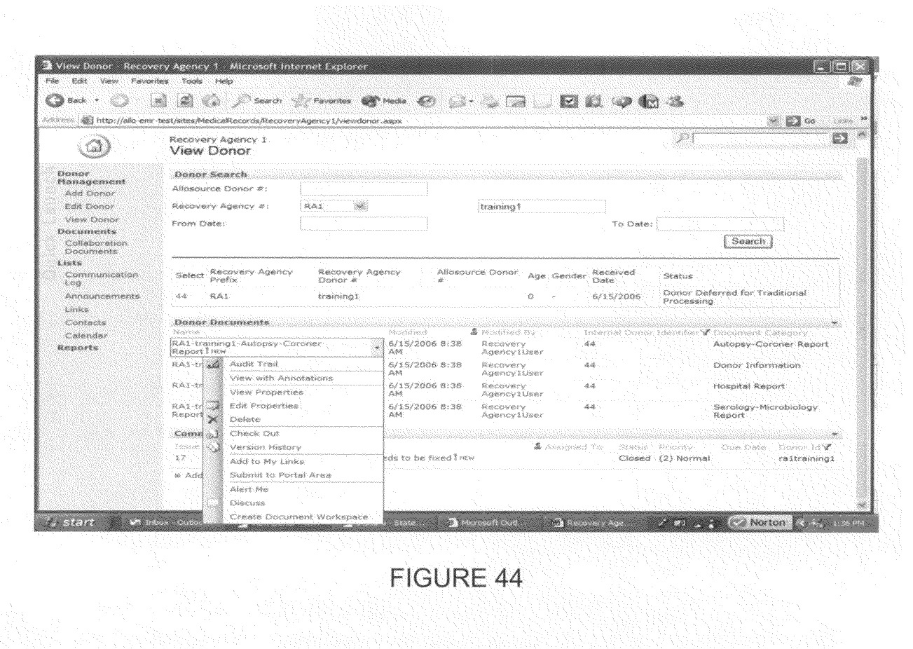

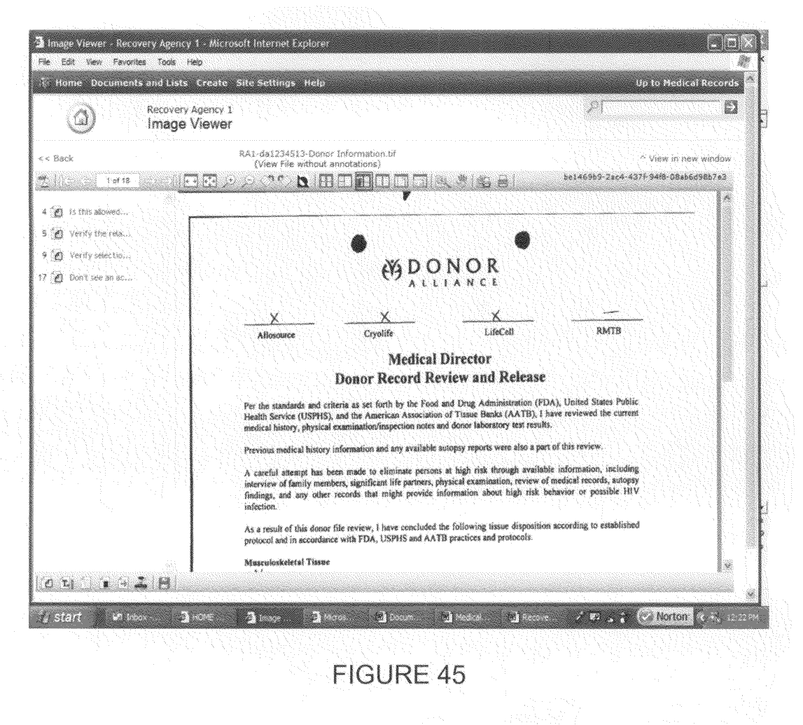

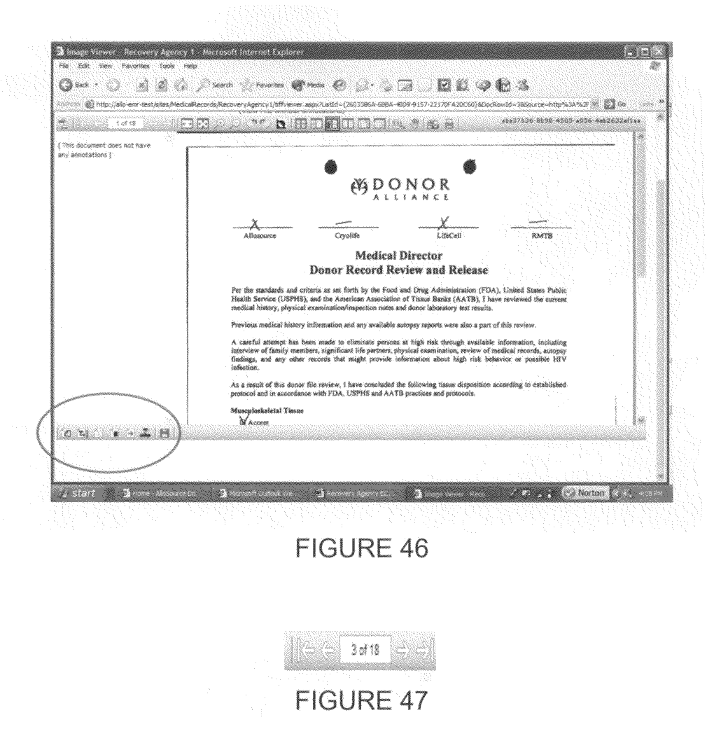

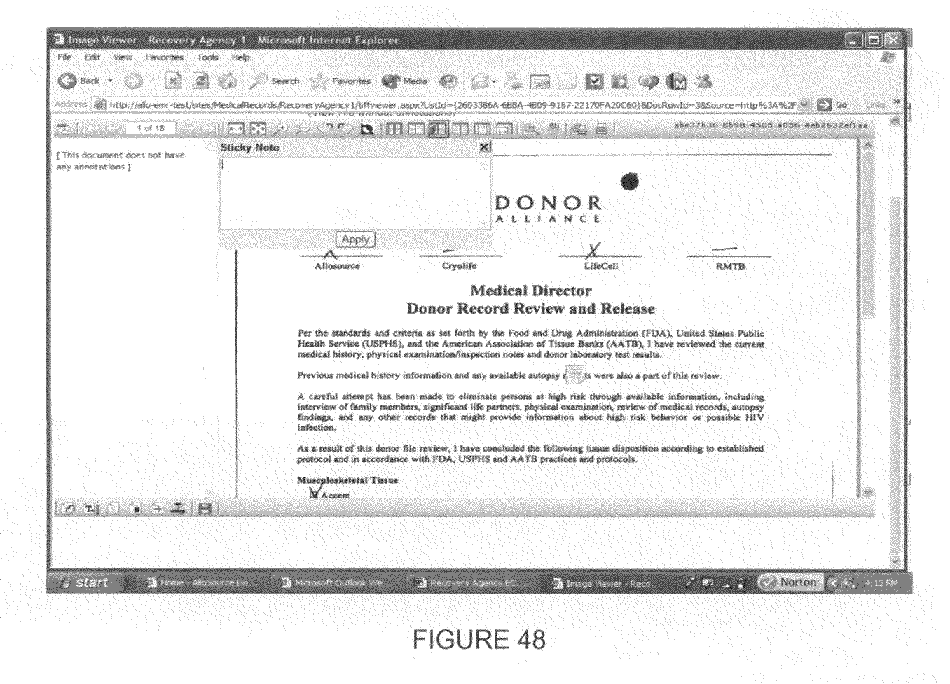

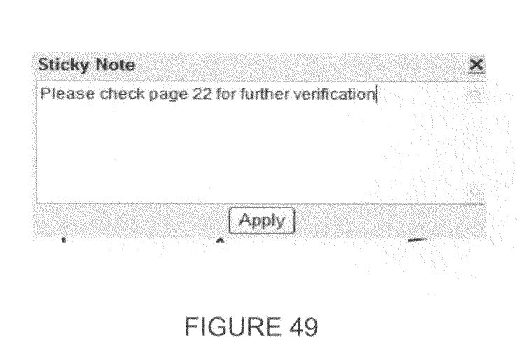

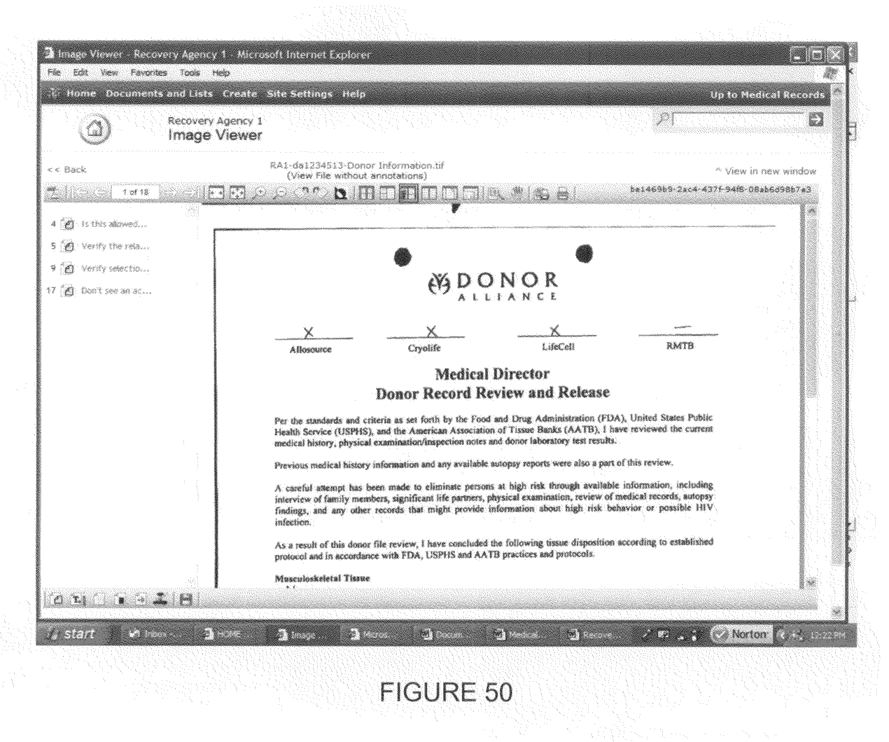

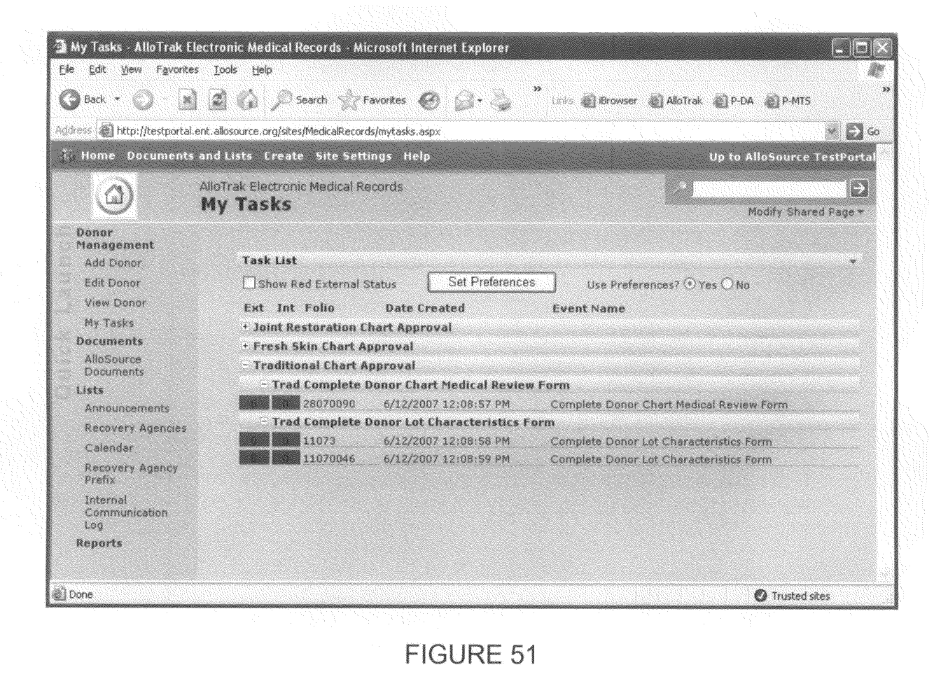

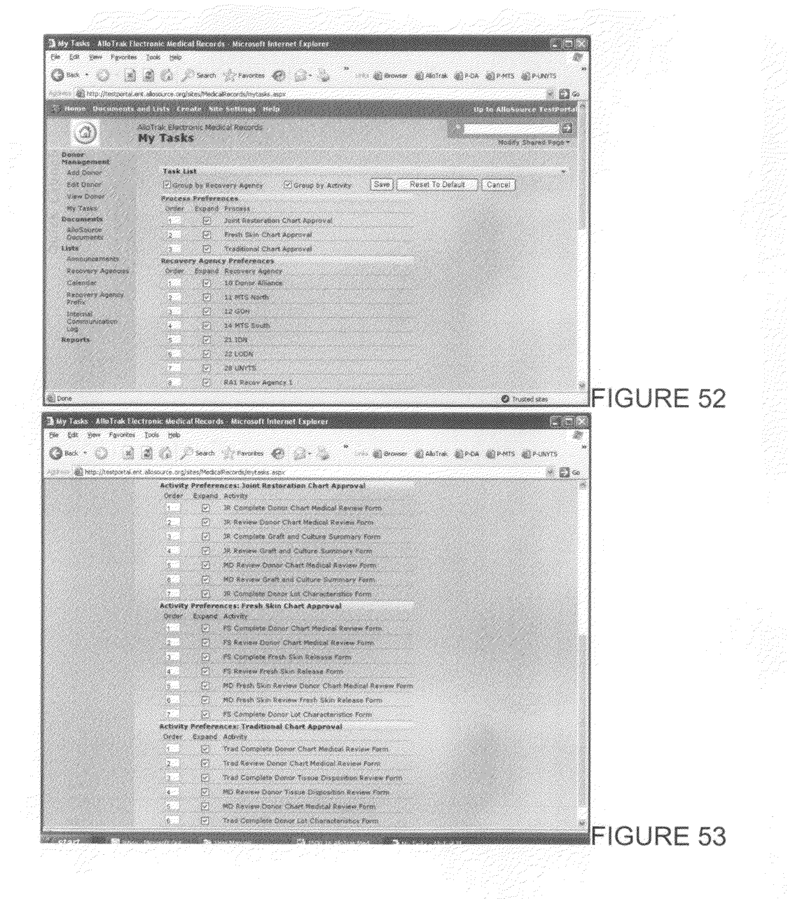

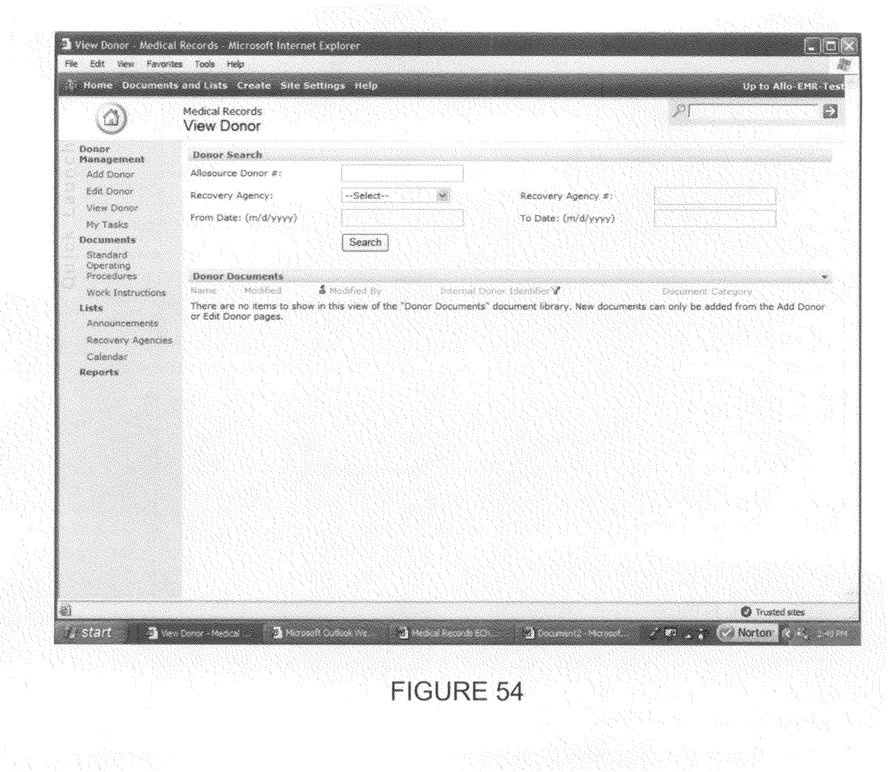

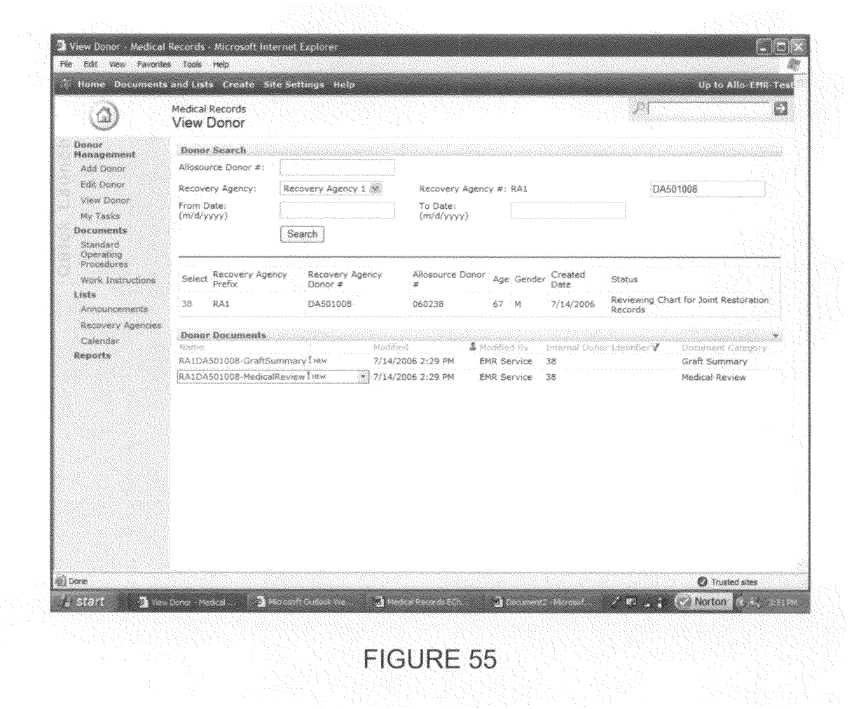

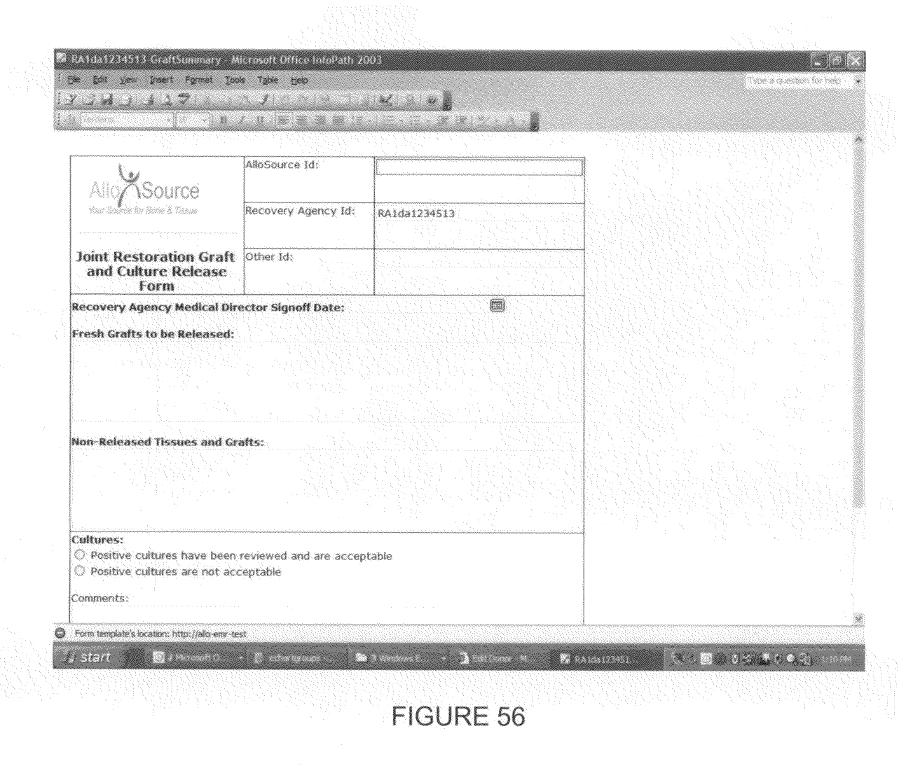

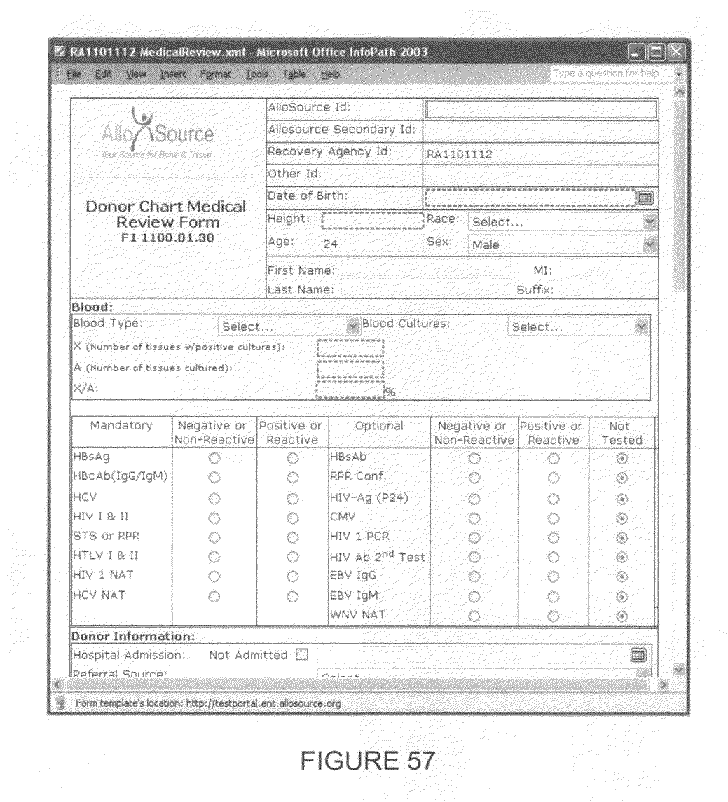

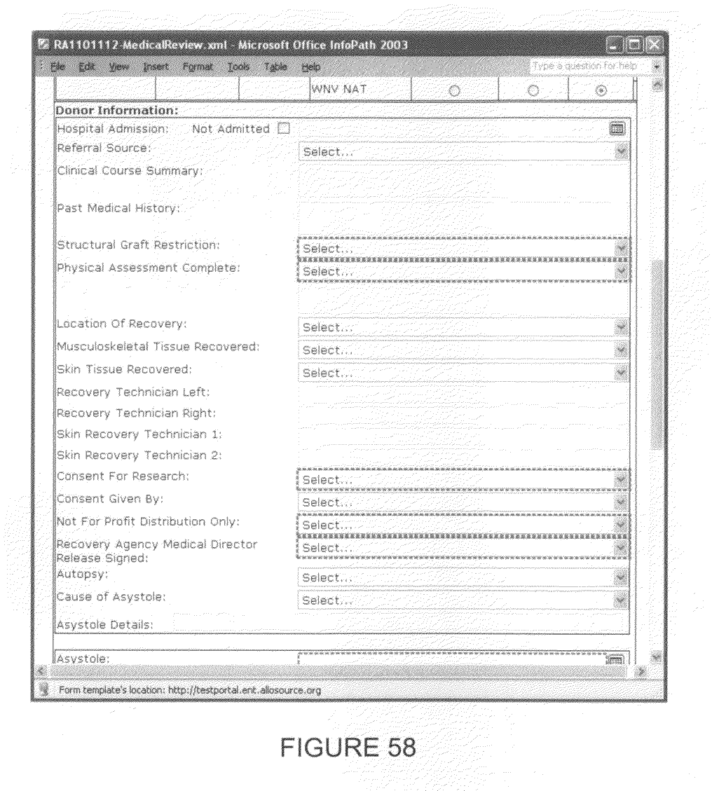

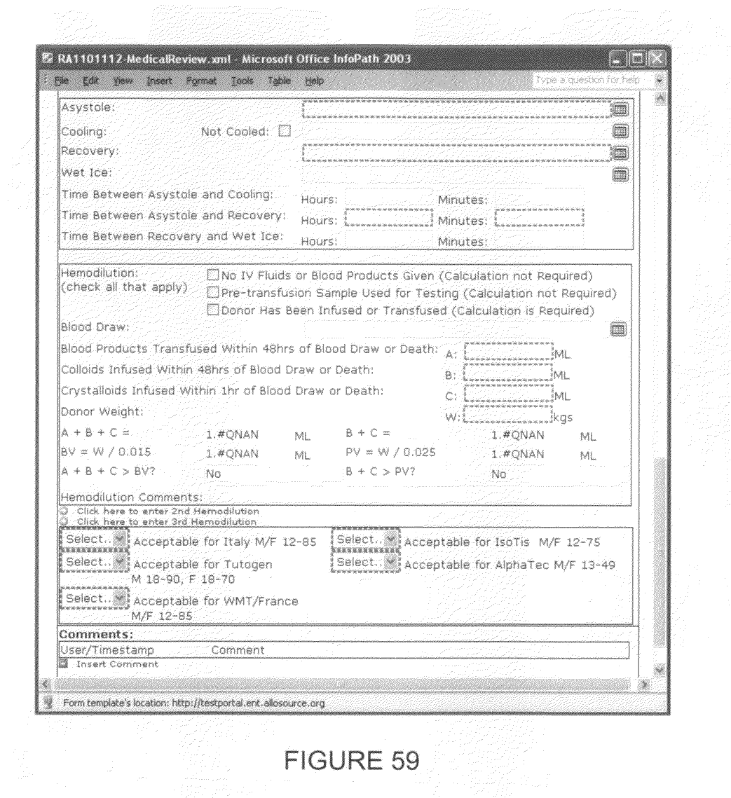

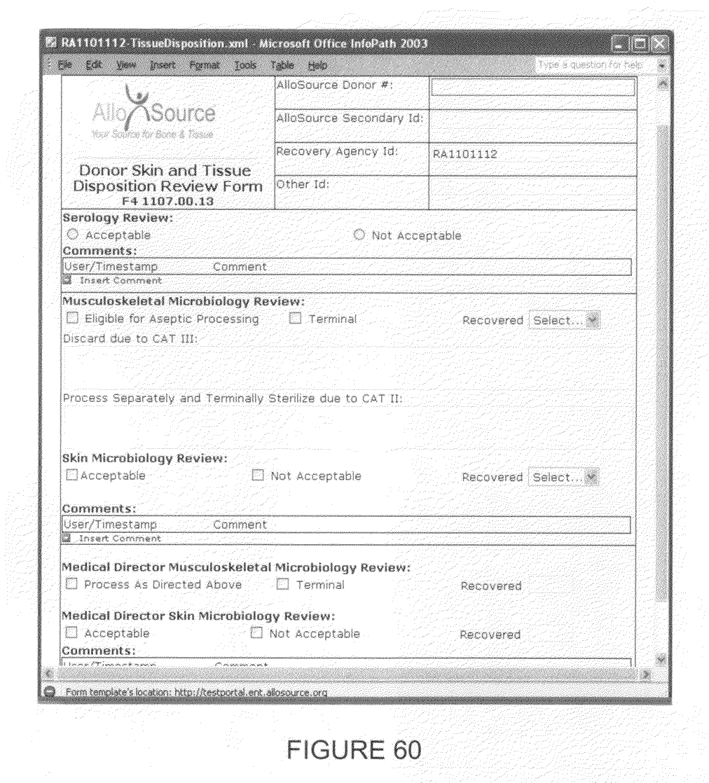

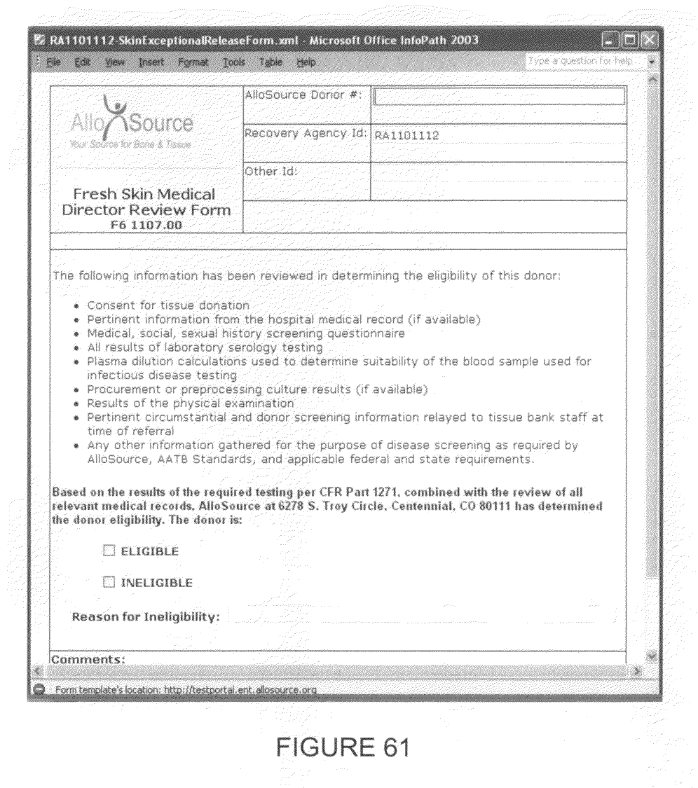

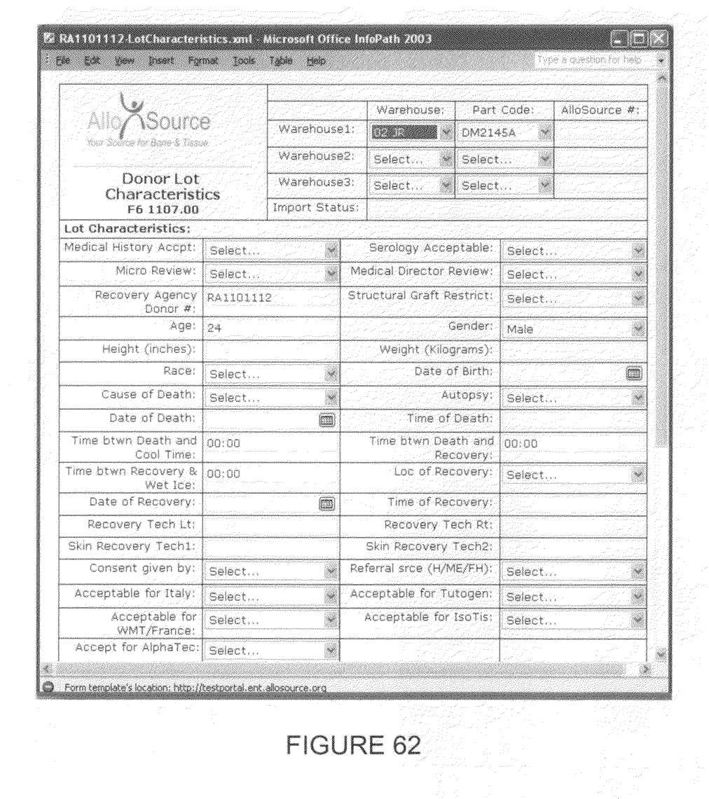

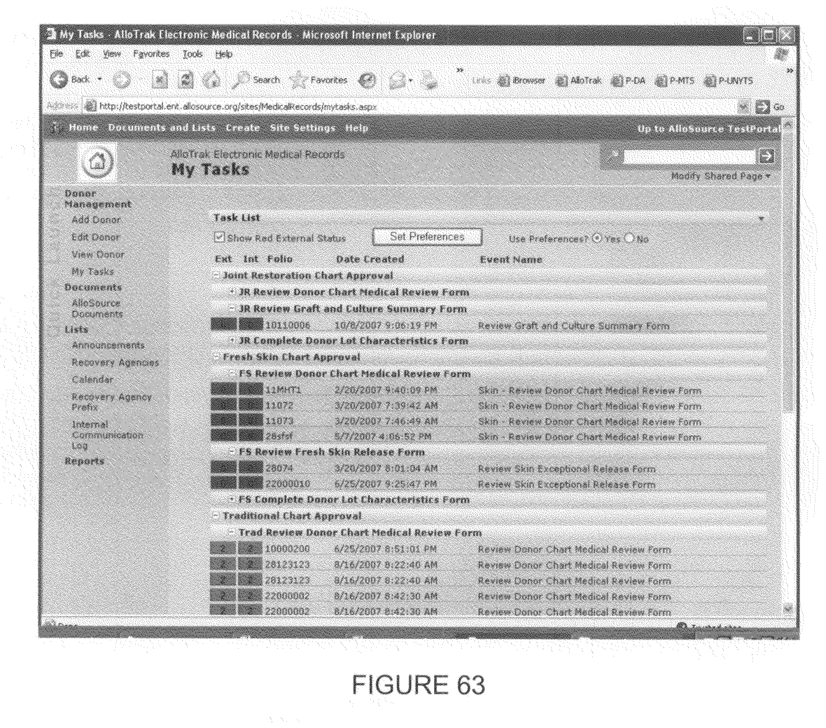

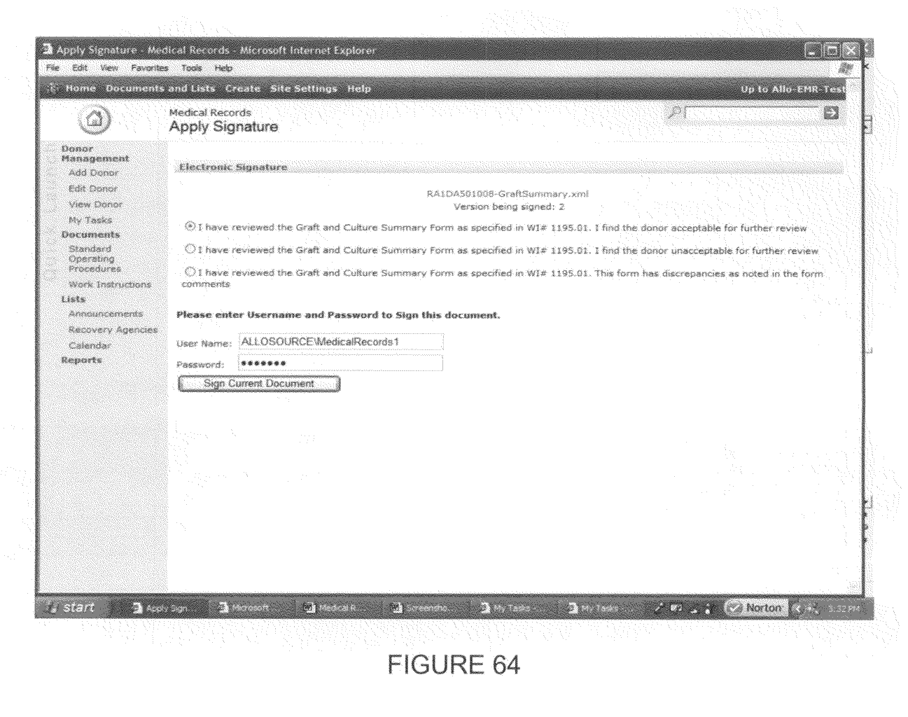

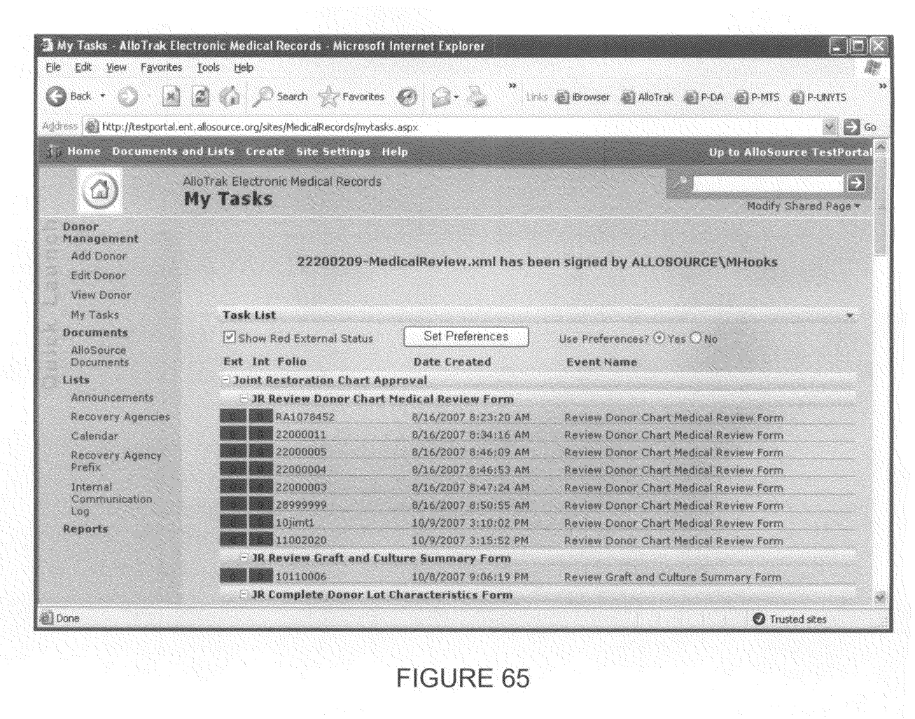

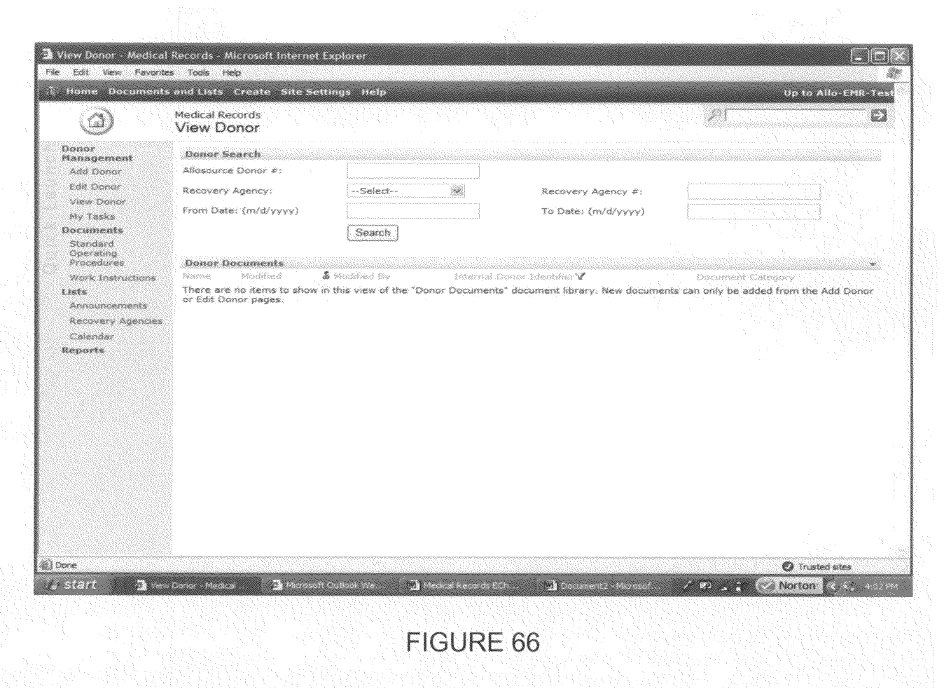

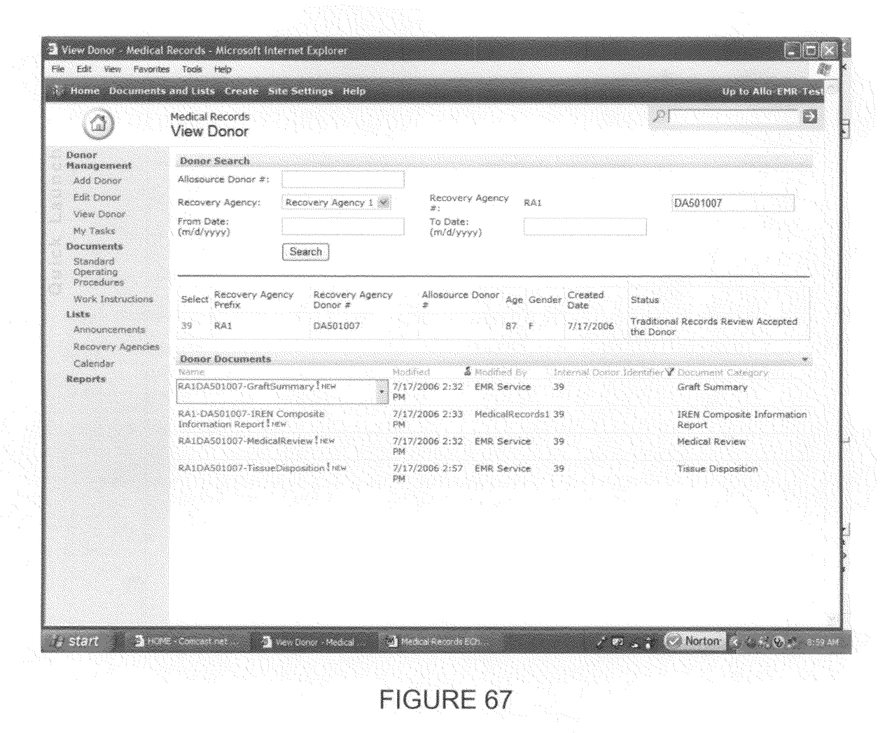

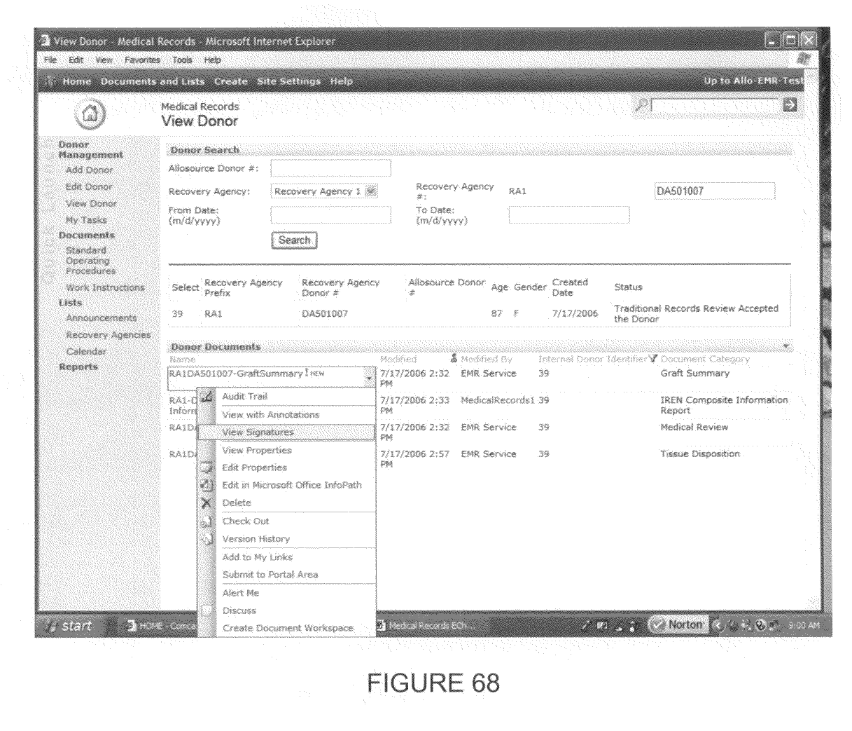

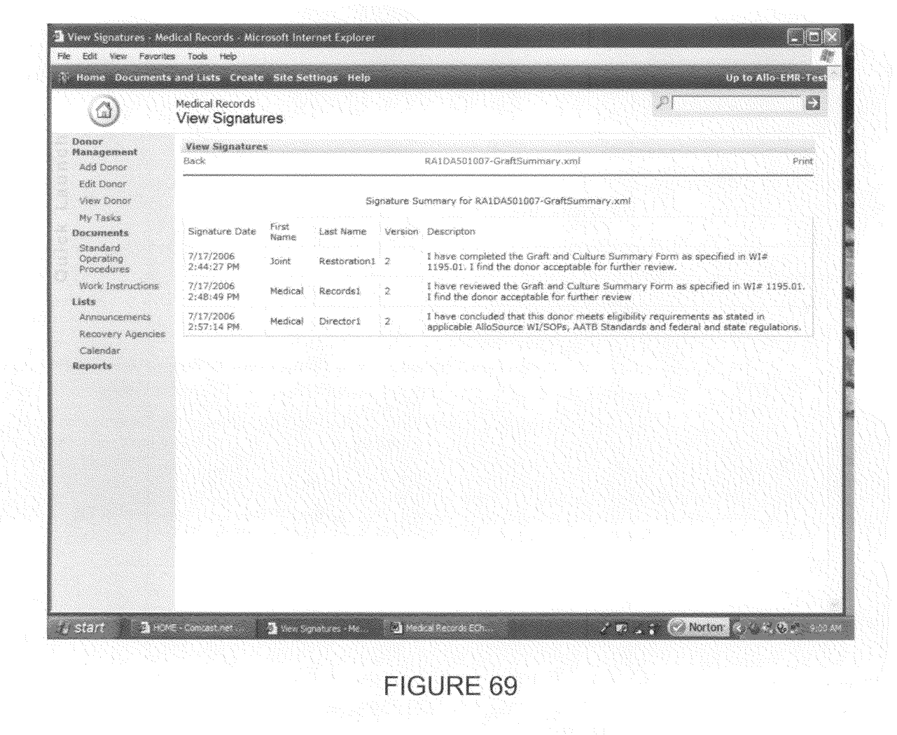

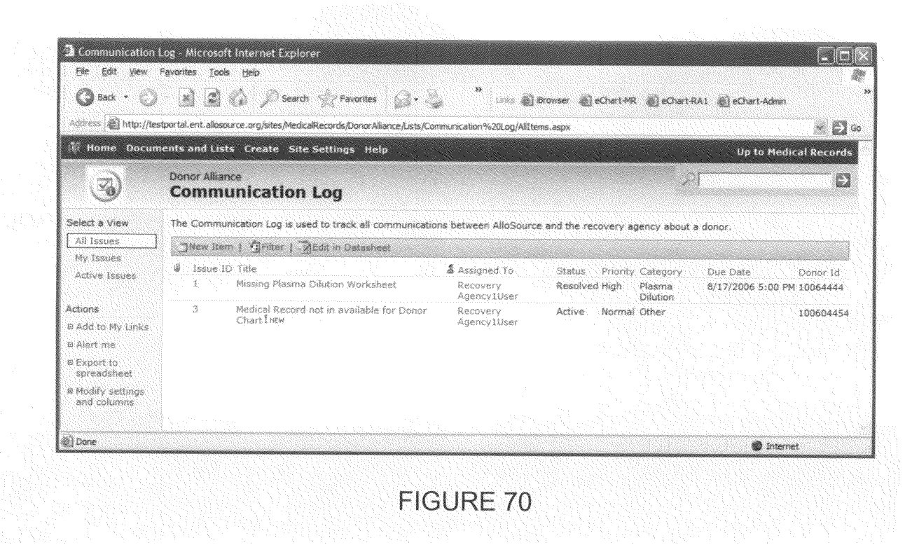

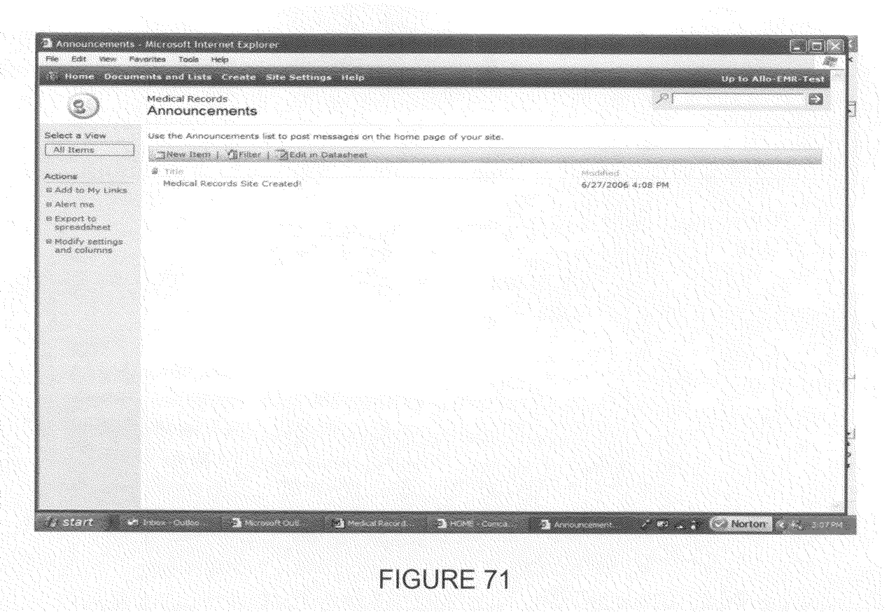

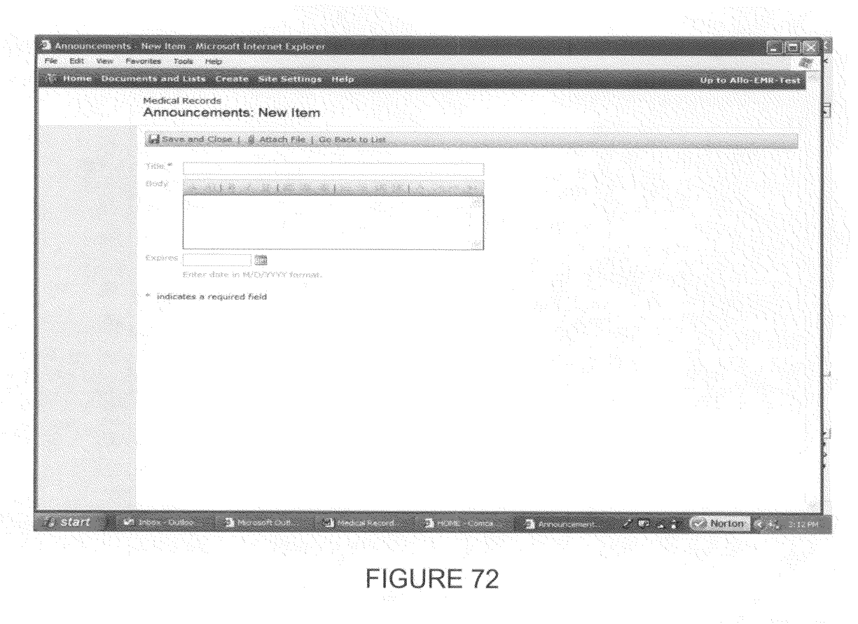

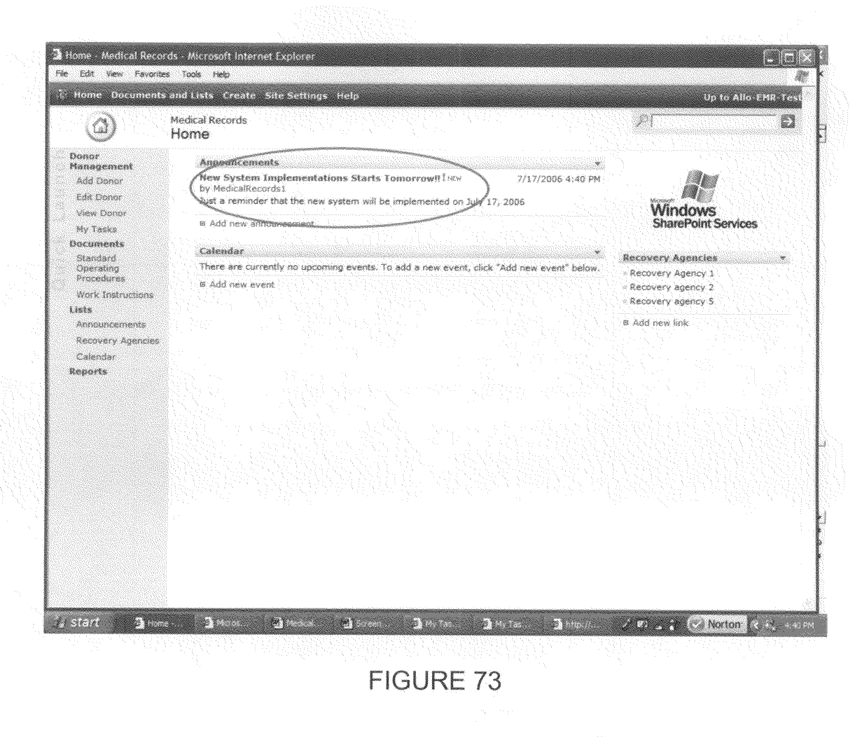

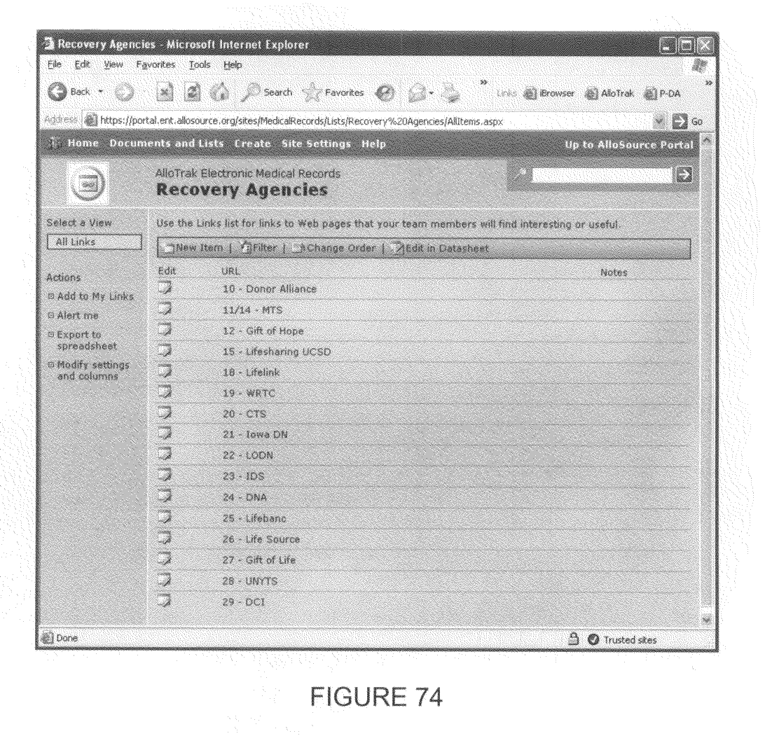

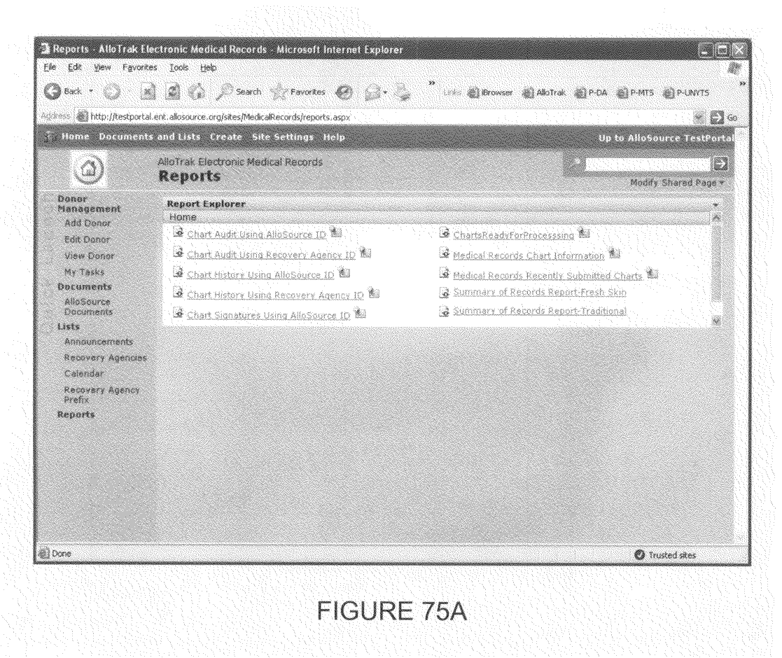

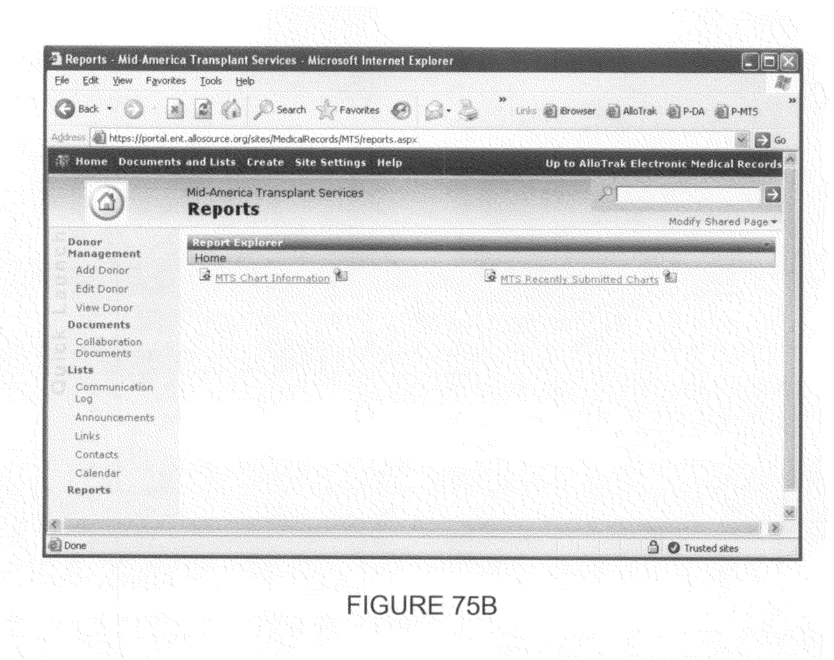

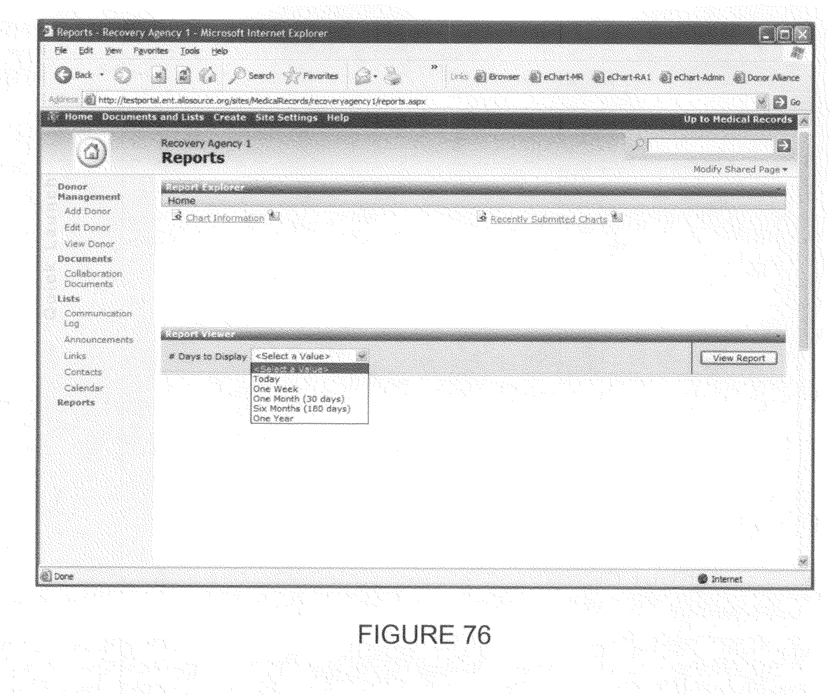

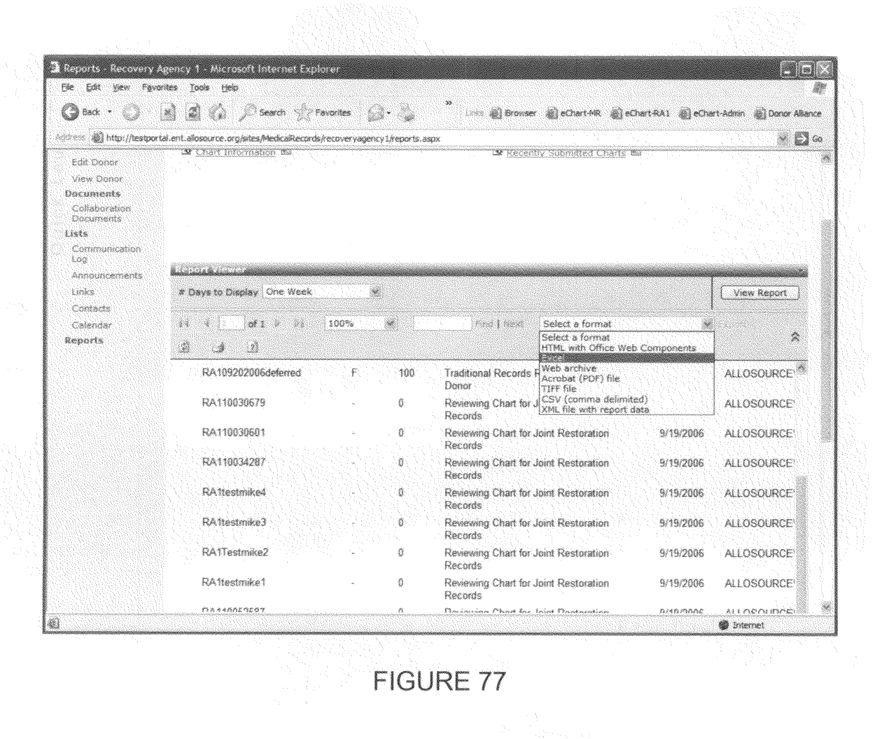

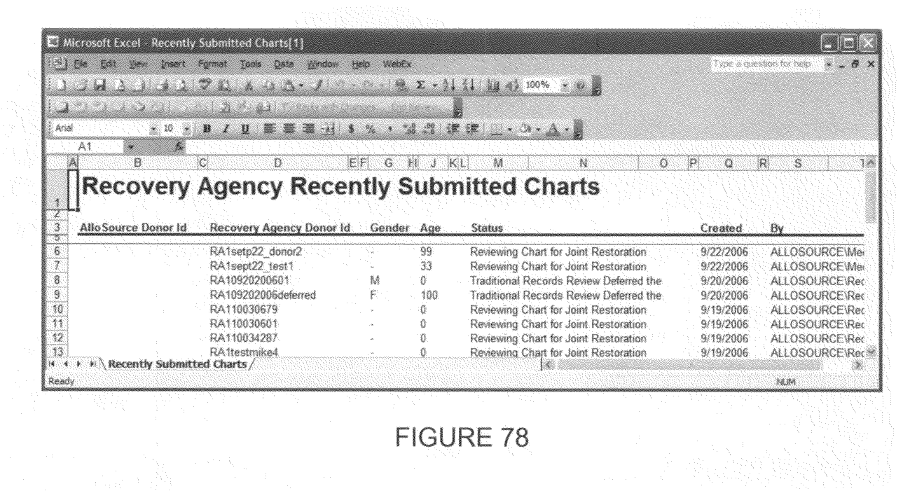

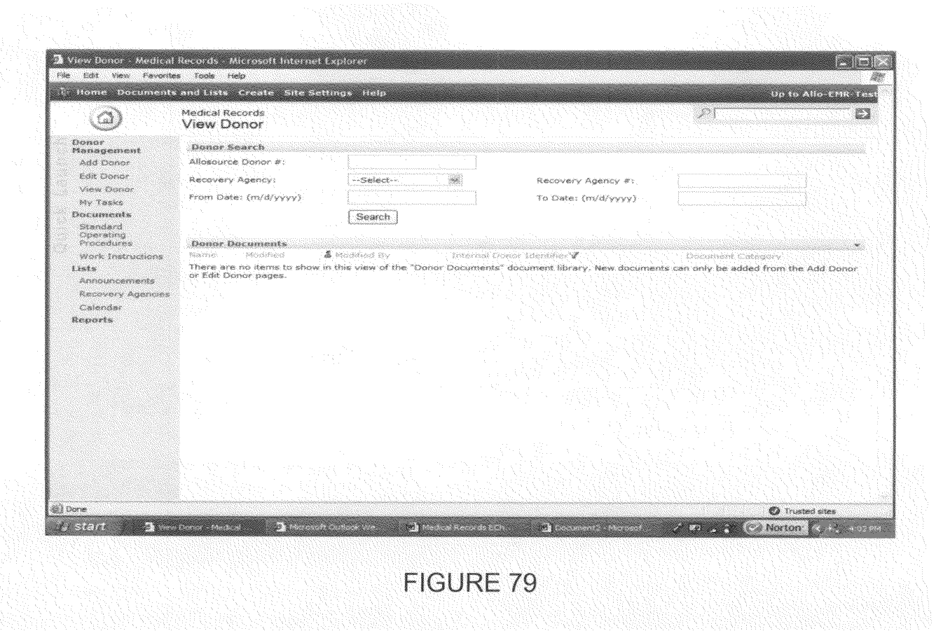

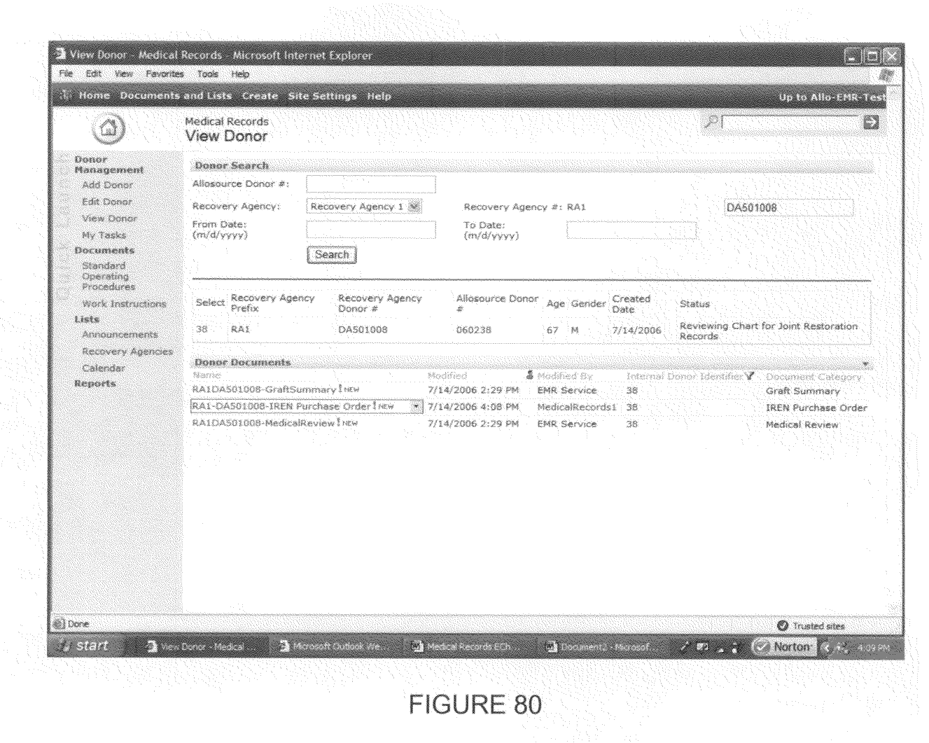

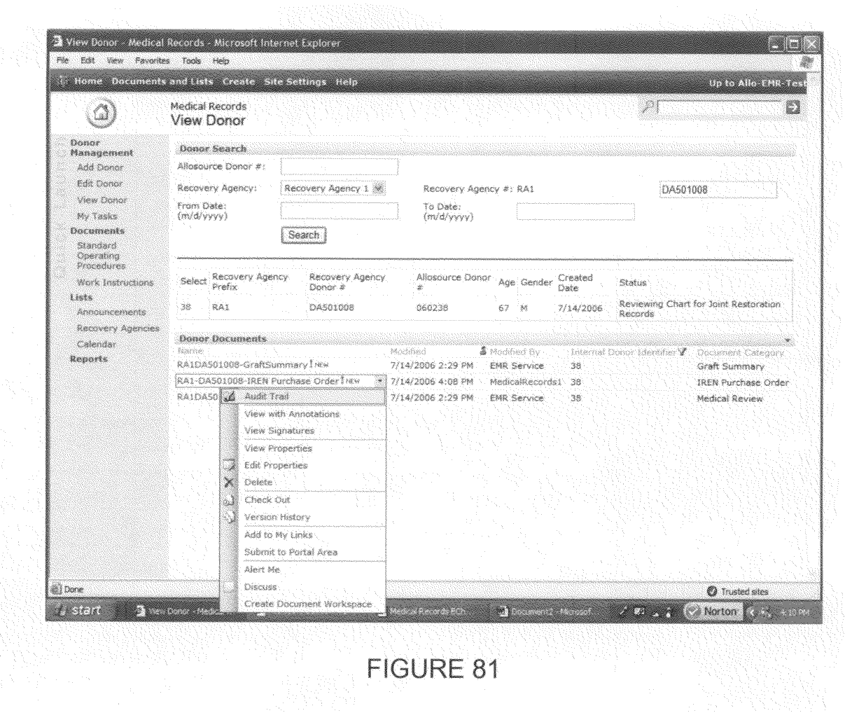

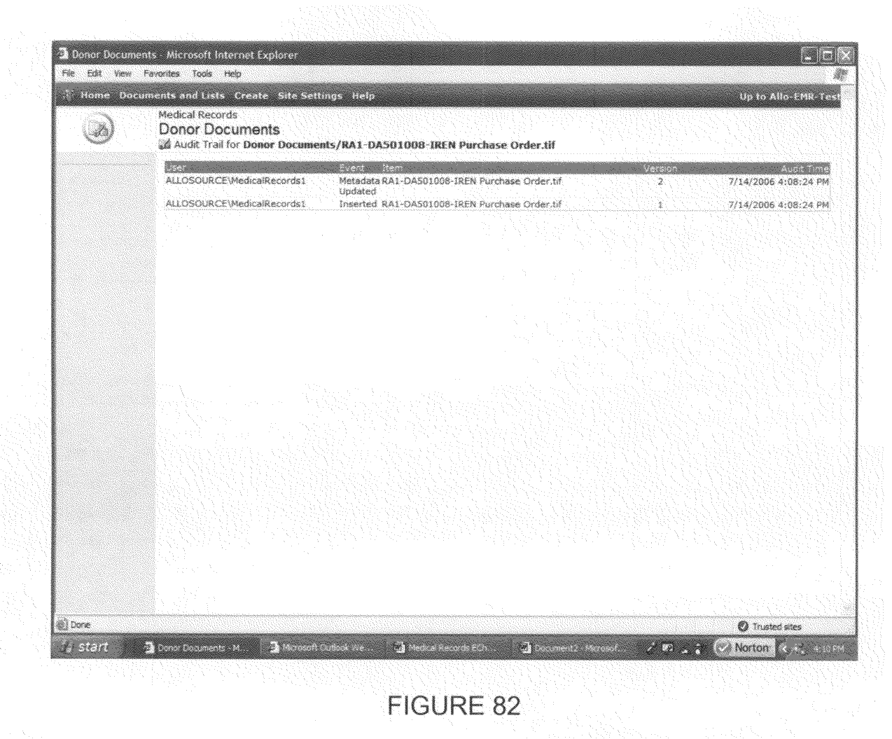

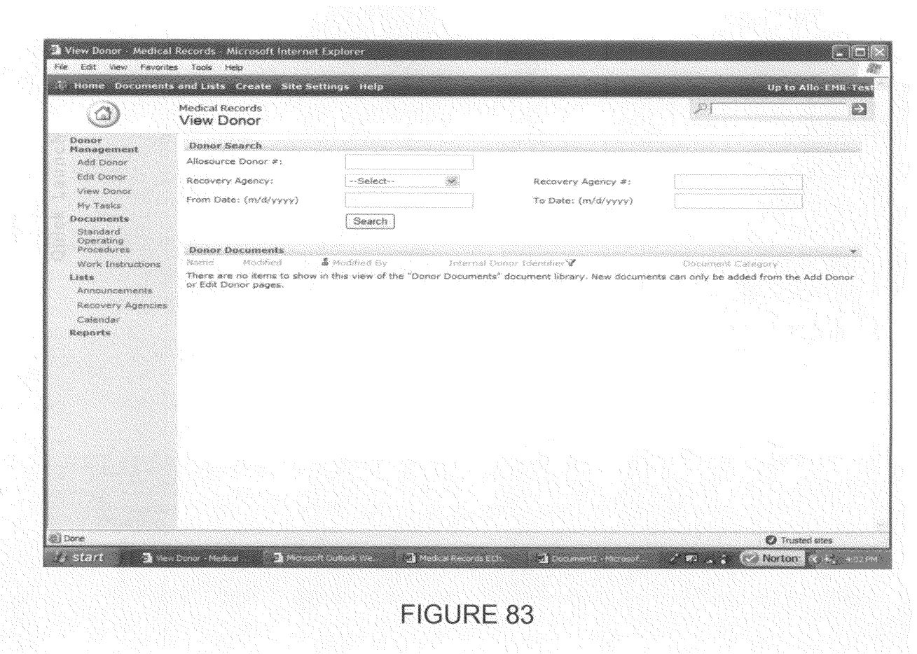

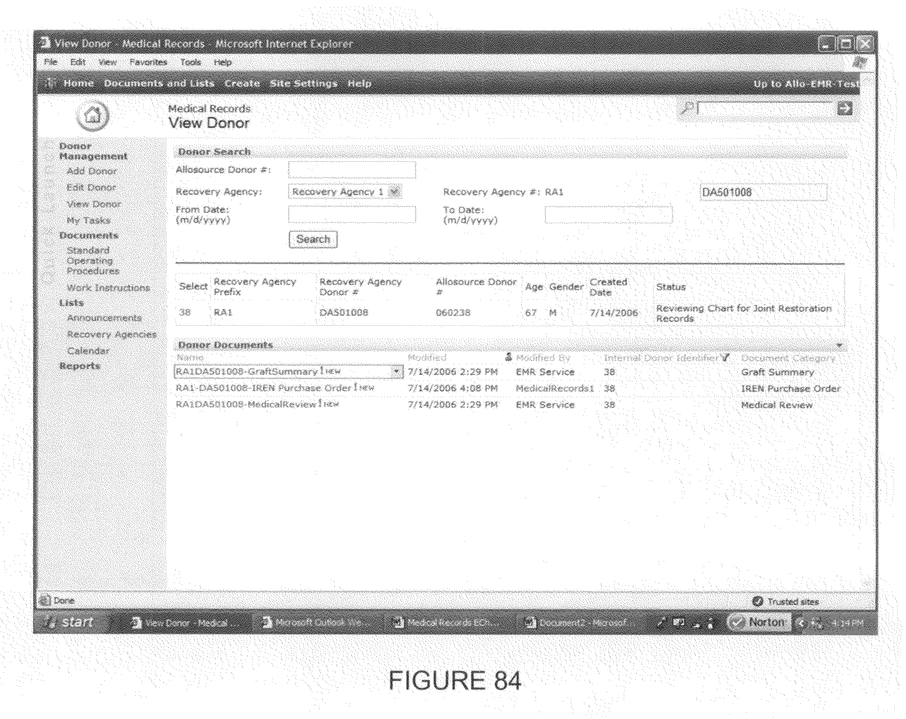

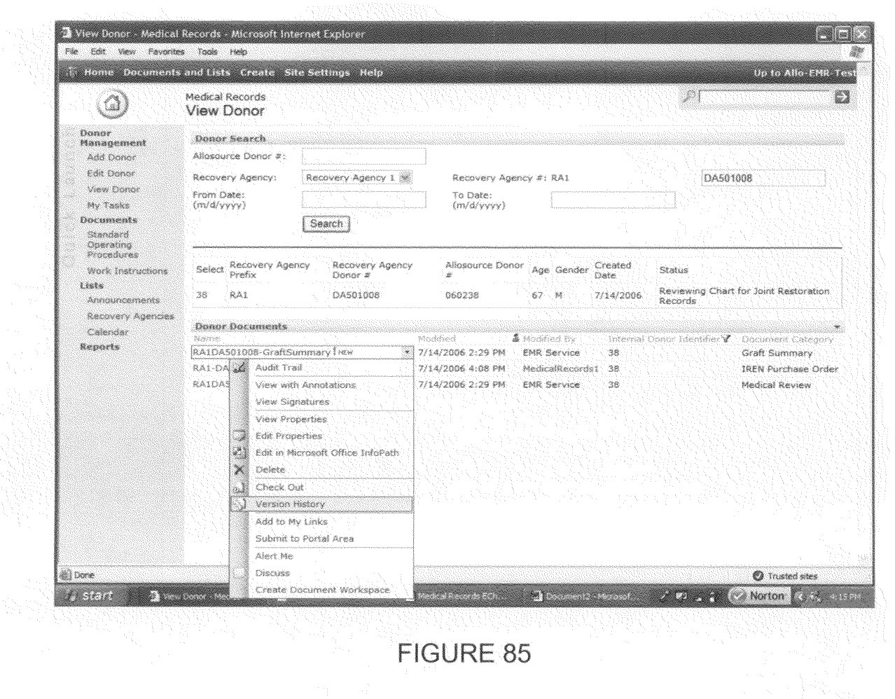

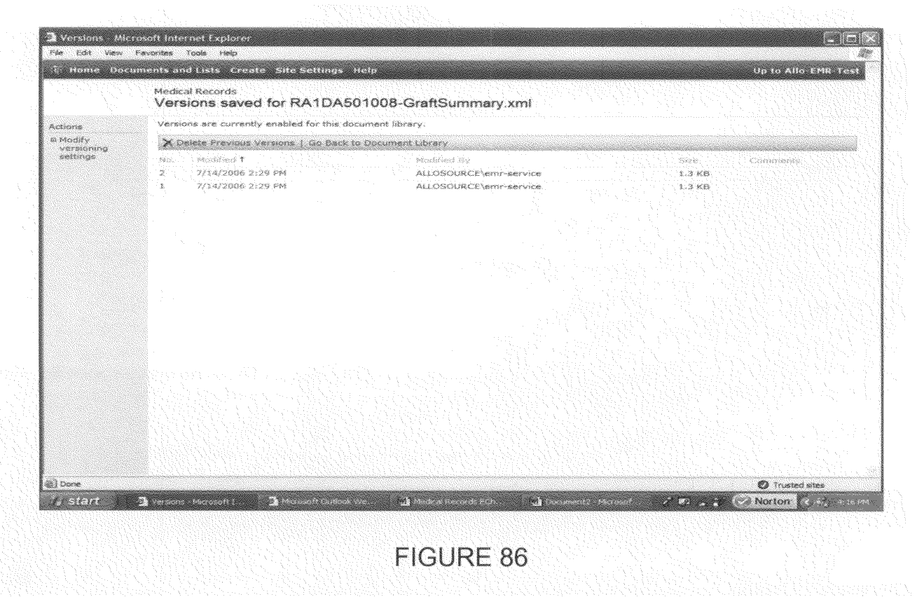

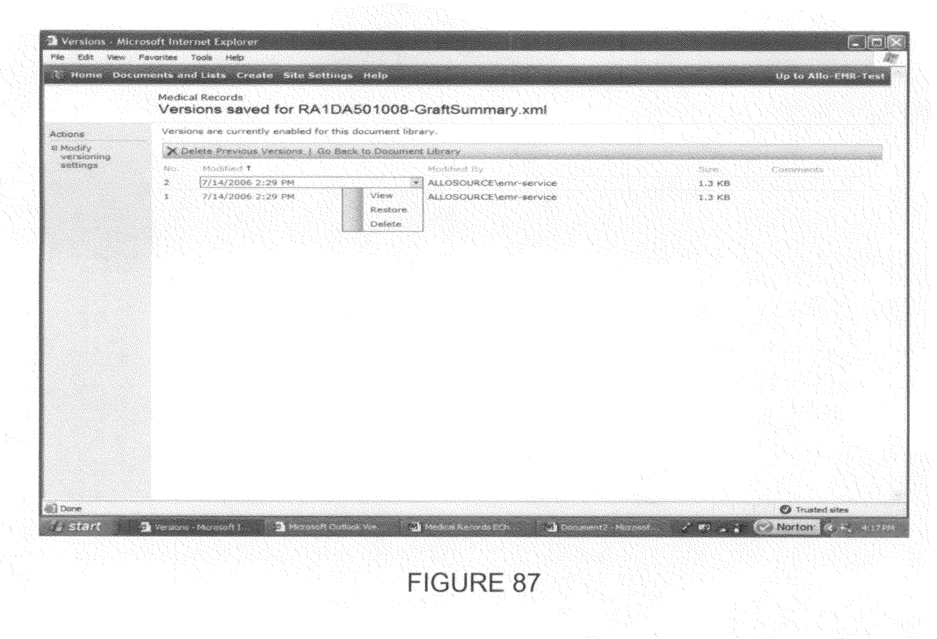

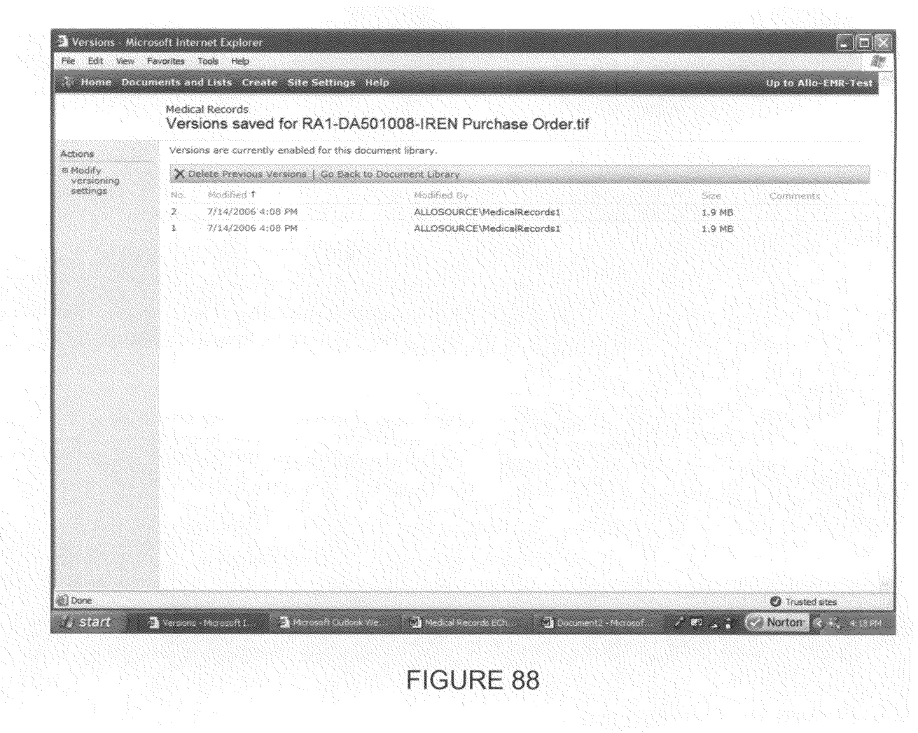

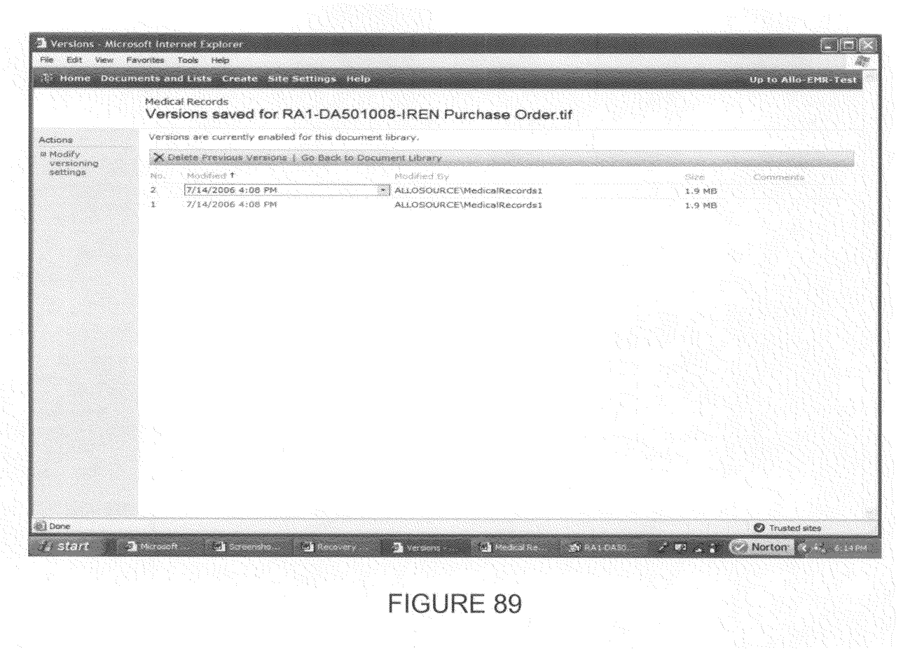

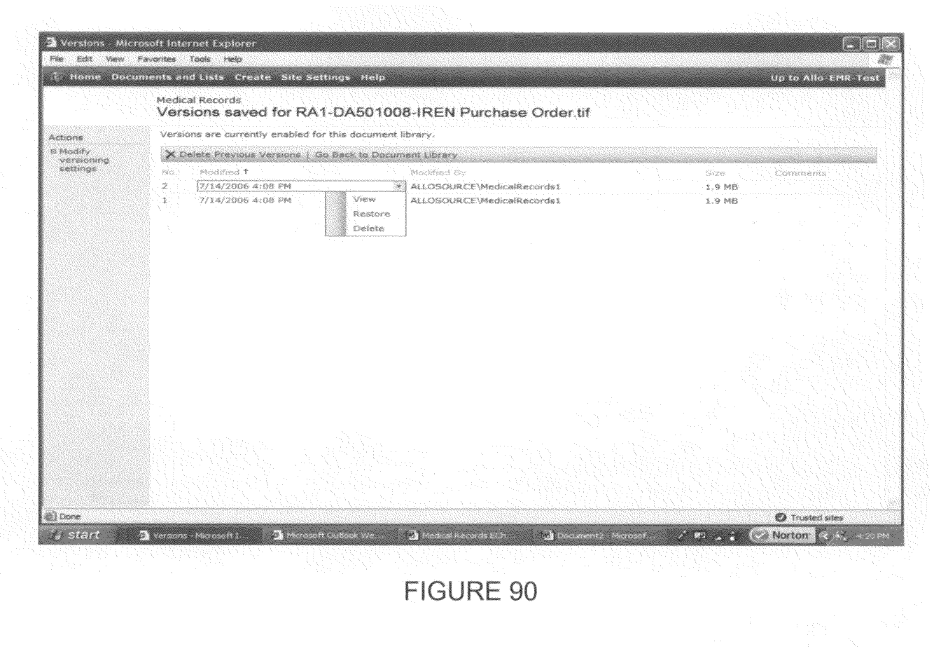

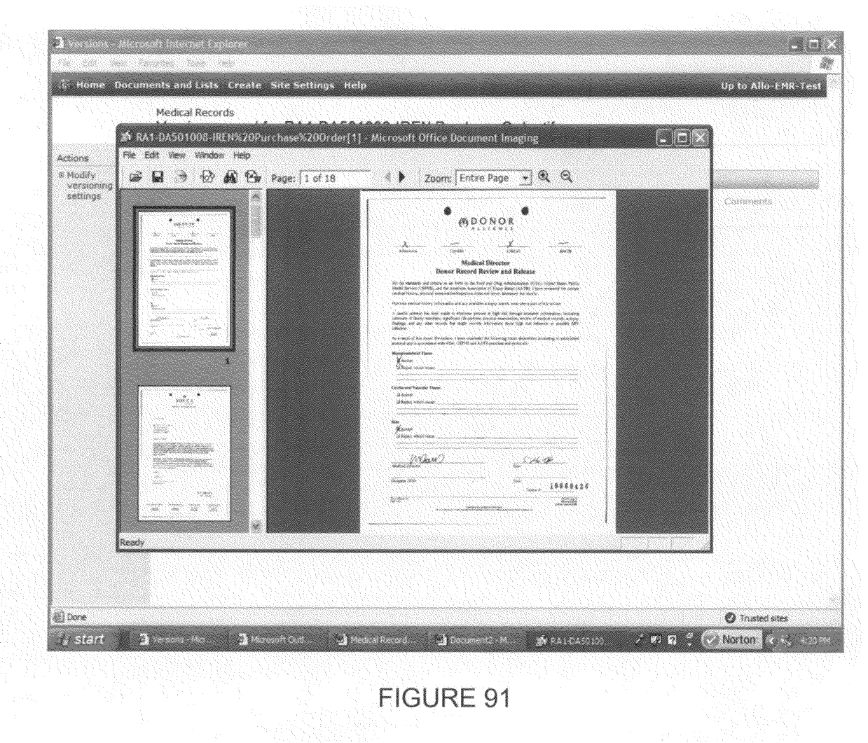

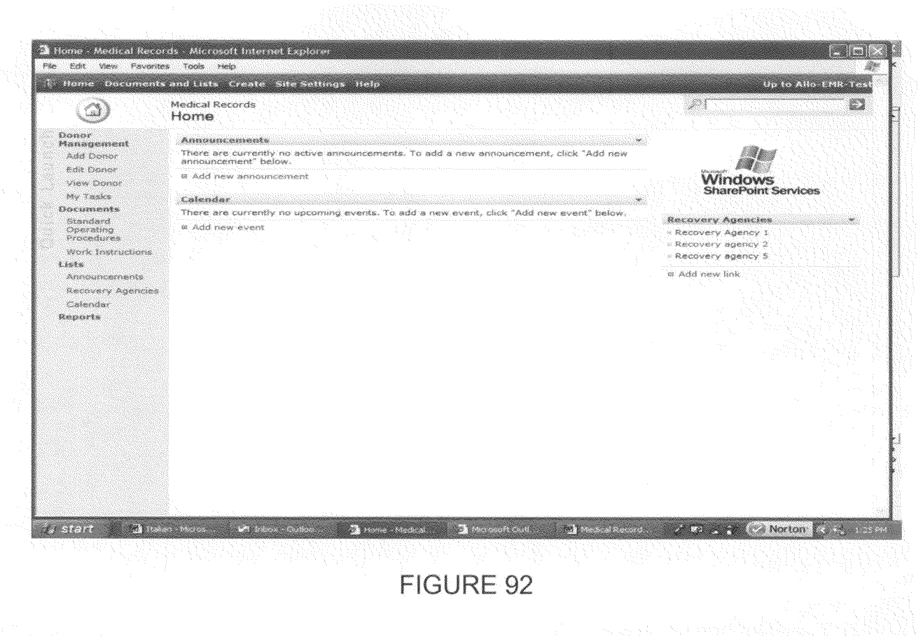

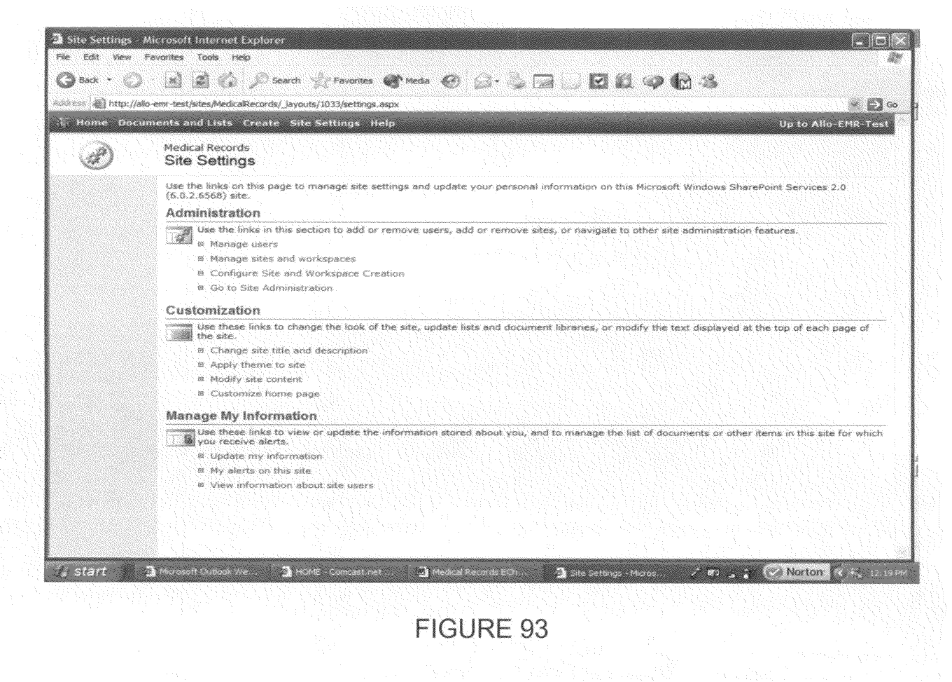

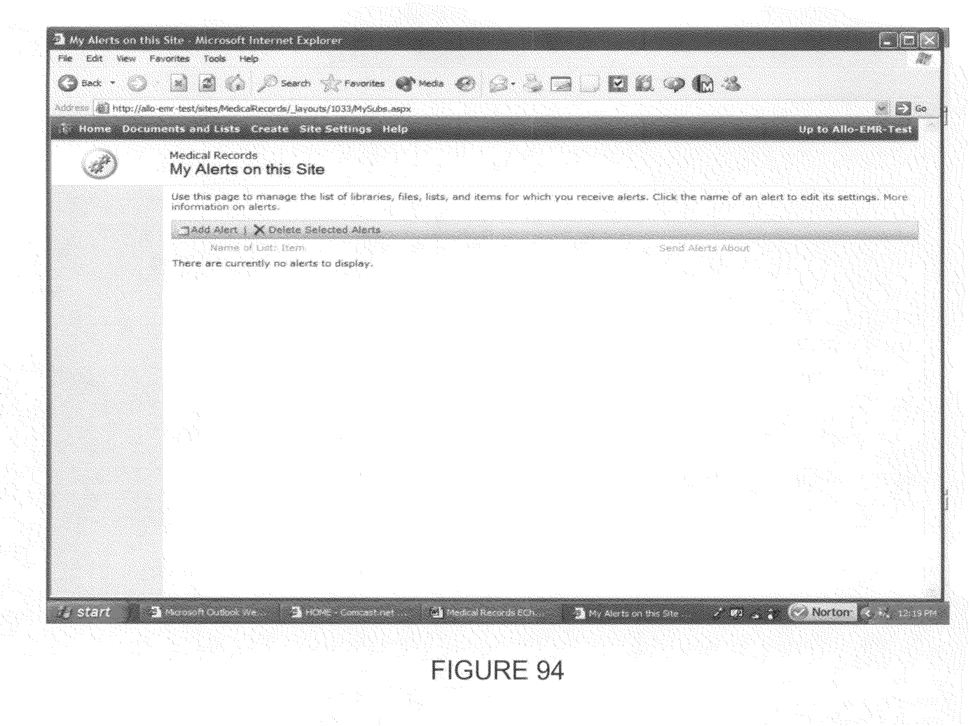

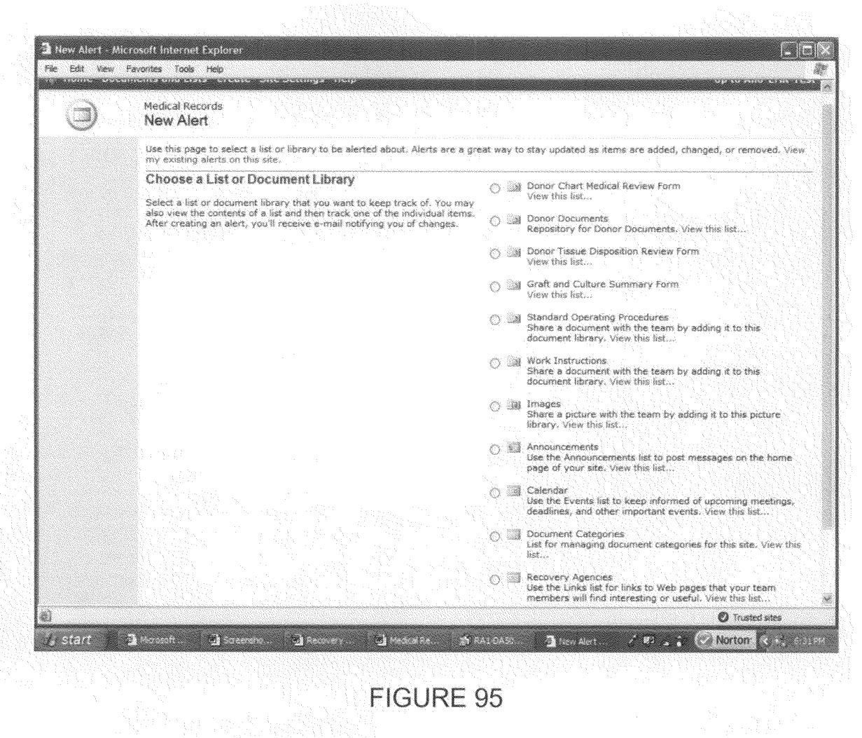

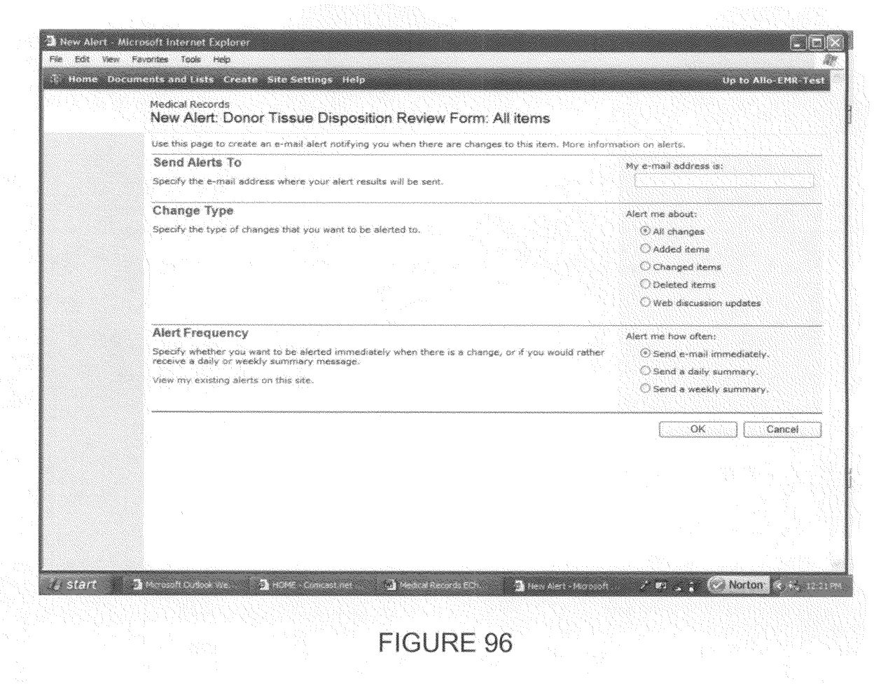

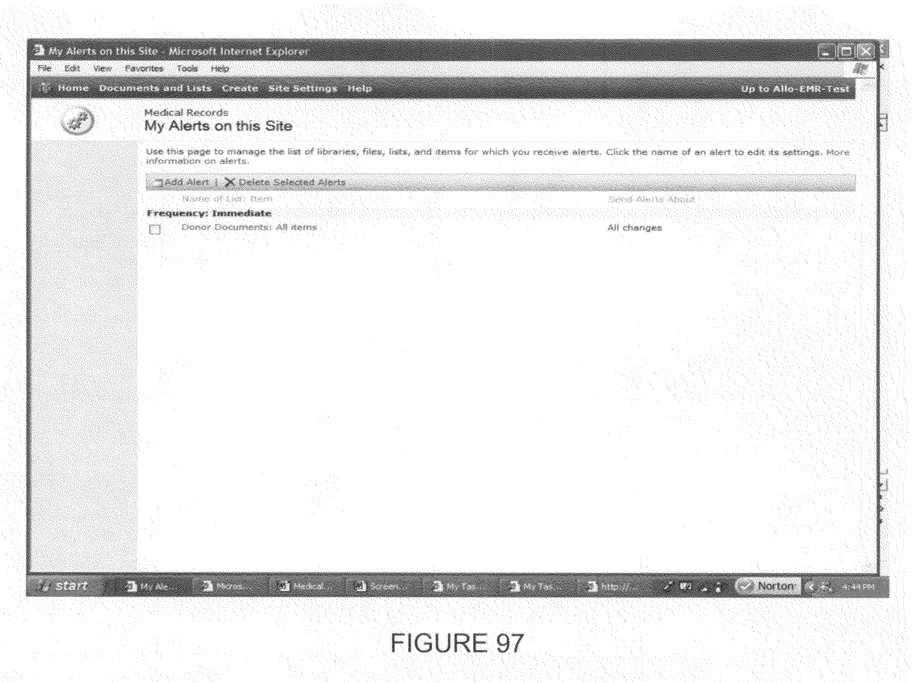

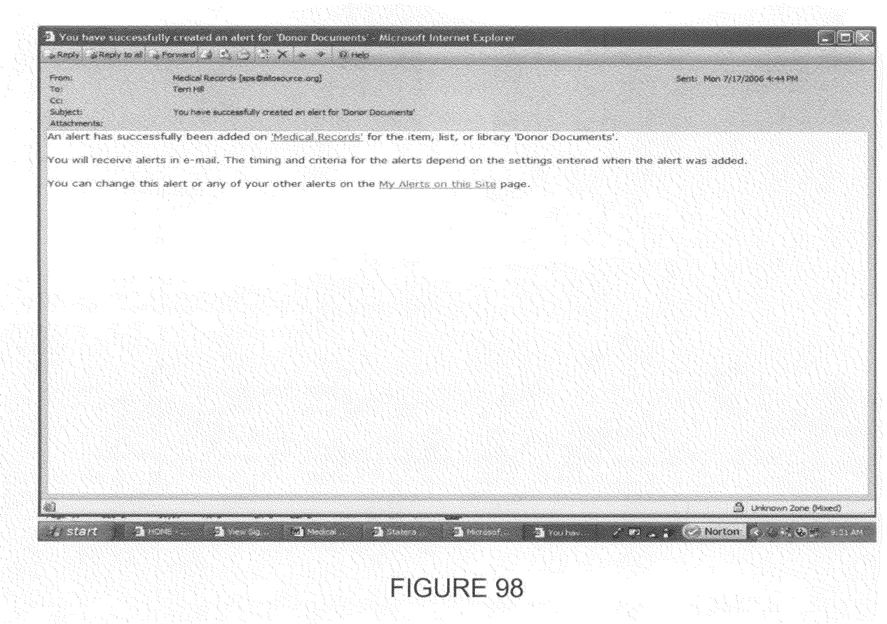

As a confirmation, the user will receive an email after setting up an alert to confirm that it was set up successfully and reiterating the selections made as illustrated in FIG. 98.

Medical Records Specialist Complete Donor Chart Medical Review Form Signature

The Medical Records Specialist who completes the Donor Chart Medical Review Form must apply an electronic signature to it with one and only one of these signature meanings:
“I have completed the Donor Chart Medical Review form. I find the donor acceptable for further review.”
“I have completed the Donor Chart Medical Review form. I find the donor unacceptable for further review.”
“I have completed the Donor Chart Medical Review form and need review from MD to determine if unacceptable for further review.

Medical Records Specialist Review Donor Chart Medical Review Form Signature

Medical Records Specialist must be able to apply an electronic signature to a completed Donor Chart Medical Review Form as a review with one and only one of these signature meanings:
“I have reviewed the Donor Chart Medical Review form. I find the donor acceptable for further review.”
“I have reviewed the Donor Chart Medical Review form. This form has discrepancies as noted in the form comments.”
“I have reviewed the Donor Chart Medical Review form. I find the donor unacceptable for further review.”
“Donor tissue was not recovered for Traditional processing.”

Traditional Medical Records workflow will add an item to the task list of everyone in the Medical Records security group. This task will instruct the user that a Donor Chart Medical Review Form must be signed as a quality check and display a link to the Signature page. The user will go to the Signature page, reenter username and password, choose which meaning to sign with, and click the Sign button. The task will then be removed from each user's task list since it has been completed. The Task List will be refreshed and displayed with the confirmation message presented at the top of the Task List.

Medical Director Donor Skin/Tissue Disposition Review Form Signature

An AlloSource Medical Director must be able to apply an electronic signature to a Donor Tissue Disposition Review Form with one and only one of these signature meanings:
“I have completed the Donor Skin/Tissue Disposition Review form. The tissue must be processed/deferred according to the instructions listed on the form.”
“I have concluded that this donor information contains discrepancies as noted in the form comments.”
“I have concluded that this donor information contains micro discrepancies as noted in the form comments.”

The Traditional Medical Records workflow will add an item to the task list of everyone in the Medical Director security group. This task will instruct the user that a Donor Skin/Tissue Disposition Review Form must be signed and display a link to the Signature page. The user will go to the Signature page, reenter username and password, choose which meaning to sign with, and click the Sign button. The task will then be removed from each user's task list since it has been completed. The Task List will be refreshed and displayed with the confirmation message presented at the top of the Task List.

Traditional Medical Records Workflow

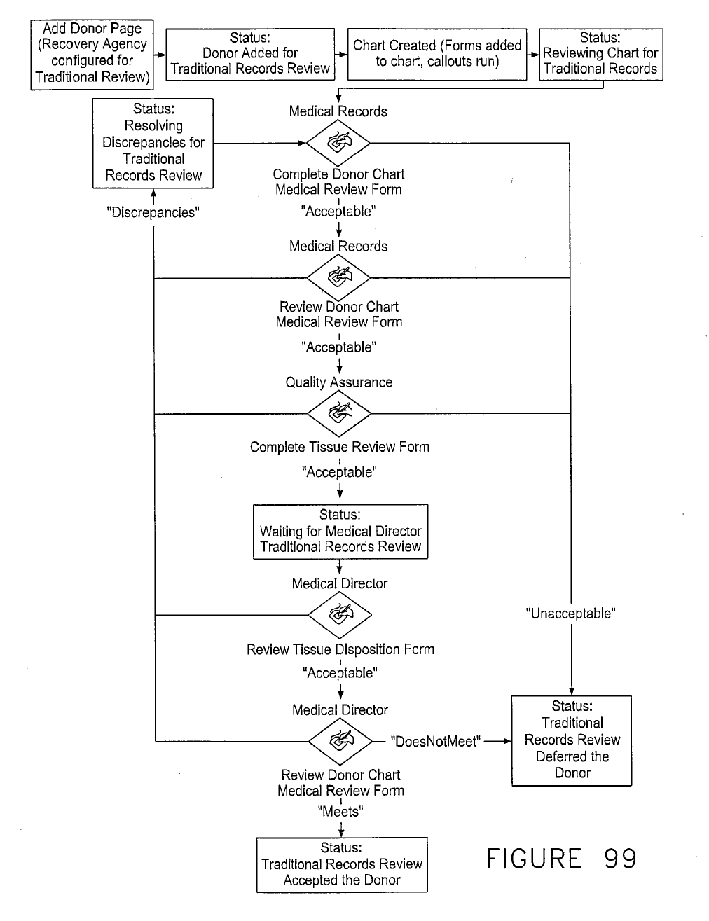

FIG. 99 illustrates an embodiment of a Traditional Medical Records Workflow, which outlines the signature steps and donor chart states for Traditional Medical Records. The requirements provide detail for each of these steps and a numbered item to track test cases, etc., against.

A new Traditional Medical Records Workflow instance must be started when a new donor is added to the system and the Traditional processing option is selected for the recovery agency that donor is added for.

The Add Donor page starts a new Donor Chart Lifecycle workflow instance, which will start a Traditional workflow instance if the Traditional processing option is selected for the recovery agency that the donor is added for.

New Donor Status

A new donor should be added to the system with status set to “Donor Added for Traditional Records Review”. After the chart is created and any callouts are run, the status should be set to “Reviewing Chart for Traditional Records”.

A step in the beginning of the process sets the new donor status to “Donor Added for Traditional Records Review”. After the chart creation and callout steps, a step sets the status to “Reviewing Chart for Traditional Records”.

Start a Traditional Medical Records Workflow Instance

A new Traditional Medical Records Workflow instance must be started when a new donor is added to the system and the Traditional processing option is selected for the recovery agency that donor is added for.

The Add Donor page uses the K2 API to start a new Donor Chart Lifecycle workflow instance, which will start a Traditional workflow instance if the Traditional processing option is selected for the recovery agency that the donor is added for.

New Donor Status

A new donor should be added to the system with status set to “Donor Added for Traditional Records Review”. After the chart is created and any callouts are run, the status should be set to “Reviewing Chart for Traditional Records”.

The K2 Process will include a step in the beginning of the process to set the new donor status to “Donor Added for Traditional Records Review”. After the chart creation and callout steps, a step will set the status to “Reviewing Chart for Traditional Records”.

Add “Complete Donor Chart Medical Review Form” Task for Medical Records

A task to complete the Donor Chart Medical Review Form must be added to the task lists of Medical Records users when a new donor is added to the system. A client event for completing the Donor Chart Medical Review Form will be added to the K2 Process that adds a task to the Medical Records security group. To complete the task, an electronic signature must be applied as described in “Medical Records Specialist Complete Donor Chart Medical Review Form Signature”.

Add “MD Consult For Potential Deferral” Task for Medical Director

A task to review the Donor Chart Medical Review Form must be added to the task lists of Medical Records users when the signature option indicates that a consult with MD is needed to determine if the donor should be differed.

A client event for reviewing the Donor Chart medical Review Form will be added to the K2 Process that adds a task to the Medical Directors security group. To complete the task, an electronic signature must be applied as described in Medical Director Consult For Potential Deferral Donor Chart Medical Review Form Signature.

Add “Review Donor Chart Medical Review Form” Task for Medical Records

A task to review the Donor Chart Medical Review Form must be added to the task lists of Medical Records users when a signature specifying the form has been completed is applied.

When a signature is applied with the “ . . . acceptable . . . ” meaning as specified in “Medical Records Specialist Complete Donor Chart Medical Review Form Signature”, a client event for reviewing the Donor Chart Medical Review Form will be added to the K2 Process that adds a task to the Medical Records security group. To complete the task, an electronic signature must be applied as described in “Medical Records Specialist Review Donor Chart Medical Review Form Signature”.

Add “Complete Donor Tissue Disposition Review Form” Task for Quality Assurance

A task to complete the Donor Tissue Disposition Review Form must be added to the task lists of Quality Assurance users when a signature specifying the Donor Chart Medical Review Form has been reviewed.

When a signature is applied with the “ . . . acceptable . . . ” meaning as specified in “Medical Records Specialist Review Donor Chart Medical Review Form Signature”, a client event for completing the Donor Tissue Disposition Review Form will be added to the K2 Process that adds a task to the Quality Assurance security group. To complete the task, an electronic signature must be applied as described in “Quality Assurance Donor Skin/Tissue Disposition Review Form Signature”.

Chance Donor Status to “Waiting for Medical Director Traditional Records Review”

The donor status should be changed to “Waiting for Medical Director Traditional Records Review” when the reviews for the Donor Chart Medical Review and Donor Tissue Disposition forms have both been completed.

The K2 Process will include a step to set the donor status to “Waiting for Medical Director Approval”. This step will execute after signatures have been completed as specified in “Medical Records Specialist Review Donor Chart Medical Review Form Signature” with the “ . . . acceptable . . . ” meaning and “Quality Assurance Donor Skin/Tissue Disposition Review Form Signature” with the “ . . . tissue must be processed . . . ” meaning.

Add “Sign Donor Chart Medical Review Form” Task for Medical Director

A task to sign the Donor Chart Medical Review Form must be added to the task lists of Medical Director users when the quality checks for the Donor Chart Medical Review and Donor Tissue Disposition forms have both been completed.

A client event for signing the Donor Chart Medical Review Form will be added to the K2 Process that adds a task to the Medical Director security group. This step will execute after signatures have been completed as specified in “Medical Records Specialist Review Donor Chart Medical Review Form Signature” with the “ . . . acceptable . . . ” meaning and “Quality Assurance Donor Skin/Tissue Disposition Review Form Signature” with the “ . . . tissue must be processed . . . ” meaning. To complete the task, an electronic signature must be applied as described in “Medical Director Donor Chart Medical Review Form Signature”.

Add “Sign Donor Tissue Disposition Review Form” Task for Medical Director

A task to sign the Donor Tissue Disposition Review Form must be added to the task lists of Medical Director users when the quality checks for the Donor Chart Medical Review and Donor Tissue Disposition forms have both been completed.

A client event for signing the Donor Chart Medical Review Form will be added to the K2 Process that adds a task to the Medical Director security group. This step will execute after signatures have been completed as specified in “Medical Records Specialist Review Donor Chart Medical Review Form Signature” with the “ . . . acceptable . . . ” meaning and “Quality Assurance Donor Skin/Tissue Disposition Review Form Signature” with the “ . . . tissue must be processed . . . ” meaning. To complete the task, an electronic signature must be applied as described in “Medical Director Donor Skin/Tissue Disposition Review Form Signature”.

Lock a Donor Chart from Recovery Agency Users

The donor chart should be locked from Recovery Agency Users only when the Medical Director signatures for the Donor Chart Medical Review and Donor Tissue Disposition forms have both been completed. “Locked” means that no new documents or new versions of documents can be uploaded and the donor cannot be edited.

2.5.11 Change Donor Status to “Traditional Medical Records Review Accepted the Donor” or “Traditional Medical Records Review Deferred the Donor”

The donor status should be changed to “Traditional Medical Records Review Accepted the Donor” or “Traditional Medical Records Review Deferred the Donor” when the Medical Director signatures for the Donor Chart Medical Review and Donor Tissue Disposition forms have both been completed. The status is determined by which signature meaning the Medical Director selected in the Donor Chart Medical Review signature.

Additionally, the donor status should be changed to “Traditional Medical Records Review Deferred the Donor” when a Medical Records Specialist determines a donor is unacceptable for further review at either of their signatures.

An email alert is sent to the Research group when a Traditional donor is deferred by Medical Records or a Medical Director.

The K2 Process will include a step that inspects the signature meaning from the Medical Director Donor Chart Medical Review signature and sets the donor status to “ . . . Accepted . . . ” when the “ . . . meets . . . ” meaning is selected or “ . . . Deferred . . . ” when the “ . . . does not meet” meaning is selected. This step will execute after signatures have been completed as specified in “Medical Director Donor Chart Medical Review Form Signature” with the “ . . . accepted . . . ” meaning and “Medical Director Donor Skin/Tissue Disposition Review Form Signature” with the “ . . . tissue must be processed . . . ” meaning.

In either the “Medical Records Specialist Complete Donor Chart Medical Review Form Signature” or “Medical Records Specialist Review Donor Chart Medical Review Form Signature” signature, if the “ . . . unacceptable for further review . . . ” meaning is selected, then the process will set the status to “ . . . Deferred . . . ”.

Finish a Traditional Medical Records Workflow Instance

A Traditional Medical Records workflow instance must end after the donor status has been set to “Traditional Medical Records Review Accepted the Donor” or “Traditional Medical Records Review Deferred the Donor”.

The K2 step described in “Change Donor Status to “Traditional Medical Records Review Accepted the Donor” or “Traditional Medical Records Review Deferred the Donor” will be the last step in the process. The instance will end after executing this step.

Discrepancies Noted in Donor Chart Medical Review Form

If a discrepancy is noted in a Donor Chart Medical Review form signature, then the process will loop back and re-add a “Complete the Donor Chart Medical Review Form” task to the task lists of Medical Records users. An email alert should be sent to these users because of the higher priority of this task. The donor status should be set to “Resolving Discrepancies for Traditional Records Review”.

If the “ . . . discrepancies . . . ” meaning is selected in either the “Medical Records Specialist Review Donor Chart Medical Review Form Signature” or “Medical Director Donor Chart Medical Review Form Signature”, then the K2 Process will loop back to the step to add a “Complete the Donor Chart Medical Review Form” task. The client event will be configured to send out email alerts.

Discrepancies Noted in Donor Skin/Tissue Disposition Review Form

If a discrepancy is noted in a Donor Tissue Disposition Review form signature, then the process will loop back and re-add a “Complete the Donor Chart Medical Review Form” task to the task lists of Medical Records users. An email alert should be sent to these users because of the higher priority of this task. The donor status should be set to “Resolving Discrepancies for Traditional Records Review”.

If the “ . . . discrepancies . . . ” meaning is selected in either the “Quality Assurance Donor Skin/Tissue Disposition Review Form Signature” or “Medical Director Donor Skin/Tissue Disposition Review Form Signature”, then the K2 Process will loop back to the step to add a “Complete the Donor Chart Medical Review Form” task. The client event will be configured to send out email alerts. A step will also change the status to “Resolving Discrepancies for Traditional Records Review”.

Joint Restoration Workflow

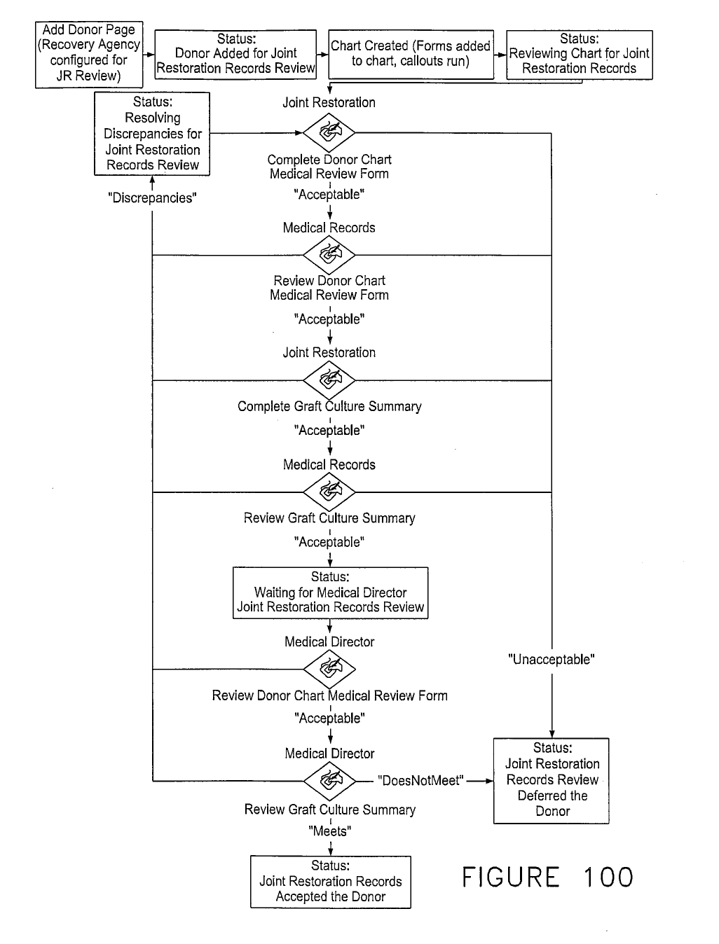

Referring to FIG. 100, there is shown a Joint Restoration Workflow, which outlines the signature steps and donor chart states for Joint Restoration. The requirements provide detail for each of these steps and a numbered item to track test cases, etc., against.

Start a Joint Restoration Workflow Instance

A new Joint Restoration Workflow instance must be started when a new donor is added to the system and the Joint Restoration processing option is selected for the recovery agency that donor is added for.

The Add Donor page starts a new Donor Chart Lifecycle workflow instance. This workflow will start a Joint Restoration workflow instance before starting the Traditional Medical Records workflow when the Joint Restoration processing option is selected.

New Process Donor Status

A new donor should be added to the system with status set to “Donor Added for Joint Restoration Records Review”. After the chart is created and any callouts are run, the status should be set to “Reviewing Chart for Joint Restoration”.

The K2 Process will include a step in the beginning of the process to set the new donor status to “Donor Added for Joint Restoration Records Review”. After the chart creation and callout steps, a step will set the status to “Reviewing Chart for Joint Restoration Records”.

Add “Complete Donor Chart Medical Review Form” Task for Joint Restoration

A task to complete the Donor Chart Medical Review Form must be added to the task lists of Joint Restoration users when a new JR donor is added to the system.

A client event for completing the Donor Chart Medical Review Form will be added to the K2 Process that adds a task to the Joint Restoration security group. To complete the task, an electronic signature must be applied as described in “Joint Restoration Specialist Complete Medical Review Form Signature”.

Add “Review Donor Chart Medical Review Form” Task for Medical Records

A task to complete the Donor Chart Medical Review Form must be added to the task lists of Medical Records users after a signature is added specifying the Donor Chart Medical Review Form has been completed.

When a signature is applied with the “acceptable” meaning as specified in “Joint Restoration Specialist Complete Medical Review Form Signature”, a client event for reviewing the Donor Chart Medical Review Form will be added to the K2 Process that adds a task to the Medical Records security group. To complete the task, an electronic signature must be applied as described in “Medical Records Specialist Review Medical Review Form Signature”.

Add “Complete Graft and Culture Summary Form” Task for Joint Restoration

A task to complete the Graft and Culture Summary Form must be added to the task lists of Joint Restoration users after a signature is added specifying the Donor Chart Medical Review Form has been reviewed.

When a signature is applied with the “acceptable” meaning as specified in “Add “Review Donor Chart Medical Review Form” Task for Medical Records”, a client event for completing the Graft and Culture Summary Form will be added to the K2 Process that adds a task to the Joint Restoration security group. To complete the task, an electronic signature must be applied as described in “Quality Assurance Donor Skin/Tissue Disposition Review Form Signature”.

Add “Review Graft and Culture Summary Form” Task for Medical Records

A task to review the Graft and Culture Summary Form must be added to the task lists of Medical Records users after a signature is added specifying the Graft and Culture Summary Form has been completed.

When a signature is applied with the “acceptable” meaning as specified in “Quality Assurance Donor Skin/Tissue Disposition Review Form Signature”, a client event for reviewing the Graft and Culture Summary Form will be added to the K2 Process that adds a task to the Medical Records security group. To complete the task, an electronic signature must be applied as described in “Medical Records Specialist Review Graft and Culture Summary Form Signature”.

Change Donor Status to “Waiting for Medical Director Joint Restoration Records Review”

The donor status should be changed to “Waiting for Medical Director Joint Restoration Records Review” when the Medical Records review for the Graft and Culture Summary Form has been completed.

The K2 Process will include a step to set the donor status to “Waiting for Medical Director Approval for Joint Restoration”. This step will execute after the signature has been completed as specified in “Medical Records Specialist Review Graft and Culture Summary Form Signature” with the “acceptable” meaning.

Add “Review Donor Chart Medical Review Form” Task for Medical Director

A task to review the Donor Chart Medical Review Form must be added to the task lists of Medical Director users when the Medical Records review for the Graft and Culture Summary Form has been completed.

A client event for reviewing the Donor Chart Medical Review Form will be added to the K2 Process that adds a task to the Medical Director security group. This step will execute after the signature has been completed as specified in “Medical Records Specialist Review Graft and Culture Summary Form Signature” with the “acceptable” meaning. To complete the task, an electronic signature must be applied as described in “Medical Director Review Medical Review Form Signature”.

Add “Review Graft and Culture Summary Form” Task for Medical Director

A task to review the Graft and Culture Summary Form must be added to the task lists of Medical Director users when the Medical Director review for the Donor Chart Medical Review Form has been completed.

A client event for reviewing the Graft and Culture Summary Form will be added to the K2 Process that adds a task to the Medical Director security group. This step will execute after a signature has been completed as specified in “Medical Director Review Medical Review Form Signature” with the “acceptable” meaning. To complete the task, an electronic signature must be applied as described in “Medical Director Review Graft and Culture Summary Form Signature”.

Lock a Donor Chart from Recovery Agency Users

The donor chart should be locked from Recovery Agency Users only when the Medical Director signatures for the Donor Chart Medical Review and Graft Culture Summary forms have both been completed. “Locked” means that no new documents or new versions of documents can be uploaded and the donor cannot be edited.

Change Donor Status to “Joint Restoration Records Review Accepted the Donor” or “Joint Restoration Records Review Deferred the Donor”

The donor status should be changed to “Joint Restoration Records Review Accepted the Donor” or “Joint Restoration Records Review Deferred the Donor” when the Medical Director signature for the Graft and Culture Summary form has been completed. The status is determined by which signature meaning the Medical Director selected in the Graft and Culture Summary signature.

Additionally, the donor status should be changed to “Joint Restoration Records Review Deferred the Donor” when a Joint Restoration Specialist determines a donor is unacceptable for further review in earlier signatures.

The K2 Process will include a step that inspects the signature meaning from the Medical Director Graft and Culture Summary signature and sets the donor status to “Joint Restoration Records Review Accepted the Donor” when the “meets” meaning is selected or “Joint Restoration Records Review Deferred the Donor” when the “does not meet” meaning is selected. This step will execute after the signature has been completed as specified in “Medical Director Review Graft and Culture Summary Form Signature”.

In either the “Joint Restoration Specialist Complete Medical Review Form Signature”, or “Joint Restoration Specialist Complete Graft and Culture Summary Form Signature”, if the “unacceptable for further review” meaning is selected, then the process will set the status to “Joint Restoration Records Review Deferred the Donor”.

Finish a Joint Restoration Workflow Instance

A Joint Restoration workflow instance must end after the donor status has been set to “Joint Restoration Records Review Accepted the Donor” or “Joint Restoration Records Review Deferred the Donor”.

The K2 step described in “Change Donor Status to “Joint Restoration Records Review Accepted the Donor” or “Joint Restoration Records Review Deferred the Donor”” will be the last step in the process. The instance will end after executing this step.

Discrepancies Noted in Donor Chart Medical Review Form

If a discrepancy is noted in a Donor Chart Medical Review form signature, then the process will loop back and re-add a “Complete the Donor Chart Medical Review Form” task to the task lists of Joint Restoration users. An email alert should be sent to these users because of the higher priority of this task. The donor status should be set to “Resolving Discrepancies for Joint Restoration Records Review”.

If the “discrepancies” meaning is selected in any of the following signatures:
Joint Restoration Specialist Complete Medical Review Form Signature
Medical Director Review Medical Review Form Signature
Medical Records Specialist Review Medical Review Form Signature
   . . . then the K2 Process will loop back to the step to add a “Complete the Donor Chart Medical Review Form” task. The client event will be configured to send out email alerts. A step will be added to change the status to “Resolving Discrepancies for Joint Restoration Records Review”.

Discrepancies Noted in Graft and Culture Summary Form

If a discrepancy is noted in a Graft and Culture Summary form signature, then the process will loop back and re-add a “Complete the Donor Chart Medical Review Form” task to the task lists of Joint Restoration users. An email alert should be sent to these users because of the higher priority of this task. The donor status should be set to “Resolving Discrepancies for Joint Restoration Records Review”.

If the “discrepancies” meaning is selected in any of the following signatures:
Joint Restoration Specialist Complete Graft and Culture Summary Form Signature
Medical Records Specialist Review Graft and Culture Summary Form Signature
Medical Director Review Graft and Culture Summary Form Signature
   . . . then the K2 Process will loop back to the step to add a “Complete the Donor Chart Medical Review Form” task. The client event will be configured to send out email alerts. A step will be added to change the status to “Resolving Discrepancies for Joint Restoration Records Review”.

Skin Exceptional Release Workflow

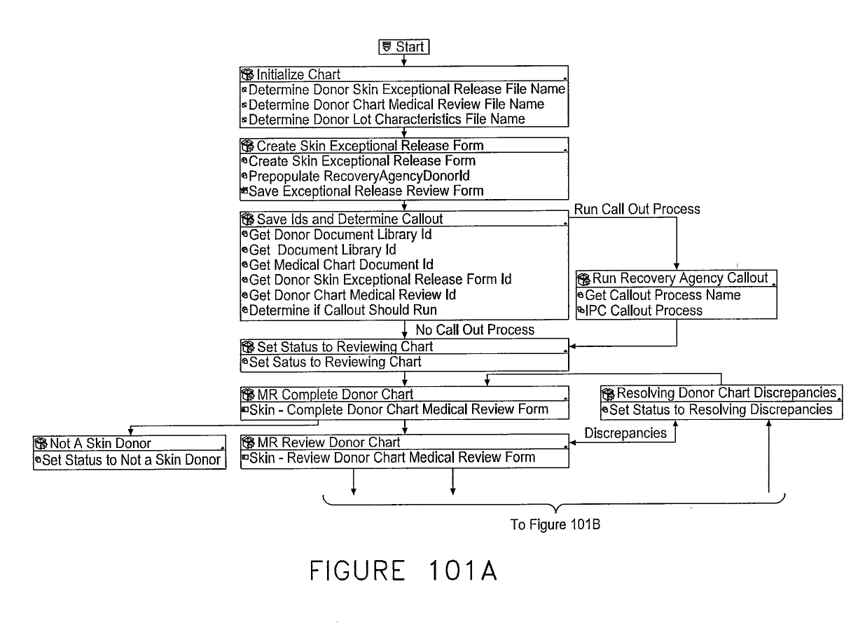

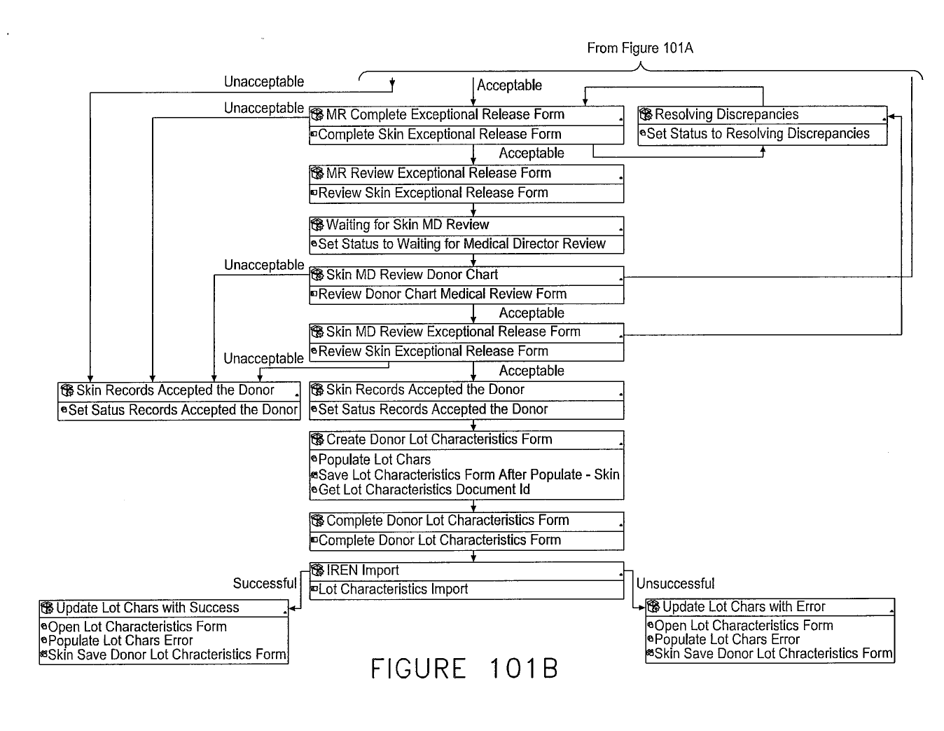

In an embodiment, FIG. 101 outlines signature steps and donor chart states for Skin Exceptional Release. The requirements provide detail for each of these steps and a numbered item to track test cases, etc., against.

Start a Skin Exceptional Release Workflow

A new Skin Medical Records Workflow instance must be created when a new donor is added to the system and the Skin processing option is selected for the recovery agency that donor is added for. The Skin Exceptional Release processing flow is run independent from both JR and Traditional processing flows.

The Add Donor page starts a new Donor Chart Lifecycle workflow instance. This workflow will be modified to start a Skin Medical Records Workflow independent to the Joint Restoration Workflow instance. The existing API will be used to determine if a Skin processing option is enabled and initiate the Skin workflow for the donor chart.

New Workflow Donor Status

A new donor is added to the system with status set to “Donor Added for Skin Medical Records Review”. After the chart is created and any callouts are run, the status shall be set to “Reviewing Chart for Skin Medical Records”. Note that since Skin and JR will run concurrently, the actual status shown on the donor chart will reflect Skin or JR statuses at any given time, but the donor chart history must show that all states were hit properly.

In an embodiment, the K2 Process will include a step in the beginning of the process to set the new donor status to “Donor Added for Skin Records Review”. After the chart creation and callout steps, a step will set the status to “Reviewing Chart for Skin Medical Records”.

Add “Skin—Complete Donor Chart Medical Review Form” Task for Exceptional Release

A task to complete the Donor Chart Medical Review Form must be added to the task lists of Medical Records users when a new Skin donor is added to the system. This task will be completed only if Exceptional Release is required for the Skin Tissue. If Exceptional Release is not required then the Medical Records User will sign this task as “not required” at the appropriate time.

A client event for completing the Donor Chart Medical Review Form will be added to the K2 Process that adds a task to the Medical Records security group. To complete the task, an electronic signature must be applied.

Add “Skin—Review Donor Chart Medical Review” Task for Medical Records

A task to review the Donor Chart Medical Review Form must be added to the task lists of Medical Records users after a signature is applied specifying the Donor Chart Medical Review Form has been completed.

When a signature is applied with the “acceptable” option, a client event for reviewing the Donor Chart Medical Review Form will be added to the K2 Process that adds a task to the Medical records security group. To complete the task, an electronic signature must be applied.

Add “Complete Skin Exceptional Release Form” Task for Medical Records

Once Medical Records has completed the Donor Chart Medical Review form, then a task may be added for Medical Records to complete the Exceptional Release form.

If “acceptable” is chosen in “Medical Records Review Donor Chart Medical Review Form Signature” then a client event for completing the Exceptional Release Form will be added to the K2 Process that adds a task to the Skin Medical Records security group. To complete the task, an electronic signature must be applied as described in Medical Records Complete Skin Exceptional Release Form Signature.

Add “Review Skin Exceptional Release Form” Task for Medical Records

If Medical Records completes the Skin Exceptional Release Form and signs off on the task as “acceptable” then Medical Records must review the Skin Exceptional Release form.

If “acceptable” is chosen in “Medical Records Complete Skin Exceptional Release Form Signature”, then a client event for reviewing the Exceptional Release Form will be added to the K2 Process that adds a task to the Medical Records security group. To complete the task, an electronic signature must be applied as described in Medical Records Review Skin Exceptional Release Form Signature.

Change Status to “Waiting for Medical Director Skin Records Review”

The donor status shall be changed to “Waiting for Medical Director Skin Records Review” when the Medical Records review of the Skin Exceptional Release Form has been completed.

The K2 Process will include a step to set the donor status to “Waiting for Medical Director Skin Records Review”. This step will execute after the signature has been completed as specified in “Medical Records Review Skin Exceptional Release Form Signature” with the “acceptable” meaning.

Add “Review Donor Chart Medical Review Form” Task for Skin Medical Directors”

A task to review the Donor Chart Medical Review Form must be added to the task lists of Skin Medical Directors after a signature is applied specifying the Skin Exceptional Release Form has been approved by Medical Records review.

When a signature is applied with the “acceptable” option as specified in “Medical Records Review Skin Exceptional Release Form Signature”, a client event for reviewing the Donor Chart Medical Review Form will be added to the K2 Process that adds a task to the Skin Medical Director security group. To complete the task, an electronic signature must be applied as described in “Skin Medical Director Review Donor Chart Medical Review Form Signature”.

Add “Review Exceptional Release Form” Task for Skin Medical Directors”

Once the Medical Director has approved the donor chart as specified in “Skin Medical Director Review Donor Chart Medical Review Form Signature” a task to review the Skin Exceptional Release Form is inserted in the Skin Medical Directors tasklist.

If “acceptable” is chosen in Skin Medical Director Review Donor Chart Medical Review Form Signature, then a client event for reviewing the Skin Exceptional Release Form will be added to the K2 Process that adds a task to the Skin Medical Directors security group. To complete the task, an electronic signature must be applied as described in Skin Medical Director Review Skin Exceptional Release Form Signature.

Change Status to “Skin Records Review Accepted the Donor”

If “meets” is selected in the Skin Medical Director review of the Skin Exceptional Release Form, then the status must be changed to “Skin Records Review Accepted the Donor”.

If “approves” is chosen in Skin Medical Director Review Donor Chart Medical Review Form Signature, then the status API will be called to change the status to “Skin Records Review Accepted the Donor”.

Change Status to “Resolving Discrepancies for Skin Records Review”

Requirement

If the “discrepancies” option is selected in the signature for either the Medical records or Skin Medical Director reviews of the Donor Chart Medical Review form, then the process must change the status to “Resolving Discrepancies for Skin Records Review”, email Skin Medical Records that there was a discrepancy, and re-add the “Complete Donor Chart Medical Review Form” task for Medical Records.

If “discrepancies” is selected in either “Medical Records Review Donor Chart Medical Review Form Signature” or “Skin Medical Director Review Donor Chart Medical Review Form Signature”, then the process will loop back to the “Add “Skin—Complete Donor Chart Medical Review Form” Task for Exceptional Release”. K2 will be configured to send an email to the Medical Records users and call the existing status API to change the status to “Resolving Discrepancies for Skin Records Review”.

Change Status to “Skin Records Review Deferred the Donor”

If the “unacceptable” or “DoesNotMeet” options are selected in any of the Donor Chart Medical Review form signatures, then the status should be changed to “Skin Records Review Deferred the Donor”.

If “unacceptable” is selected in “Medical Records Complete Skin Donor Chart Medical Review Form Signature” or “Medical Records Review Donor Chart Medical Review Form Signature” or “DoesNotMeet” is selected in “Skin Medical Director Review Donor Chart Medical Review Form Signature”, then the status API will be called to change the status to “Skin Records Review Deferred the Donor”.

Discrepancies in Exceptional Release

If either Medical Records Review or Skin Medical Directors find discrepancies in the Exceptional Release form, then the process must loop back to Medical Records to resolve the discrepancies.

If “discrepancies” is chosen in either Medical Records Review Skin Exceptional Release Form Signature or Skin Medical Director Review Skin Exceptional Release Form Signature, then the process will re-add the task “Complete Skin Exceptional Release Form” Task for Medical Records, after which the process will proceed normally.

Lot Characteristics iRen Integration

Once Skin Medical Director approves the Exceptional Release Form, the donor lot characteristics can be submitted to iRen.

If the “acceptable” option is selected in Change Status to “Skin Records Review Accepted the Donor”” a task will be added for Medical Records to approve the import into iRen. Once that signature is applied, then the automated integration with iRen will insert the donor lot characteristics.

End a Skin Medical Records Workflow

If the exceptional release is not required or the donor chart is deferred, the workflow still needs to be completed by signing the task with the appropriate radio button selected.

K2 does not end a process instance until all existing tasks are completed and no additional line rules resolve to true. Since the K2 process will be designed as noted in the requirements and the flow diagram above, it will not end until it is appropriate.

Donor Chart Decommission

The Administration screen has the functionality to decommission a Donor Chart. This functionality is required to address the situation where a donor chart is added to the system and the wrong Recovery Agency Donor Id is entered. This feature will enable the System Admin position to decommission a donor chart which is basically a clean up of the system.

The System Administrator function will access the administrative site, select the Donor Decommissioning menu option and enter the appropriate information to decommission a donor chart. The system will set a flag in the donor database that marks the donor chart as decommissioned.

Chart Metadata and Search

In an embodiment, the donor chart contains the metadata fields identified in Table 1 below.

TABLE 1
Donor Chart Metadata

| Field | Purpose |
|---|---|
| Internal Donor Id | Stores the unique id of the donor chart in the |
| | Donor Records Management System; this id is |
| | only used by the system itself |
| Recovery Agency | The recovery agency that this donor is from |
| Recovery Agency | The prefix from the recovery agency that this |
| Prefix | donor is from (i.e. different offices or locations) |
| Recovery Agency | The recovery agency's id for the donor |
| Donor Id | |
| AlloSource Donor Id | AlloSource's id for the donor |
| AlloSource | Secondary Id might be required to satisfy iRen |
| Secondary Id | processing requirements. |
| Date Created | The date/time stamp of when the donor chart |
| | was added to the system |
| Date Edited | The data/time stamp of when the donor chart |
| | was last edited |
| Status | The current status of the donor chart, as |
| | determined by the approval workflows |
| Age | Donor age |
| Gender | Donor gender |
| Processing Options | Processing options enabled for the donor |
| Recovery Date | Date that the Recovery Agency recovered the |
| | donor |

What is claimed is:

1. An electronic donor medical records management system, comprising:
a recovery agency site having a first electronic chart component configured to allow a recovery agency to add online donor charts directly to the system; and
a medical records site having a second electronic chart component configured to allow processing of the online donor charts.

2. An electronic donor medical records management system in accordance with claim 1, wherein the medical records site is configured to enter the online donor charts via the recovery agency site.

3. An electronic donor medical records management system in accordance with claim 1, wherein the medical records site includes an add donor screen.

4. An electronic donor medical records management system in accordance with claim 3, wherein the add donor screen includes a selectable drop-down list with a set of prefixes so as to identify a particular recovery agency.

5. An electronic donor medical records management system in accordance with claim 3, wherein the add donor screen includes a text field for entry of a recovery agency donor number so as to identify a donor.

6. An electronic donor medical records management system in accordance with claim 3, wherein the add donor screen includes a text field for entry of an age so as to specify the age of the donor.

7. An electronic donor medical records management system in accordance with claim 3, wherein the add donor screen includes a selectable drop-down list with a choice of gender so as to identify a particular gender of a donor.

8. An electronic donor medical records management system in accordance with claim 3, wherein the add donor screen includes (1) a browse button to display and attach donor chart documents to the online donor chart and (2) a selectable drop-down list with a choice of document categories adjacent to each one of the donor chart documents displayed next to a particular browse button so as to associate the donor chart documents.

9. A method of managing electronic donor medical records in a system, the method comprising:
navigating a browser to a recovery agency site related to a donor;
selecting an add donor link so as to be directed to an add donor page;
selecting a prefix to identify a particular recovery agency;
entering a recovery agency donor number to identify a donor;
selecting necessary documents to be uploaded and associated with a donor chart being added to the system;
clicking a checkbox for review when the donor chart is complete and a medical director of the recovery agency has signed off on the donor chart; and
clicking a save donor button so as to store the donor chart.

10. A method of managing electronic donor medical records in a system in accordance with claim 9, further comprising reviewing a success message displayed in the browser, and clicking a button within the success message displayed in the browser so to confirm the donor chart.
